(19) United States
(12) Patent Application Publication
(10) Pub. No.: US 2026/0147832 A1
(43) Pub. Date: May 28, 2026

(54) SYSTEMS AND METHODS FOR AUTOMATED TRANSFORMATION OF SPORTS DATA

(71) Applicant: STATS LLC, Chicago, IL (US)

(72) Inventors: Jonathan Andrew WHITMORE, London (GB); Robert BATEMAN, London (GB); Daniel Richard DINSDALE, London (GB); Joe Dominic GALLAGHER, Prenton (GB); Jens MELVANG, Mougins (FR); Markus KOCH, Graz (AT); Rodrigo Rosado GONZÁLEZ, Madrid (ES); Arun MURALI, Bengaluru (IN); Nils Sebastiaan MACKAIJ, Amsterdam (NL); Daniele FORONI, Chicago, IL (US); Harry HUGHES, Brisbane (AU); Jonathan Manuel, Kidderminster (GB)

(73) Assignee: STATS LLC, Chicago, IL (US)

(21) Appl. No.: 19/398,806

(22) Filed: Nov. 24, 2025

Related U.S. Application Data
(60) Provisional application No. 63/725,397, filed on Nov. 26, 2024.

(51) Int. Cl. G06F 16/75; G06F 16/25

(52) U.S. Cl. CPC G06F 16/75; G06F 16/258

(57) ABSTRACT

A method including receiving video data including a plurality of video frames captured during a sporting occasion, wherein each frame of the plurality of video frames includes data corresponding to one or more agents. The method including receiving event data associated with the video data. The method including processing the plurality of video frames and the event data to generate imputed tracking data, wherein the imputed tracking data includes positional data and movement data for each of the one or more agents. The method including determining one or more metrics based on the imputed tracking data, wherein the one or more metrics includes at least one of a pass option, a pressure, a line detection, and a marking. The method including determining an output based on the one or more metrics for the one or more agents.

### CROSS-REFERENCE TO RELATED APPLICATIONS

This application claims the benefit of priority to U.S. Provisional Patent Application No. 63/725,397, filed on Nov. 26, 2024, the entirety of which is incorporated herein by reference.

### FIELD OF INVENTION

Various embodiments of the present disclosure relate generally to sports analytics and data processing systems, and more particularly to systems and methods for automated transformation of sports tracking data into contextual metrics including player runs, phases of play, and tactical analysis using machine learning models that process frame-by-frame positional data combined with event data.

### BACKGROUND

Sports analytics has become increasingly sophisticated with the advancement of tracking technologies and data processing capabilities. Modern sporting occasions generate vast amounts of data through various tracking systems, including broadcast video feeds, in-venue camera systems, and wearable sensors that capture player movements, ball trajectories, and tactical formations. However, existing systems face limitations in providing comprehensive analysis due to incomplete data coverage, occlusions in broadcast footage, and the challenge of transforming raw positional data into meaningful tactical insights that can be readily understood by coaches, analysts, and broadcasters.

Current approaches to sports data analysis often rely on manual annotation of events or basic statistical aggregation of tracking information, which fails to capture the nuanced tactical behaviors and contextual relationships between players during different phases of play. The complexity of team sports involves intricate spatial and temporal dependencies between multiple agents, making it difficult to automatically identify and classify player movements, defensive formations, and attacking patterns. Additionally, broadcast tracking data frequently contains gaps and occlusions that limit the ability to perform comprehensive analysis, while existing methods struggle to integrate multiple data streams such as event data and positional tracking to provide a complete picture of gameplay dynamics.

The background provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, the techniques described herein relate to a computer implemented method for automated transformation of sports data for metric based output determination, including: receiving video data including a plurality of video frames captured during a sporting occasion, wherein each frame of the plurality of video frames includes data corresponding to one or more agents; receiving event data associated with the video data; processing the plurality of video frames and the event data to generate imputed tracking data, wherein the imputed tracking data includes positional data and movement data for each of the one or more agents; determining one or more metrics based on the imputed tracking data, wherein the one or more metrics includes at least one of a pass option, a pressure, a line detection, and a marking; and determining an output based on the one or more metrics for the one or more agents.

In some aspects, the techniques described herein relate to a computer implemented method, wherein the pass option identifies available passing opportunities for an object carrier based on the positional data and the movement data for each of the one or more agents.

In some aspects, the techniques described herein relate to a computer implemented method, wherein the pressure quantifies a defensive pressure applied to an object carrier based on a proximity of the one or more agents determined by the positional data and the movement data for each of the one or more agents.

In some aspects, the techniques described herein relate to a computer implemented method, wherein the line detection identifies one or more line-breaking actions when movement of at least one of an object or one or more agents penetrates through a detected defensive line.

In some aspects, the techniques described herein relate to a computer implemented method, wherein the marking identifies one or more defensive matchups by determining one or more defensive agents are within a threshold distance from an offensive agent.

In some aspects, the techniques described herein relate to a computer implemented method, wherein the one or more metrics includes a player run to identify one or more movement patterns for each of the one or more agents.

In some aspects, the techniques described herein relate to a computer implemented method, wherein the player run is categorized into at least one of an in-possession or an out-of-possession based on the positional data and the movement data for each of the one or more agents.

In some aspects, the techniques described herein relate to a computer implemented method, wherein the in-possession category includes one or more of an in to out, an out to in, a coming short, a dropping off, a supporting runs, an overlapping and underlapping runs, a runs ahead of an object, a runs in behind, and a cross option.

In some aspects, the techniques described herein relate to a computer implemented method, wherein the one or more metrics includes a phase of play that categorizes one or more portions of a sporting occasion into at least one of a recovery, a build-up, a progressive play, a counter-attack, and a set piece phase.

In some aspects, the techniques described herein relate to a computer implemented method, wherein the phase of play is determined by: determining one or more aggregated metrics corresponding to the one or more metrics associated with the one or more agents; determining one or more phase breakdowns based on the one or more aggregated metrics; and categorizing each of the one or more portions of the sporting occasion based on the one or more aggregated metrics and the one or more phase breakdowns.

In some aspects, the techniques described herein relate to a system for automated transformation of sports data for metric based output determination, the system including: a non-transitory computer readable medium configured to store processor-readable instructions; and a processor operatively connected to the non-transitory computer readable medium, and configured to execute the instructions to perform operations including: receiving video data including a plurality of video frames captured during a sporting occasion, wherein each frame of the plurality of video frames includes data corresponding to one or more agents; receiving event data associated with the video data; processing the plurality of video frames and the event data to generate imputed tracking data, wherein the imputed tracking data includes positional data and movement data for each of the one or more agents; determining one or more metrics based on the imputed tracking data, wherein the one or more metrics includes at least one of a pass option, a pressure, a line detection, and a marking; and determining an output based on the one or more metrics for the one or more agents.

In some aspects, the techniques described herein relate to a system, wherein the pass option identifies available passing opportunities for an object carrier based on the positional data and the movement data for each of the one or more agents, and wherein the pressure quantifies a defensive pressure applied to an object carrier based on a proximity of the one or more agents determined by the positional data and the movement data for each of the one or more agents.

In some aspects, the techniques described herein relate to a system, wherein the line detection identifies one or more line-breaking actions when movement of at least one of an object or one or more agents penetrates through a detected defensive line, and wherein the marking identifies one or more defensive matchups by determining one or more defensive agents are within a threshold distance from an offensive agent.

In some aspects, the techniques described herein relate to a system, wherein the one or more metrics includes a player run to identify one or more movement patterns for each of the one or more agents.

In some aspects, the techniques described herein relate to a system, wherein the player run is categorized into at least one of an in-possession or an out-of-possession based on the positional data and the movement data for each of the one or more agents.

In some aspects, the techniques described herein relate to a system, wherein the one or more metrics includes a phase of play that categorizes one or more portions of a sporting occasion into at least one of a recovery, a build-up, a progressive play, a counter-attack, and a set piece phase.

In some aspects, the techniques described herein relate to a non-transitory computer readable medium configured to store processor-readable instructions, wherein when executed by a processor, the instructions perform operations including: receiving video data including a plurality of video frames captured during a sporting occasion, wherein each frame of the plurality of video frames includes data corresponding to one or more agents; receiving event data associated with the video data; processing the plurality of video frames and the event data to generate imputed tracking data, wherein the imputed tracking data includes positional data and movement data for each of the one or more agents; determining one or more metrics based on the imputed tracking data, wherein the one or more metrics includes at least one of a pass option, a pressure, a line detection, and a marking; and determining an output based on the one or more metrics for the one or more agents.

In some aspects, the techniques described herein relate to a non-transitory computer readable medium, wherein the pass option identifies available passing opportunities for an object carrier based on the positional data and the movement data for each of the one or more agents, wherein the pressure quantifies a defensive pressure applied to an object carrier based on a proximity of the one or more agents determined by the positional data and the movement data for each of the one or more agents, wherein the line detection identifies one or more line-breaking actions when movement of at least one of an object or one or more agents penetrates through a detected defensive line, and wherein the marking identifies one or more defensive matchups by determining one or more defensive agents are within a threshold distance from an offensive agent.

In some aspects, the techniques described herein relate to a non-transitory computer readable medium, wherein the one or more metrics includes a player run to identify one or more movement patterns for each of the one or more agents, wherein the player run is categorized into at least one of an in-possession or an out-of-possession based on the positional data and the movement data for each of the one or more agents, and wherein the in-possession category includes one or more of an in to out, an out to in, a coming short, a dropping off, a supporting runs, an overlapping and underlapping runs, a runs ahead of an object, a runs in behind, and a cross option.

In some aspects, the techniques described herein relate to a non-transitory computer readable medium, wherein the one or more metrics includes a phase of play that categorizes one or more portions of a sporting occasion into at least one of a recovery, a build-up, a progressive play, a counter-attack, and a set piece phase.

The foregoing general description of the illustrative embodiments and the following detailed description thereof are merely exemplary aspects of the teachings of this disclosure and are not restrictive.

### BRIEF DESCRIPTION OF DRAWINGS

The accompanying drawings, which are incorporated in and constitute a part of this specification, illustrate various exemplary embodiments and together with the description, serve to explain the principles of the disclosed aspects.

FIG. 1 depicts a block diagram of an exemplary tracking and analytics environment, according to one or more embodiments.

FIG. 2A depicts an exemplary block diagram of a system for a transformer network for generating trajectories of players, according to one or more embodiments.

FIG. 2B depicts an exemplary block diagram of a system for a spatiotemporal axial attention for generating trajectories of players, according to one or more embodiments.

FIG. 2C depicts a flowchart for metric-based analysis using imputed tracking data, according to one or more embodiments.

FIG. 3 depicts a visualization of data received and determined by the system, according to one or more embodiments.

FIG. 4 depicts spatiotemporal axial attention as determined by a system, according to one or more embodiments.

FIG. 5 depicts a frame-by-frame metrics processing for sports data analysis, according to one or more embodiments.

FIG. 6A depicts output data comparing receiver models in broadcast tracking scenarios, according to one or more embodiments.

FIG. 6B depicts output data comparing imputed and in-venue receiver models across tracking scenarios, according to one or more embodiments.

FIG. 6C depicts output data comparing imputed and in-venue receiver models with field diagrams, according to one or more embodiments.

FIG. 6D depicts output data comparing performance metrics between receiver models, according to one or more embodiments.

FIG. 7 depicts a flowchart for automated transformation of sports data processing, according to one or more embodiments.

FIG. 8 depicts a marking interface showing agent positions on a sports field, according to one or more embodiments.

FIG. 9 depicts line-breaking patterns during sports gameplay, according to one or more embodiments.

FIG. 10 depicts off-ball runs output data for player movement analysis, according to one or more embodiments.

FIG. 11 depicts in-possession player runs categorization framework, according to one or more embodiments.

FIG. 12 depicts out-of-possession player runs categorization framework, according to one or more embodiments.

FIG. 13 depicts tables presenting phases of play data analysis, according to one or more embodiments.

FIG. 14 depicts tables presenting comparative phases of play metrics, according to one or more embodiments.

FIG. 15 depicts a table organizing player runs and movement characteristics, according to one or more embodiments.

FIG. 16 depicts a graphic showing player analysis categories and attributes, according to one or more embodiments.

FIG. 17 depicts exemplary phases of play categorizations, according to one or more embodiments.

FIG. 18 depicts a flow diagram for determining phases of play, according to one or more embodiments.

FIG. 19 depicts a flowchart for phase of play determination, according to one or more embodiments.

FIG. 20 depicts a phase of play interface displaying match statistics, according to one or more embodiments.

FIG. 21 depicts a flow diagram for training a machine learning model, in accordance with an aspect of the disclosed subject matter.

FIG. 22A depicts a block diagram illustrating a computing device, according to example embodiments.

FIG. 22B depicts another block diagram illustrating a computing device, according to example embodiments.

For simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various embodiments of the present disclosure relate generally to sports analytics and data processing systems, and more particularly to systems and methods for automated transformation of sports tracking data into contextual metrics including, for example, player runs, phases of play, and/or tactical analysis using machine learning models that process frame-by-frame positional data combined with tracking data and/or event data.

Unlike conventional sports analytics systems that rely on manual annotation of events or basic statistical aggregation, the present invention provides an automated transformation system that processes frame-by-frame positional data combined with event data using machine learning models. While existing systems face limitations due to incomplete data coverage, occlusions in broadcast footage, and difficulty in transforming raw positional data into meaningful tactical insights, the disclosed system may employ a transformer-based neural network with spatiotemporal axial attention mechanisms to generate complete tracking data from limited broadcast feeds. The disclosure addresses the challenge of integrating multiple data streams by utilizing a diffusion model that fuses broadcast tracking data with event data to synthesize highly photorealistic trajectories.

The system overcomes a permutation problem inherent in conventional approaches by implementing spatiotemporal axial attention, which processes temporal and spatial dimensions separately without imposing artificial ordering on agents. This approach enables the processing of multiple minutes of tracking context, addressing the limitation where players may remain occluded for extended periods. The invention further provides automated categorization of player movements into contextual metrics such as, for example, pass options, pressure analysis, line detection, marking identification, and phases of play classification, transforming raw tracking data into actionable tactical insights that can be readily understood by coaches, analysts, and broadcasters.

The disclosure offers several key advantages in sports data processing and analysis. The automated transformation system significantly reduces the computational complexity associated with processing multi-agent trajectory data by utilizing axial attention mechanisms. This efficiency improvement enables real-time processing of sporting occasions (e.g., sports events, games, matches, tournaments, sessions, etc.) while maintaining high accuracy in player tracking and tactical analysis. The system's ability to generate complete tracking data from incomplete feeds (e.g., in complete broadcast fees) addresses a fundamental limitation in sports analytics, providing comprehensive coverage even when players are occluded or outside the camera's field of view. This ability to generate complete tracking data from incomplete feeds is a substantial improvement in tracking technology, and more specifically to sports tracking technology.

The machine learning framework discussed herein may provide enhanced analytical capabilities by automatically identifying and classifying complex tactical behaviors that would otherwise require manual annotation. The system's integration of event data with positional tracking creates a multi-modal approach that captures both coarse-grained tactical formations and fine-grained movement patterns, enabling more nuanced analysis of gameplay dynamics. The automated phase of play categorization and player run classification provide coaches and analysts with immediate tactical insights, reducing the time required for post-match analysis while improving the depth and accuracy of performance evaluation compared to traditional statistical methods.

The technical framework disclosed herein may provide significant improvements to computer-based sports tracking technology by addressing fundamental computational challenges in multi-agent trajectory processing. The spatiotemporal axial attention mechanism reduces computational complexity from O(T²·E²) to O(T²)+O(E²), where T represents temporal sequence length and E represents the number of agents, enabling real-time processing of extended tracking sequences that were previously computationally intractable. The system's diffusion-based approach to trajectory synthesis may overcome technical limitations in conventional computer vision systems by generating smooth, physically plausible agent movements that eliminate jitter and teleportation artifacts commonly present in broadcast tracking data. The transformer-based neural network architecture processes multiple minutes of tracking context simultaneously, addressing the technical challenge where conventional systems fail when agents remain occluded for extended periods, thereby improving the robustness and reliability of automated sports tracking systems.

The disclosed system may further enhance computer functionality by implementing a novel multi-modal data fusion approach that integrates broadcast tracking data with event data streams through machine learning algorithms specifically designed for sports analytics applications. The automated transformation of raw positional coordinates into contextual tactical metrics represents a technical advancement in sports data processing, enabling computers to automatically identify complex spatial and temporal patterns that characterize player behaviors, defensive formations, and attacking strategies. The system's ability to generate complete tracking data from incomplete broadcast feeds addresses a specific technical problem in computer vision and tracking technology, where occlusions and limited camera coverage result in gaps that prevent comprehensive analysis. By synthesizing missing positional information through conditional guided diffusion, the system may provide a technological solution that improves the accuracy and completeness of computer-based sports tracking systems compared to conventional approaches that rely solely on direct visual observation.

The terminology used herein may be interpreted in its broadest reasonable manner, even though the terminology is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the embodiments disclosed herein. The specification and examples should be considered as exemplary only.

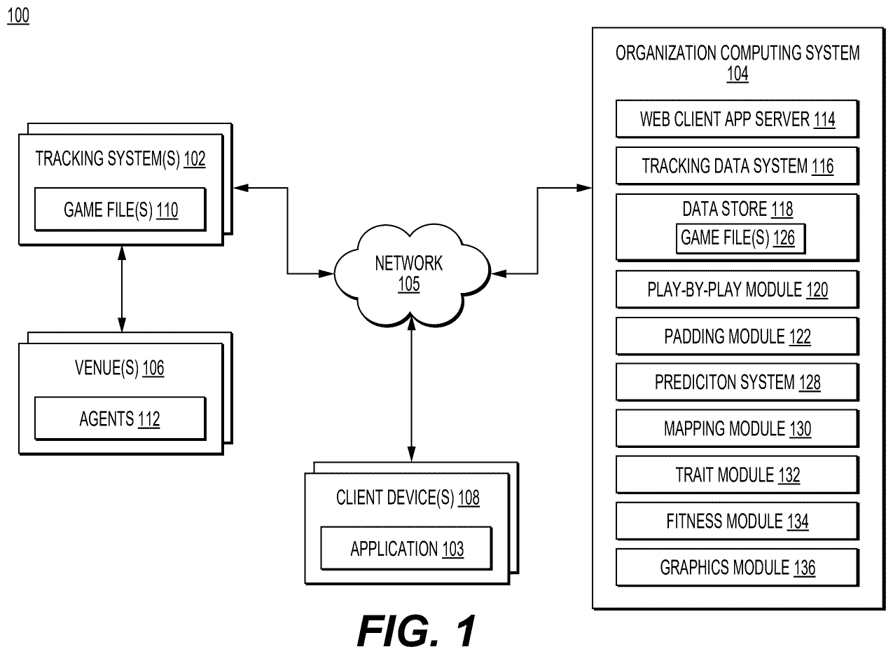

Referring to FIG. 1, illustrating a block diagram of a computing environment 100, according to example aspects of the disclosed subject matter. The computing environment 100 includes a tracking system 102, an organization computing system 104, and a client device 108 connected via a network 105. In the example depicted, the tracking system 102 obtains various measurements of game play, and transmits the measurements across network 105 to the organization computing system 104, where the measurements can be used in conjunction with one or more machine learning models. In an example, the one or more machine learning models described herein may be configured to receive as input broadcast tracking data and event data and to perform a conditional guided diffusion to generate trajectories for one or more players in a sporting occasion. The one or more machine learning models may further generate outputs based on the generated trajectories for the one or more players in the sporting occasion, including generating alternative trajectories for the one or more players, generating fitness outputs for the one or more players, generating traits for one or more players, generating predicted events and simulations related to the one or more players, generating graphics related to the one or more players, etc.

The tracking system 102 may be positioned in a venue 106 and/or may be in communication (e.g., electronic communication, wireless communication, wired communication, etc.) with components located at the venue 106. For example, the venue 106 may be configured to host a sporting occasion that includes one or more agents 112. The tracking system 102 may be configured to capture the motions of one or more agents (e.g., players) on the playing surface, as well as one or more other agents of relevance (e.g., ball, puck, referees, etc.). For simplicity, the present disclosure generally references “ball” when describing an object or an object related position or action. However, it will be understood that a reference to “ball” may be substituted for any applicable object (e.g., ball, puck, disk, shuttlecock, etc.) In some embodiments, the tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., the tracking system 102) may result in many different camera views of the playing surface (e.g., high sideline view, free-throw line view, huddle view, face-off view, end zone view, etc.).

In some embodiments, the tracking system 102 may be used for a broadcast feed of a given match. For example, the tracking system 102 may be used to generate one or more first game files 110 to facilitate a broadcast feed of a given match. In such embodiments, each frame of the broadcast feed may be stored in the one or more first game files 110. A broadcast feed may be a feed that is formatted to be broadcast over one or more channels (e.g., broadcast channels, internet-based channels, etc.). The one or more first game files 110 may be converted from a first format (e.g., a format output by the one or more cameras or a different format than the format output by the one or more cameras) and may be converted into a second format (e.g., for broadcast transmission).

As an example, broadcast tracking data may include the positions (e.g., x=(x, y)) of each entity (or player) at each time step on a playing surface. Broadcast tracking data may be generated and/or stored in a format different than the format of a game file or broadcast transmission. For example, a broadcast transmission may include video files, whereas broadcast tracking data may be generated or stored as digital representations of agents and/or objects in a format different than the format of the broadcast transmission (e.g., different than a video file format). In some embodiments, to represent the broadcast tracking data in a well-defined structure that avoids issues presented in conventional approaches, a pre-processing agent may construct a graphical representation of the broadcast tracking data. For example, a pre-processing agent may construct a graph G(V,E,U) that may be defined by nodes V, edges E, and global features U. In some embodiments, each node in a graph may represent the player and ball broadcast tracking data. In some embodiments, each edge may include information about various relationships between nodes. In some embodiments, edges eij may be directed edges and connect a sending node vi to a receiving node vj.

In some embodiments, the one or more first game files 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. The organization computing system 104 may generate the event data by, for example, analyzing broadcast tracking data (e.g., from the tracking system 102), and/or one or more other data types such as a video feed, excitement data, etc. The computing system may utilize a machine learning model to determine when given broadcast tracking data or changes in broadcast tracking data (e.g., given player movements, object movements, changes in the same, etc.) correspond to an event (e.g., a scoring event, a penalty event, a possession-based event, play type event, etc.). Event data may be automatically identified using a machine learning trained to receive, as an input, the one or more first game files 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on broadcast tracking data and/or content feeds (e.g., in-venue video feeds, broadcast feeds, etc.). For example, broadcast tracking data may be generated by providing a content feed to one or more machine learning models. The one or more machine learning models may identify players and/or objects in the content feed and convert them to digital representations. The digital representations of the players and/or objects and their respective positions may be tracked to identify broadcast tracking data such as movement data (e.g., changes in the positions), changes in movement, trends, etc. Such information may be used by a prediction module (e.g., a prediction system 128) to make predictions. The tracking data may be analyzed by the machine learning models to determine correlations between the broadcast tracking data and event types (e.g., goal scored, pass made, play types, etc.). For example, broadcast tracking data may be used to determine when a digital representation of an object (e.g., a ball) crosses a scoring object (e.g., a goal post). The determination may be based on, for example, detection of a triggering change between a first broadcast tracking data digital representation and a second broadcast tracking data digital representation, where the triggering change may be for a given event type. More specifically, the determination may be made based on a component or machine learning algorithm detecting the triggering change between the first broadcast tracking data digital representation and the second broadcast tracking data digital representation, and automatically identifying correlations between the triggering change and attributes associated with one or more event types. If a correlation meets a correlation threshold for a given event type, the triggering change may be associated with the given event type, and may be tagged as event data for that event type. Such automated event data detection may be performed, for example, by a machine learning model using input data (e.g., tracking data and/or game files) that are in a non-human readable format optimized for machine learning operations. Based on such determination, for example, an event type of a goal scored may be identified based on the broadcast tracking data. Further, the digital representation of the player(s) that contacted the object (e.g., ball) prior to the goal scored event may be identified as the player(s) that contributed to or otherwise caused the event (e.g., goal). Accordingly, content feeds may be used to generate broadcast tracking data which may further be used to determine event data corresponding to certain sports events.

The tracking system 102 may be configured to communicate with the organization computing system 104 via the network 105. For example, the tracking system 102 may be configured to provide the organization computing system 104 with a broadcast stream of a game or event in real-time or near real-time via the network 105. As an example, the tracking system 102 may provide the one or more first game files 110 in a first format (e.g., corresponding to a format based on the components of the tracking system 102). Alternatively, or additionally, the tracking system 102 or the organization computing system 104 may convert the broadcast stream (e.g., the one or more first game files 110) into a second format, from the first format. The second format may be based on the organization computing system 104. For example, the second format may be a format associated with a data store 118, discussed further herein.

The organization computing system 104 may be configured to process the broadcast stream of the game. The organization computing system 104 may include at least a web client application server 114, a tracking data system 116, the data store 118, a play-by-play module 120, a padding module 122, a prediction system 128, a mapping module 130, a trait module 132, a fitness module 134, and/or a graphics module 136. Each of the tracking data system 116, the play-by-play module 120, the padding module 122, the prediction system 128, and the mapping module 130, the trait module 132, the fitness module 134, and/or the graphics module 136 may be comprised of one or more software modules. The one or more software modules may be collections of code or instructions stored on a media (e.g., memory of the organization computing system 104) that represent a series of machine instructions (e.g., program code) that implements one or more algorithmic steps. Such machine instructions may be the actual computer code the processor of the organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

The data store 118 may be configured to store one or more second game files 126. The one or more second game files 126 may include video data of a given match. For example, the video data may correspond to a plurality of video frames captured by the tracking system 102, the broadcast tracking data derived from the broadcast video as generated by the tracking data system 116, play-by-play data, enriched data, and/or padded training data. The one or more second game files 126 may be based, for example, on the one or more first game files 110 as discussed herein. The one or more second game files 126 may be in a different format than the one or more first game files 110. For example, a first format of the one or more first game files 110 or a subset thereof may be transformed into a second format of the one or more second game files 126. The transformation may be performed automatically based on the type and/or content of the first format and the type and/or content of the second format.

The tracking data system 116 may be configured to receive broadcast data from the tracking system 102 and generate broadcast tracking data from the broadcast data. In some embodiments, the tracking data system 116 may apply an artificial intelligence and/or computer vision system configured to derive broadcast tracking data from broadcast video feeds.

To generate the broadcast tracking data from the broadcast data, the tracking data system 116 may, for example, map pixels corresponding to each player and ball into dots and may transform the dots into a semantically meaningful event layer, which may be used to describe player attributes. For example, the tracking data system 116 may be configured to ingest broadcast video received from the tracking system 102. In some embodiments, the tracking data system 116 may further categorize each frame of the broadcast video into trackable and non-trackable clips. In some embodiments, the tracking data system 116 may further calibrate the moving camera based on the trackable and non-trackable clips. In some embodiments, the tracking data system 116 may further detect players within each frame using skeleton tracking. In some embodiments, the tracking data system 116 may further track and re-identify players over time. For example, the tracking data system 116 may reidentify players who are not within a line of sight of a camera during a given frame. In some embodiments, the tracking data system 116 may further detect and track an object across a plurality of frames. In some embodiments, the tracking data system 116 may further utilize optical character recognition techniques. For example, the tracking data system 116 may utilize optical character recognition techniques to extract score information and time remaining information from a digital scoreboard of each frame.

Such techniques assist in the tracking data system 116 generating broadcast tracking data from the broadcast feed (e.g., broadcast video data). For example, the tracking data system 116 may perform such processes to generate broadcast tracking data across thousands of possessions and/or broadcast frames. In addition to such process, the organization computing system 104 may go beyond the generation of broadcast tracking data from broadcast video data. Instead, to provide descriptive analytics, as well as a useful feature representation for the prediction system 128, the organization computing system 104 (via the tracking data system 116) may be configured to map the tracking data to a semantic layer (e.g., events). Mapping the tracking data to a semantic layer is discussed in greater detail below.

The tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

The play-by-play module 120 may be configured to receive play-by-play data from one or more third party systems. For example, the play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module 120 may utilize machine learning outputs and/or manually annotated data that may reflect the referee's ultimate adjudication. Such data may be referred to as the play-by-play feed.

To help identify events within the broadcast tracking data, the tracking data system 116 may merge or align the play-by-play data with the broadcast tracking data (which may include the game and time fields). The tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system 116 may be configured to perform various operations on the aligned tracking system. For example, the tracking data system 116 may use the play-by-play data to refine the player and ball positions and precise frame of the end of possession events (e.g., shot/rebound location). In some embodiments, the tracking data system 116 may further be configured to detect events, automatically, from the tracking data. In some embodiments, the tracking data system 116 may further be configured to enhance the events with contextual information.

For automatic event detection, the tracking data system 116 may include a neural network system trained to detect/refine various events in a sequential manner. For example, the tracking data system 116 may include an actor-action attention neural network system to detect/refine one or more of: shots, scores, points, rebounds, passes, dribbles, penalties, fouls, and/or possessions. The tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

The padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, the padding module 122 may be configured to utilize a padding method, which may be a weighted average between the observed values and sample mean.

Accordingly, for each player, the tracking data system 116, the play-by-play module 120, and the padding module 122 may work in conjunction to generate a raw data set and a padded data set for each player.

The prediction system 128 may include a transformer neural network that may include one or more encoders and/or decoders. The transformers may be further configured to generate prediction(s) for the trajectory of one or more players during a match based on the broadcast tracking data and on the event data.

The prediction system 128 may include a diffusion model capable of generating multi-agent tracking data. The prediction system 128 may be configured to generate or simulate the remainder of a given match at the player trajectory level. For example, instead of generating trajectories for a possession, the prediction system 128 may be configured to generate trajectories for multiple possessions and even for the remainder of a sporting occasion. Further, the prediction system 128 may be further configured to generate event data for the game. In this manner, the prediction system 128 may be used to generate the commentary of a game via text/speech or 3D models of player behaviors. The prediction system 128 may further output data (e.g., the trajectories of the one or more players) to the mapping module 130, the trait module 132, the fitness module 134, or the graphics module 136 to perform downstream analysis of the data determined by the prediction system 128 described above.

Accordingly, downstream applications may be performed using the data output by the prediction system 128, such data including data generated by and/or output via a transformer neural network and/or diffuser, as discussed herein. Such data may be considered complete (e.g., imputed) tracking data that is in a format and in a form (e.g., in a complete form that mitigates gaps in information) that can be used by such downstream applications for downstream analysis. Generation of such data represents an improvement in technology for use with downstream applications such that, for example, the quality of the downstream applications and the possibility of performing such downstream analysis is improved based on generating such data using the transformer neural network and/or diffusion techniques disclosed herein.

The mapping module 130 may be configured or trained to generate a connection and/or association with prompts of a multimodal sports large language model (LLM) and user inputs (e.g., audio, speech, drawings, video, etc.). For example, the mapping module 130 may be configured to receive a user input (e.g., audio/speech) requesting information relating to a play within a specific match (e.g., goal scored by Manchester United against Liverpool). The mapping module 130 may generate one or more connections and/or associations with the user input, an event stream (e.g., match between Manchester United against Liverpool), and the data (e.g., trajectories) output by the prediction system 128. Based on the generated connections, the mapping module 130 may be configured to determine event data via the data (e.g., trajectories) output by the prediction system 128, the event stream, and the user input. The mapping module 130 may output one or more graphics, text, audio, or a combination thereof based on the determined connections and/or associations.

In some embodiments, the mapping module 130 may include a separate mapping model tuned for each input type (e.g., audio, text, drawing, video, etc.). Given that each input is very different from each other, there may be times that a single mapping model may have trouble determining connections and/or associations. In such scenarios, one or more individual mapping models may be employed for a single user input. For example, upon receiving a user input (e.g., speech and drawing), the mapping module 130 may utilize one or more mapping models for each input type received. The one or more mapping models may determine one or more connections and/or associations from the received inputs. Based on the determined one or more connections, the mapping module 130 may output one or more graphics and texts corresponding to the user inputs.

The trait module 132 may be configured or trained to generate or identify player and/or team traits using event data, broadcast tracking data, and/or data (e.g., trajectories) output by the prediction system 128. Player and/or team traits (e.g., pass prediction, decision making, continuous xG) may be used by one or more machine-learning models to predict outcomes for a player and/or a team. For example, event data may include information relating to the option or availability to pass or shoot the ball at one or more points in time during a match. This information may be used to generate a pass prediction trait for a player and a team. The pass prediction trait may be further used by one or more machine-learning models (e.g., the prediction system 128) to predict a pass versus shot in a future scenario based on the trajectories output by the prediction system 128. This information may be used to generate graphic and/or text information for broadcasters or individual users.

Another example of generating trait information may include performance under pressure. As similarly described above, event data, broadcast tracking data, and/or data (e.g., trajectories) relating to performance under pressure may be collected and/or aggregated. Once the trait (e.g., performance under pressure) has been generated, individual users may utilize this trait. For example, a coach may use this information in preparation for an upcoming match. The trait information may relate to one or more players on either team. Coaches may utilize this information to determine different match-ups or markings for an upcoming match as well as which players to use to optimize their chances throughout the match. In addition, individual end users (e.g., fans, fantasy players, etc.) may utilize this information to determine how to set their line-up for an upcoming match in their fantasy league.

The fitness module 134 may be configured or trained to generate or identify one or more fitness metrics of a player based on data output by the prediction system 128. Fitness metrics can relate to movements, defensive intensity of the player, offensive intensity of the player, trajectories output by the prediction system 128, etc. Example fitness metrics can include player sprints, jogs, on-court time with no movement, average distance to an offensive player during a pick-and-roll or screen, etc. The fitness metrics can each include scores (e.g., 0-100 scores) that can be aggregated to determine an overall fitness metric of the player. In some instances, fitness metrics can be based on different time ranges that the player is on the court. In this example, if the player spends most of their time on the court with no movement (based in part by the trajectories output by the prediction system 128), the fitness metrics of that player can be negatively impacted as the game progresses.

The graphics module 136 may be configured to generate one or more graphics and texts relating to event data, broadcast tracking data, and/or data (e.g., trajectories) output by the prediction system 128 relating to one or more players or teams. For example, the graphics module 136 may receive event data related to a goal being scored by a player, and generate a graphic illustrating the player making the goal as well as text relating to the goal, such as the time when the goal was scored and the total score of the game.

The client device 108 may be in communication with the organization computing system 104 via the network 105. The client device 108 may be operated by a user. For example, the client device 108 may be a mobile device, a tablet, a desktop computer, or any computing system having the capabilities described herein. Users may include, but are not limited to, individuals such as, for example, subscribers, clients, prospective clients, or customers of an entity associated with the organization computing system 104, such as individuals who have obtained, will obtain, or may obtain a product, service, or consultation from an entity associated with the organization computing system 104.

The client device 108 may include one more applications 103. The application 103 may be representative of a web browser that allows access to a website or a stand-alone application. The client device 108 may access the application 103 to access one or more functionalities of the organization computing system 104. The client device 108 may communicate over the network 105 to request a webpage, for example, from the web client application server 114 of the organization computing system 104. For example, the client device 108 may be configured to execute the application 103 to access content managed by the web client application server 114. The content that is displayed to the client device 108 may be transmitted from the web client application server 114 to the client device 108, and subsequently processed by the application 103 for display through a graphical user interface (GUI) of the client device 108.

The client device 108 may include a display. Examples of the display include, but are not limited to, computer displays, Light Emitting Diode (LED) displays, and so forth. Output or visualizations generated by the application 103 (e.g., a GUI) can be displayed on or using the display.

Functionality of sub-components illustrated within the organization computing system 104 may be implemented in hardware, software, or some combination thereof. For example, software components may be collections of code or instructions stored on a media such as a non-transitory computer-readable medium (e.g., memory of the organization computing system 104) that represent a series of machine instructions (e.g., program code) that implements one or more method operations. Such machine instructions may be the actual computer code the processor of the organization computing system 104 interprets to implement the instructions or, alternatively, may be a higher level of coding of the instructions that is interpreted to obtain the actual computer code. The one or more software modules may also include one or more hardware components. Examples of components include processors, controllers, signal processors, neural network processors, and so forth.

The network 105 may be of any suitable type, including individual connections via the Internet, such as cellular or Wi-Fi networks. In some aspects, the network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some aspects, however, the information being transmitted may be less personal, and therefore, the network connections may be selected for convenience over security.

The network 105 may include any type of computer networking arrangement used to exchange data or information. For example, the network 105 may be the Internet, a private data network, virtual private network using a public network and/or other suitable connection(s) that enables components in the computing environment 100 to send and receive information between the components of the computing environment 100.

The system described herein may implement an imputation method that processes broadcast tracking data, fuses broadcast tracking with event data, and utilizes generative AI models to synthesize highly photorealistic trajectories. The output generated based on these techniques may include complete (e.g., imputed) tracking data that is in a form and format that can be used for downstream applications as discussed herein.

The first step of imputation may be to encode broadcast tracking data, which may form a signal for inferring the locations of occluded agents. Two challenges of encoding tracking data may be: (1) modeling each agent's past behaviors, and (2) representing inter-agent spatial dynamics. In the systems described herein, a first challenge may be especially difficult, because players often remain occluded for long periods of time (e.g., up to a minute). To address this challenge, the techniques disclosed herein include encoding a large contextual window (e.g., multiple minutes) of broadcast tracking at a time.

In conventional systems, tracking data may have been visualized as a two-dimensional top-down image and processed through computer vision models. However, while the agents' spatial inter-relationships can be perceived from a single image, the agents' long-term temporal histories cannot. Furthermore, the high dimensionality of images may make it intractable to jointly process more than a few consecutive image frames at a time. In the systems described herein, where multiple minutes of tracking context is required, image-based approaches may not be utilized based on the problems described above.

Tracking data may be an inherently compressed data representation, and therefore it may be more efficient to impute behaviors by using a direct stream of data. One important challenge of using tracking data directly is the permutation drawbacks discussed above. AI models generally assume that their inputs are consistently ordered (e.g., words passed to an LLM are entered sequentially). However, there may be no natural ordering of players that persists from frame to frame and from game to game, which means that conventional standard deep learning models may be forced to learn the same relationships for each of the, for example, (10!)² possible permutations of agent orderings (the number of ways in which the two teams of 10 outfield players can be ordered). One approach that conventional systems have implemented to address the permutation problem may be to consistently order players by inferring their instantaneous spatial role within a formation template. This method may be limited by its use of a single static template, failing to represent how player roles change depending on the current phase of play (e.g., corners, dead-balls, counterattacks).

Another approach that conventional systems have implemented to address the permutation problem may be by using permutation invariant models (models where changing the order of the players has no impact on the model's output). One such family of models that have this property may be Graph Neural Networks, which may encode information that has an underlying graph structure. These models may have been applied to sports tracking in conventional systems by representing each agent as a node in a fully connected graph, (where there is an edge between every pair of nodes). While formulating tracking data as a graph may solve the spatial modelling challenge, existing applications may have only endowed GNNs with short-term temporal context (e.g., <10 seconds).

The systems described herein may utilize a transformer based neural network that may primarily rely on, for example, self-attention. For a given collection of tokens (e.g., a sequence of words) the attention mechanism will infer each token's (e.g., word's) dependence on every other token from large amounts of training data, and each token is updated with the context with respect to all other tokens. From the success of the attention mechanism on language modeling problems, transformers can learn complex long-term interdependencies within sequential data. This may make transformers an appealing model for encoding tracking data, which contains long-term spatial and temporal dependencies.

The system described herein may utilize a transformer based neural network (e.g., the prediction system 128) to fuse multi-agent trajectory with a sport's semantic even stream data. The prediction system 128 may implement a score-based diffusion framework as described below.

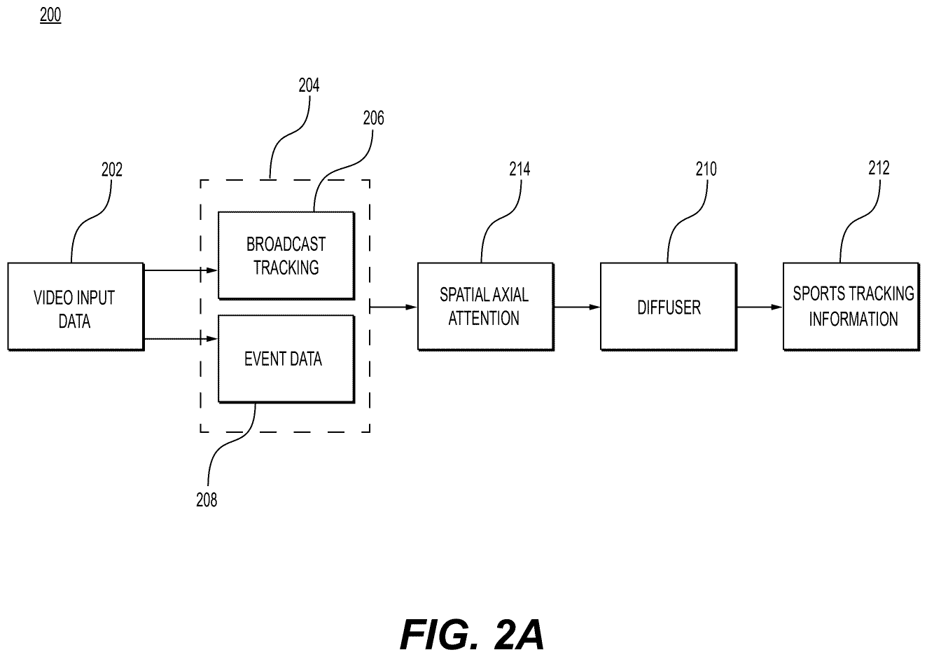

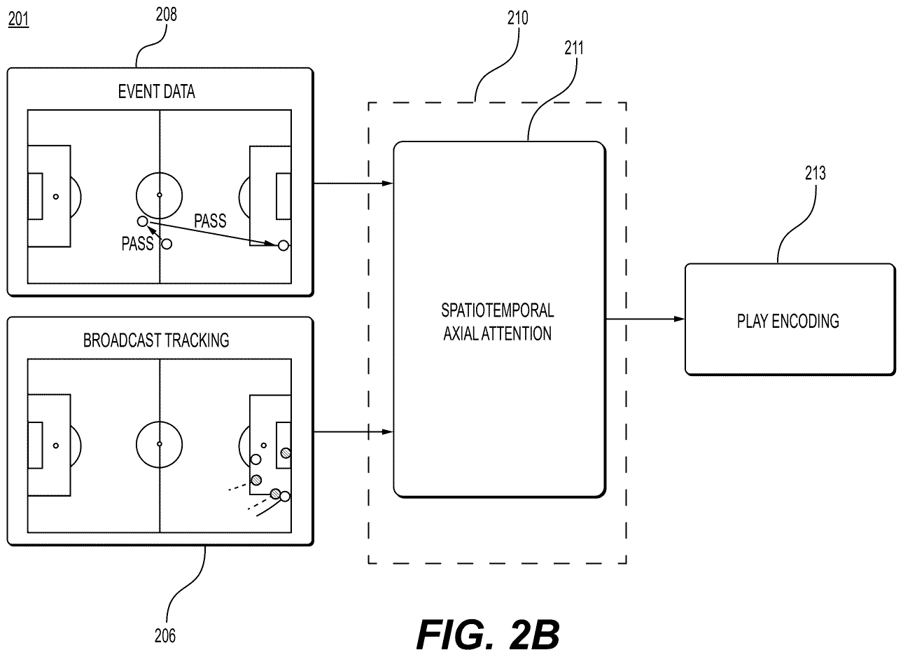

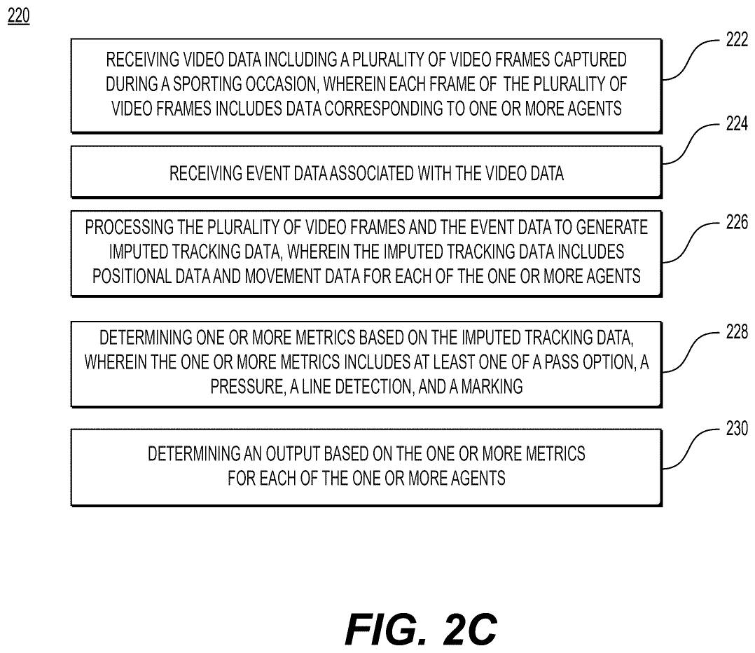

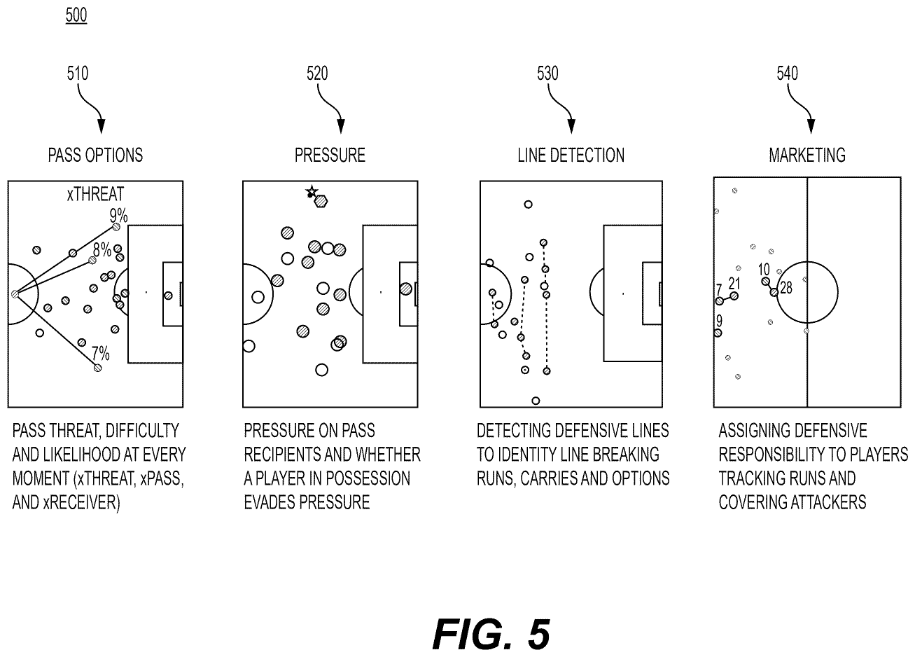

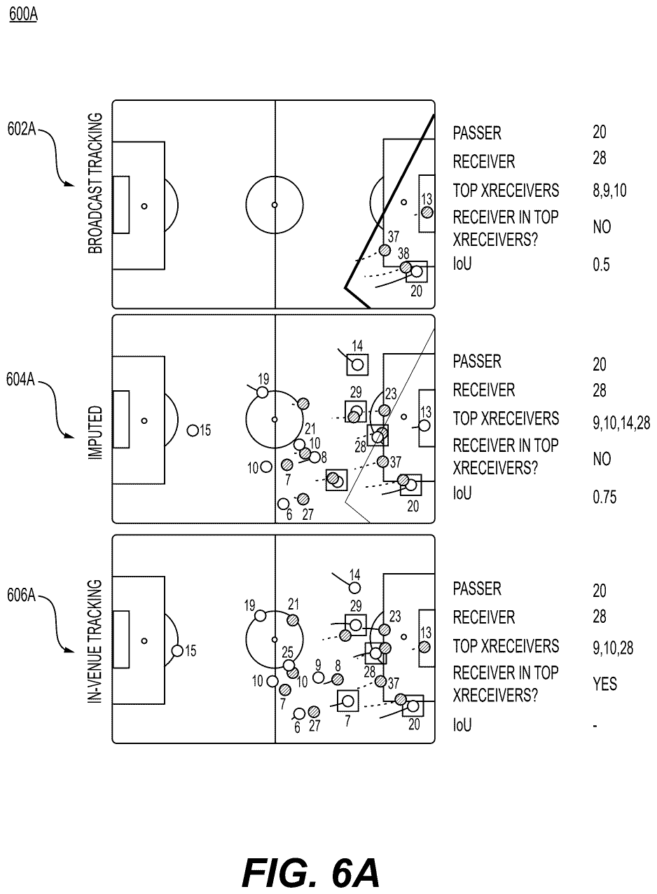

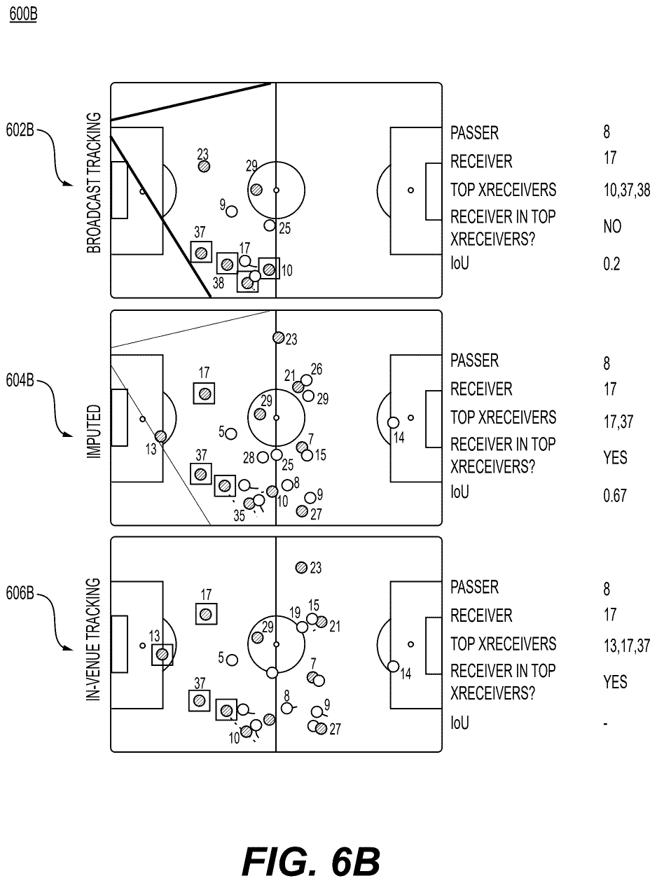

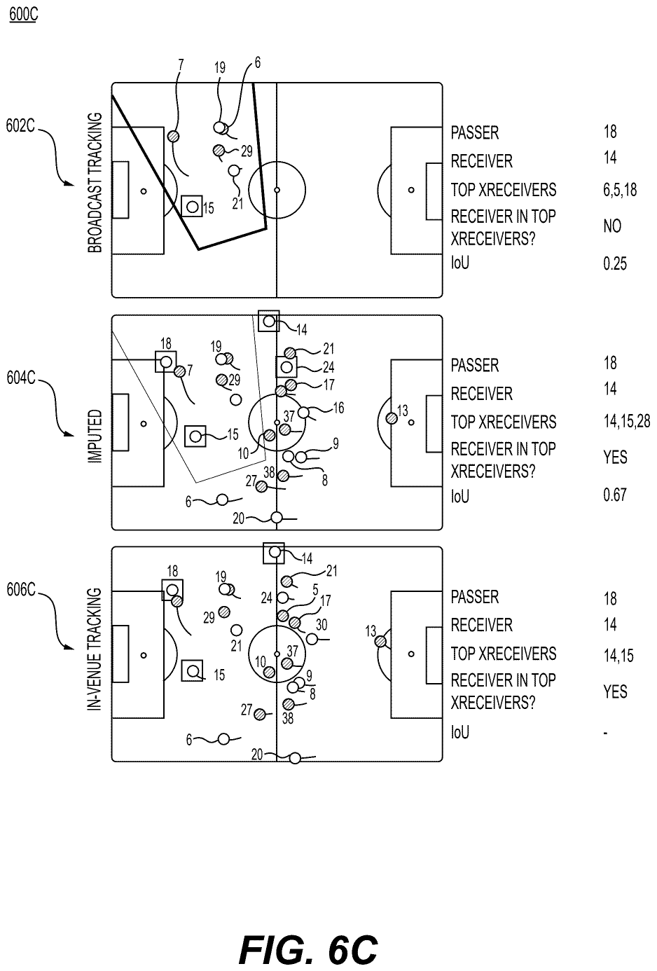

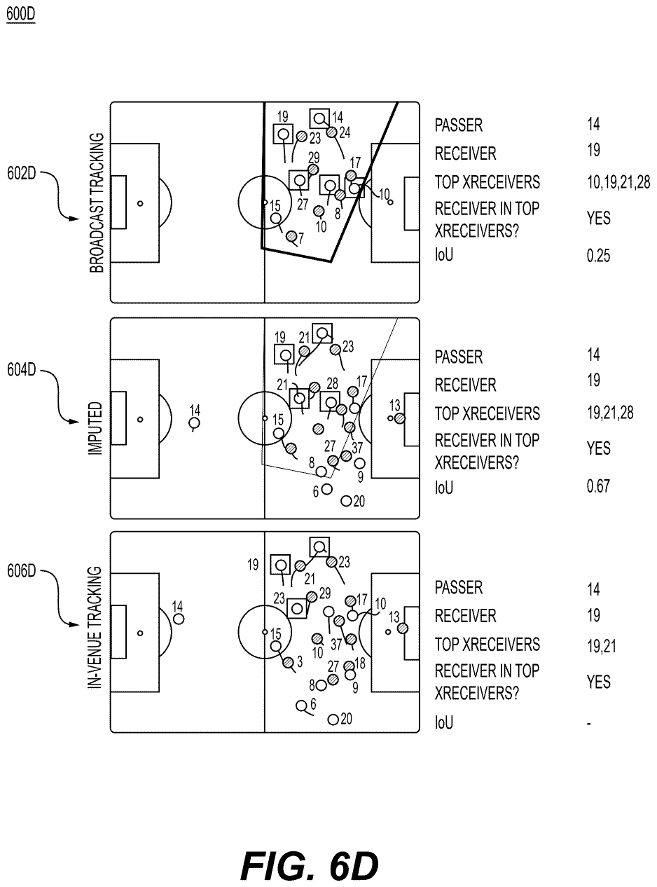

FIGS. 2A-4 are generally directed to generating imputed tracking data (e.g., based on video input data such as broadcast data). FIG. 5 is generally directed to downstream techniques for using imputed data. FIGS. 6A-6D are generally directed to differences in data types for performing the downstream techniques discussed in FIG. 5. Subsequent figures are generally directed to performing the downstream techniques using imputed data.

FIG. 2A illustrates an exemplary block diagram of a system 200 for a transformer network (e.g., a diffuser 210) to generate trajectories of agents (e.g., sports tracking information 212), according to one or more embodiments. The system 200 may, for example, provide conditional guided diffusion (e.g., by the diffuser 210) to generate one or more trajectories for an agent (e.g., the sports tracking information 212) from a limited vision (e.g., from a video input data 202 that includes occlusions).

The sports tracking information 212 generated by the system 200 may represent complete (e.g., imputed) trajectory data and contextual metrics for agents within the sporting occasion, providing comprehensive tracking outputs that fill gaps present in the original video input data 202 through the automated transformation process described in the system 200.

The system 200 may include the video input data 202 (e.g., broadcast feed, etc.) of a sports broadcast. As previously discussed, the video input data 202 may be generated by the tracking system 102. The video input data 202 may for example have a limited receptive field. For example, occlusions may occur where a subset of players cannot be visually displayed by the video input data 202. These occlusions may occur from diverse sources, caused by a broadcast camera's limited monocular receptive field, close-ups, replays, and alter-native camera angles. The video input data 202 (e.g., broadcast feed) may be a subset of geospatial data. Geospatial data may be any content, information, or feed that may allow tracking of one or more agents or objects, as further discussed herein. For example, geospatial data may refer to broadcast footage, in-venue footage, global satellite positioning (GPS) data, radio-frequency identification data (RDIF), Near Field Communication (NFC), triangulation data, and/or the like. Geospatial data and subsequently processed geospatial data (e.g., by the tracking data system 116) may be received as input by the diffuser 210 described herein. Video input data 202 may refer to broadcast footage or an in-venue computer vision system output which may be or include, for example, raw video content (as discussed above). An in-venue computer vision system may, for example, record video footage of an entire field of play throughout and entire match.

The video input data 202 may be input into the tracking data system 116. The tracking data system 116 may perform one or more functions. As previously discussed, the tracking data system 116 may generate a broadcast tracking data 206. The broadcast tracking data 206 may be determined by one or more computer vision algorithms. The broadcast tracking data 206 may, for example, be output as multi-agent trajectories for each of the players in a match. The one or more computer vision algorithms may be configured to (1) detect players in a sporting occasion; (2) classify the detected players into one or more teams; (3) identify a “logical identity” to the identified players in order to maintain identity and track players over a temporal sequence; (4) identify a ground plane of the sporting occasion; and/or (5) identify the assigned number of each player on the field. The one or more computer vision algorithms may further provide a tracking of identified players over time. The broadcast tracking data 206 may for example be stored in a JavaScript Object Notation (JSON) file. The broadcast tracking data 206 may, for example, as previously discussed, include the two-dimensional tracking of one or players in a match, the players respective team, and the player's respective identifying number (e.g., a player's respective jersey number).

The broadcast tracking data 206 may be based on publicly or privately available broadcast data and/or footage related to a sports event generated or broadcasted at least in part using one or more cameras or camera systems of the tracking system 102 of FIG. 1. The broadcast tracking data 206 may include a tracking stream determined using computer algorithms applied to a broadcast feed. The tracking stream may represent the movement of an agent (e.g., a player, other individual, object, etc.). The broadcast tracking stream may be represented as b∈R^{T×E×D}b, where each observation contains the agent's 2D coordinate, agent-type (i.e., outfield player, ball, goalkeeper, etc., team affiliation, and indicators as to whether the ball is in-play, and whether the agent is visible.

A second function of the tracking data system 116 may be to determine an event data 208. As previously discussed, the event data 208 may refer to the sequential stream of all major events (e.g., actions) throughout the sporting occasion (e.g., pass, shot, tackle, foul, turnover, penalty, goal, score, substitution, etc.). The event data 208 may provide an essential signal for reconstructing the sections of games that are not covered by raw broadcast tracking data. The event data 208 may be detected or generated by any of the methods previously discussed herein. The event data 208 may, for example, be automatically detected by a computing system or input from a user reviewing the video input data 202. As another example, the event data 208 may be input by a user viewing the video input data 202 (e.g., a broadcast feed). The event data 208 may be unified to be a two-dimensional spatiotemporal grid. This may be performed by stacking (with padding) each player's events, forming an event stream s∈R^{L×E×D}s where L is the maximum number of events performed by a single agent over a specified time horizon, and each event includes the event's time stamp, 2D coordinates, agent-type, and event category (e.g., pass). Event data 208 may be referred to as “labeled event data” herein.

As shown via block 204, the determined broadcast tracking data 206 and the event data 208 may, for example, be input to the diffuser 210. The diffuser 210 may incorporate a transformer based-neural network. The diffuser 210 may include an encoder (e.g., for operations related at least in part to the event data 208) and one or more tracking decoders (e.g., for fusion of the event encoder output and the broadcast tracking data 206), as further discussed herein. The diffuser 210 may generate and output trajectories as sports tracking information 212. These may be output as vectors for further analysis and/or presentation. The diffuser 210 may be part of the tracking data system 116.

As discussed above, processed geospatial data may be received as input by the diffuser 210 (e.g., in place of or in addition to the video input data 202). For example, the geospatial data may be based on wearable technology worn by the one or more agents on the field. For example, GPS, RFID, and/or NFC data may be received by the system 200. GPS, RFID, and/or NFC data may correspond to location data tracked using GPS sensors, satellite tracking, proximity sensors, tags, and/or the like. Such location data may provide useful context to the system 200 when sensor information (e.g., broadcast data, in-venue sensor information, etc.) is noisy or missing. Alternatively, or additionally, the geospatial data may be based on an in-venue computer vision system. The in-venue computer vision data may be utilized to denoise the input (or merge together in the event data 208). The event data 208 may be received in and/or transformed into the frame of reference which is being tracked. For example, the event data may have a frame of reference from (0, 0, 100, 100) whereby the filed coordinate may be (0, 0, 106, 68). Accordingly, the event data may be transformed into the (0, 0, 100, 100) frame of reference using any applicable scaling technique such as a transformation, transfer, normalization, and/or the like.

Further, the diffuser 210 may be configured to receive labeled inputs such as human labeled inputs (e.g., a labeled version of the event data 208). The system 200 may be configured to impute the position of one or more agents and/or objects based on the event data 208 (e.g., based on the labeled version of the event data 208). Such a labeled input may be received, for example, in text form and may be converted to tracking data based on analysis of the text and/or based on providing the text to a machine learning model trained to output tracking data based on labeled text inputs. In another example, the system may be configured to impute the event data 208 based on one or more inputs discussed herein. For example, the imputation may output the frame on what time interval an event occurred.

The diffuser 210 may further be configured to receive output data from a spatial axial attention module 214. The spatial axial attention module 214 may be a separate component than the diffuser 210, as illustrated herein, or as part of the diffuser 210 as similarly described in FIG. 2B. The spatiotemporal axial attention module 214 may be configured to determine and/or predict the one or more agents (e.g., player) location even when the one or more agents may not be visible within a current video frame (e.g., the broadcast tracking 206), utilizing spatiotemporal dependencies extracted from tracking data to infer where occluded or off-screen players should be positioned based on tactical context and team formation patterns. The spatiotemporal axial attention module 214 may generate positional data and/or predictions by analyzing the spatial relationships between visible players and applying learned movement patterns to estimate the locations of each visible and/or non-visible player, enabling complete tactical analysis even during periods of incomplete visual coverage in broadcast footage. Diffusion techniques may be applied by the diffuser 210 on top of the spatial axial attention module 214 to achieve a diverse set of predictions and not just a coarse deterministic prediction (e.g., to output realistic motion of players based on the output of the spatiotemporal axial attention module 214 processed through diffuser 210 to generate the realistic motion such as motion without jitter and/or other non-realistic or less-realistic attributes). Additional methods that may applied on top of the spatial axial attention module 214 include another set of temporal filters such as Kalman filters, a long short-term memory (LSTM), and/or additional temporal filters. However, diffusion may provide the most accurate results. The spatial axial attention module 214 may extract spatiotemporal dependencies from the tracking data. In an example, the spatial axial attention module 214 may be configured to, for a given pass, determine what the probability is that each attacking player will be the pass receiver. This may be referred to as the xReceiver metric as will be described in more detail below. The spatial axial attention module 214 may further be configured to perform “ghosting” which may refer to a prediction of an optimal location where a player should have been to minimize the likelihood of a pass, or shot, or goal (xG). In another example, the spatial axial attention module 214 may be configured to predict which playing style (e.g., a counter-attack) the team is using or the type of run a player is executing (e.g., an active run). The output of the diffuser 210 may be provided via the sports tracking information 212, which may include determined and/or predicted realistic motion of agents and/or objects).

FIG. 2B illustrates an exemplary block diagram of a system 201 for a spatiotemporal axial attention for generating trajectories of agents, according to one or more embodiments. The system 201 of FIG. 2B may include the event data 208 and the broadcast tracking data 206 discussed in reference to FIG. 2A. The event data 208 and broadcast tracking data 206 may be input into the diffuser 210, also discussed in reference to FIG. 2A. The diffuser 210 may include a spatiotemporal axial attention mechanism 211, as described in more detail below, that is configured to output the sports tracking information 212. In certain instances, spatiotemporal axial attention mechanism 211 may provide additional technical capabilities (e.g., improved imputed tracking data outputs) in comparison to the spatial axial attention model 214 of FIG. 2A. The output player encoding 213 may be sports tracking information that refers to the captured information necessary to fully reconstruct a play (e.g., all players and the ball). The output player encoding 213 maybe utilized to define the play of the game, and it may further be used to detect specific aspect of a game such as passing options (e.g., for downstream analysis).

Denoising diffusion models may be implemented by the system 201 described herein (e.g., by diffuser 210). Such diffusion models are described below. Such diffusion models may consider the family of distributions p(x, σ) where Gaussian noise of standard deviation σ is added to a data distribution p_{data}(x) with standard deviation σ_{data}. Where the Gaussian noise standard deviation may be maximized (i.e., σₘₐₓ), this perturbed data distribution may be virtually indistinguishable from pure Gaussian noise. Samples from this data distribution may thus be generated by iteratively denoising x₀˜N(0, σ²ₘₐₓI) over range σₘₐₓ, . . . , σ_{N-2}, σ_{N-1} such that xi˜p(xi, σi). Score-based diffusion models may frame this reverse diffusion process as an ordinary differential equation (ODE) where the derivative of the noised sample x is given by:

$$dx = - ( t ) σ ( t ) ▽ x log p ( x , σ ) , \qquad ( 1 )$$

Where ∇ₓ log p(x, σ) gives the score function, σ(t) is the noise level at diffusion step t, and \grave{σ}(t) is the time derivative of σ. The score function may be a vector field that gives the direction where the probability density function grows most quickly, from which the underlying probability density function can be inferred. The probability distribution's score function can be obtained by training a conditional de-noising model D_{θ}(x, σ, c) parameterized by θ to minimize the L2 reconstruction loss between the perturbed and original data sample,

$$E σ ∼ q ( σ ) Ex , c ∼ pdata En ∼ N ( 0 , {σ}^{2} I ) ‖ D θ ( y ; σ , c ) - x ‖ 2 , \qquad ( 2 )$$

Where q denotes the distribution of σ during training and y=x+n. Following this definition, the score is given by:

$${▽}_{y} log p ( y ; σ , c ) = ( {D}_{θ} ( y ; σ , c ) ) - x ) / {σ}^{2} \qquad ( 3 )$$

Training and preconditioning may be implemented for a diffuser model used herein. Such models (e.g., deep models) may learn most effectively when their inputs and outputs are scaled to have unit variance. Furthermore, at low values of σ it may be easier to predict the noise level n, whereas at high values of σ it is easier to predict the clean original signal x. Consequently, rather than directly returning the raw output of the denoiser neural network, the diffuser described herein (e.g., the diffuser 210) may add preconditioning terms to both scale the variance of the model's inputs, and a skip connection to enable the model to adaptively predict either the noise level or the clean signal for different levels of σ. The denoiser can be written as:

$${D}_{θ} ( y ; σ , c ) = {c}_{skip} ( σ ) y + {c}_{out} ( σ ) {F}_{θ} ( {c}_{input} ( σ ) y ; {c}_{noise} ( σ ) , c ) \qquad ( 4 )$$

Such that F_{θ} is the raw neural network's output, cᵢₙₚᵤₜ modulates the perturbed trajectory's variance, cₙₒᵢₛₑ modulates the noise's variance, cₒᵤₜ modulates the output's variance, and cₛₖᵢₚ modulates the skip connection. To normalize losses over the σ range, the per-sample reconstruction losses are scaled by term λ(σ)=1/c². c may represent a raw input to the neural network, and may be assumed to be modulated.

Constrained sampling may be applied by the diffuser described herein. The diffusion model described herein (e.g., the diffuser 210) may learn the conditional score function ∇y log p(y, σ, c) of the probability distribution of multi-agent trajectory sets. However, it is often preferable to sample from the joint score function:

$${▽}_{y} log p ( y ; σ , c ) + {▽}_{y} log q ( y ; σ , c ) \qquad ( 5 )$$

Where the second term represents the constraint gradient score for manifold q over y. This constraint manifold may represent any loss function: L:R^{T×E×2}→R that can be differentiated with respect to y. Scaled by hyper parameter α, the constraint gradient score can be calculated as:

$${▽}_{y} log q ( y ; σ , c ) ) = α \frac{\partial }{\partial y} L ( {D}_{θ} ( y ; σ , c ) ) . \qquad ( 6 )$$

With the ODF dynamics described in equation (1) above, sampling from the diffuser 210 may be performed using, for example, approximately 128 inference steps of the Henu sampler.

In order to prepare (e.g., train) and/or validate the diffuser 210, the diffuser 210 may be provided access to multiple streams of spatiotemporal data such as the video input data 202 (e.g., including the broadcast tracking data 206 and/or the event data 208) and may be provided in-venue tracking data. Such streams may be represented as spatiotemporal grids which consist of a temporal dimension T specifying the length of trajectories, a spatial dimension (e.g., of size E=23) denoting the number of agents (e.g., two teams of 11 and one ball), followed by a feature dimension. The perturbed in-venue trajectories may be written as y∈R^{T×E×2}, where each observation specifies the agent's perturbed 2D location. Similarly, the broadcast tracking stream is represented as b∈R^{T×E×D}b, where each observation contains the agent's 2D coordinate, agent-type (i.e., outfield player, ball, goalkeeper), team affiliation, and/or indicators as to whether the ball is in-play, and whether the agent is visible. Observations that are not visible may have the agent's 2D coordinate zeroed. While event data may be typically represented as a 1D temporal stream, the event data 208's data stream is represented to be a 2D spatiotemporal grid. This may be achieved by stacking (with padding) each agent's events, forming event stream s∈R^{L×E×D}s where L is the maximum number of events performed by a single agent over a specified time horizon, and each event includes the event's timestamp, 2D coordinates, agent-type, and event category (e.g., pass).

The diffuser 210 may apply spatiotemporal axial attention. The diffuser 210 may process the modalities in a way that maintains their underlying spatiotemporal structure. While spatiotemporal data has a clear temporal total ordering (i.e., chronologically), no such natural ordering may exist over agents spatially. In soccer, because there are two teams each with 10 outfield players with no natural ordering, there may be (10!)² possible permutations of agent indices. To avoid a combinatorial increase in complexity, the spatial dimension of spatiotemporal grids may be processed in a permutation equivariant manner. That is, for example, the following equality may hold for every permutation p of agent indices:

$${F}_{θ} ( y ; σ , c ) = {F}_{θ} ( {y}^{p} ; σ , {c}^{p} ) , ∀ p ∈ [ 1 , {( 10 ! )}^{2} ] , \qquad ( 7 )$$

Where y^{P} and c^{P} may represent permutations of the agent indices for the perturbed in-venue tracking and contextual vectors respectively.

This property may be obtained using spatiotemporal axial attention, where self-attention is applied across temporal and spatial axes separately. With this scheme, individual agent motion may be learned through temporal attention, while collective group dynamics can be learned through spatial attention, without imposing an artificial ordering upon agents. Another benefit of axial attention may be its computation efficiency. Standard self-attention may have quadratic performance with respect to sequence length, and therefore jointly attending across spatial and temporal axes has O(T²·E²). Separate axial attention is of O(T²)+ O(E²)=O(T²) complexity in cases where sequence length T dominates the number of agents E. This efficiency improvement in the diffuser 210 may allow for the processing of considerably larger length multi-agent trajectories than conventional systems.

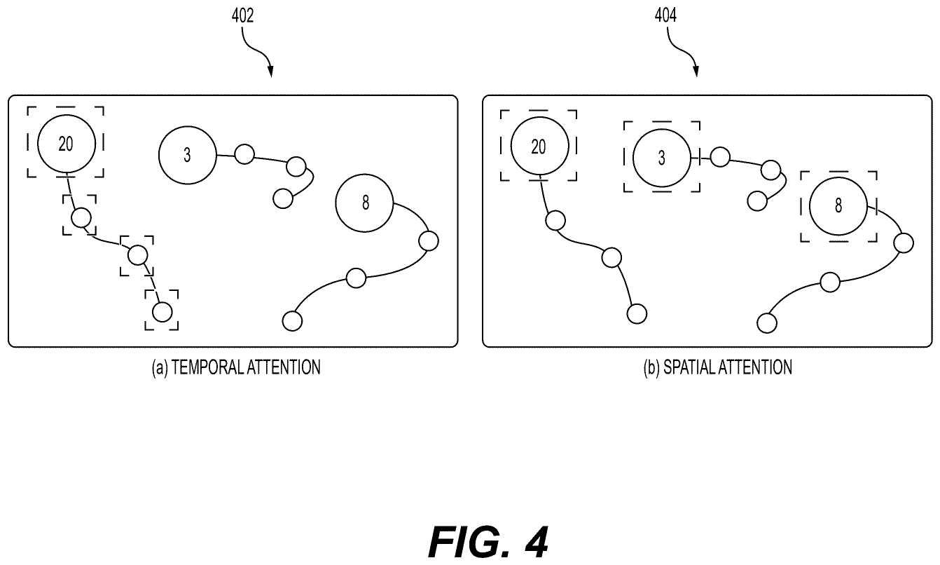

The system described herein may apply techniques to adapt transformers to sports tracking data through spatiotemporal axial attention which includes two interleaved attention modules: a temporal attention 402 and a spatial attention 404 as depicted in FIG. 4, as described below in further detail. In the temporal attention 402, each agent's (e.g., player, referee, object, ball, etc.) temporal context is encoded by completing self-attention between each of an agent's past locations. Conversely, in the spatial attention 404, the spatial relationships within a single frame may be modeled by completing self-attention between each agent's locations at that instant. By interleaving these operations, both the temporal and spatial dependencies within the sporting scene may jointly be modeled. Spatiotemporal axial attention (“SAA”) may have two key advantages: First, SAA may avoid the permutation problem described above as no ordering is imposed on agents. Secondly, temporal attention may be an extremely computationally efficient method for modeling agent's long-term histories. This may be important when accurately predicting the behaviors of agents that are occluded for long periods of time.

Although broadcast tracking provides an essential signal for the accurate synthesis of complete tracking data, it has several limitations. First, broadcast tracking may struggle to track the ball continuously and accurately, due to its small size and fast movement. Secondly, there may be many continuous periods of the game where broadcast tracking does not provide any coverage. Although these periods are typically relatively short (e.g., <10 seconds), synthesizing accurate agent behaviors for these segments may be extremely difficult without additional contextual information. The system described herein may address these challenges by integrating event data with broadcast tracking data to estimate occluded agent behaviors. This may be a shift away from conventional systems that treat sport as a unimodal domain (only using tracking data). The system described herein may treat sports as multi-modal, including multiple spatiotemporal input such as tracking data and event data.

The system described herein further considers that, like tracking data, event data may also be framed as a spatiotemporal modality, including a temporal dimension (i.e., the chronological ordering of each player's events), and a spatial dimension (i.e., representing each specific player) and thus can be encoded using SAA. The system may utilize the flexibility of the transformer architecture (e.g., by the diffuser 210) by jointly processing these modalities together to produce an encoding that contains both tracking and event context, as depicted in FIG. 2A and FIG. 2B. Collectively, this architecture may enable the first fusion of event and tracking data in a deep learning model, which is a landmark moment for the ways in which sports data is understood and processed by AI models.

The system described herein may apply techniques for fusing event data with broadcast tracking data can accurately predict agent locations, however these locations collectively do not necessarily form realistic human motion. This is caused by the high level of uncertainty in agent locations, particularly in the presence of noise and heavy occlusions in the broadcast tracking input. In practice, this means that behaviors generated in this way often model exhibit jitter (i.e., unsmooth trajectories) and occasionally teleport between locations. To alleviate these issues in generating agent behaviors, the system may utilize diffusion, (e.g., a family state-of-the-art generative AI models that have most notoriously been used in the generation of highly realistic images from captions). At a basic level, diffusion models may synthesize data via iteratively denoising from a random initial state. Starting with pure noise, diffusion models progressively refine the sample, gradually creating a higher and higher fidelity generation. The process of iterative denoising may make the diffusion approach well-suited to the generation of images. Iterative denoising may lead to the models learning to construct the coarse features (e.g., the subject of an image) and granular features (e.g., visual texture) that include an image, resulting in highly photorealistic generations. Diffusion may have similar advantages in the generation of tracking data that also contains both rich coarse features (e.g., agents' rough locations) and granular features (e.g., the smoothness of agent motion). Moreover, just as images can be generated by diffusion models by conditioning on textual captions, the system described herein may generate complete tracking data that are conditioned on broadcast tracking and event data streams.

To evaluate the accuracy of imputation, downstream metrics from in-venue tracking and our imputed tracking may be extracted from an exemplary game. The outputs of the system may be compared to in-venue tracking to determine the accuracy of the system. In one example, for a given pass, it was analyzed what the probability that each attacking player will be the pass receiver is (e.g., the xReceiver metric). The xReceiver metric may be dependent both on agents' coarse locations and on more fine-grained details such as agent Velocities, accelerations, and body orientations. For the xReceiver outputs to match the outputs of in-venue tracking, the imputed data may be required to correctly synthesize the complex features in trajectory space. Described below is the method for implementing the xReceiver model (e.g., the spatiotemporal axial attention module 214), along with comparisons of the xReceiver model outputs for in-venue tracking, raw broadcast tracking, and our imputed tracking.

The xReceiver model may have been trained and validated on a set of sporting occasion games. For example, the model may have been trained on a set of one hundred games from a particular league (e.g., English Premier League season) and from a particular season of a sport (e.g., from 2023 to 2024). The training and validation data may include both the both the in-venue tracking and broadcast tracking data. The training may focus on predicting successful passes with a focus on the five seconds of tracking context leading up to the 0.2 seconds before a pass is performed. By utilizing tracking data directly, rather than extracting handcrafted features (e.g., velocity and acceleration), the models may have an increase in the amount of information available and be less sensitive to small amounts of noise. In an example, the model may use a 90:10 training and validation split, with features including each agent's (x, y) locations, the agent's type (i.e., goalkeeper, ball, or outfield player), and an indicator as to whether the agent is on the attacking team. It will be understood that the above is an example only and the model described above and/or below may be implemented using values that are different than those provided above (e.g., such values may be up to 500% more or less than those provided in the example, up to 1000% more or less than those provided in the example, and/or the like).

The xReceiver model may utilize SAA as the underlying architecture, as this may extract spatiotemporal dependencies from tracking data. All agents' trajectories may be processed by a SAA module followed by a linear projection. Next, each attacking agent's outputs may be fed through an activation function (e.g., a softmax activation function), which may ensure that the xReceiver model maintains the Law of Total Probability (all player xReceiver values sum to 1). The models may be trained using cross entropy loss. Two instances of this model may be trained, one using in-venue tracking to comprise agent locations, and another that uses broadcast tracking.

The results of the xReceiver model may have been tested, for example, on a single game using three datasets: in-venue tracking, raw broadcast tracking, and the determined imputed tracking. During testing, the xReceiver model trained on in-venue tracking may be applied to in-venue tracking. Likewise, the xReceiver model trained on raw broadcast tracking may be applied to the raw broadcast tracking data. In the case of imputed tracking, the model trained on in-venue tracking may have been used. This may enable an analysis of imputed tracking data's ability to be substituted for in-venue tracking.

Two metrics may be used to compare the quality of the raw broadcast and imputed tracking's xReceiver outputs with the in-venue outputs. The first metric may be how frequently the true receiver is among the top-k most likely predicted receivers from each dataset. The second metric may be the similarity between the high likelihood receivers (e.g., receivers with an xReceiver value over 0.1) in the in-venue data, and in the raw broadcast and imputed data. To quantify this similarity, the system may compute the Intersection over Union (IoU) separately between the in-venue and raw broadcast outputs, and in-venue and imputed outputs.

Referring to FIG. 2C, a flowchart 220 illustrates a method for automated transformation of sports data through conditional guided diffusion processing. The flowchart 220 demonstrates the technical implementation generating complete (e.g., imputed) tracking data from incomplete broadcast feeds by integrating multiple data modalities through machine learning algorithms. The imputed tracking data is used for downstream applications such as for metric analysis and application.

The flowchart 220 begins with a step 222, where video data including a plurality of video frames captured during a sporting occasion is received. Each frame may include positional data corresponding to one or more agents, though the video data may contain occlusions and limited field coverage characteristic of broadcast footage. The step 222 may involve processing broadcast feeds through computer vision algorithms to extract initial positional coordinates for visible agents while identifying periods where agents are occluded or outside the camera's receptive field.

The flowchart 220 proceeds to a step 224, where event data associated with the sporting occasion is received. The event data may provide semantic information about game events including passes, shots, tackles, and possession changes that occur during periods when broadcast tracking coverage may be incomplete. The step 224 may involve processing event streams that complement the positional information from the step 222 by providing contextual understanding of tactical situations and game dynamics.

Following data acquisition, the flowchart 220 advances to a step 226, where the video data and event data are processed through a diffusion model incorporating spatiotemporal axial attention mechanisms to generate imputed tracking data. The step 226 may apply the temporal attention 402 and spatial attention 404 components of FIG. 4 to process both data modalities simultaneously, enabling the system to predict missing positional information based on available tracking context and event information. The diffusion process may iteratively refine predicted agent positions to generate smooth, physically plausible trajectories that eliminate jitter and teleportation artifacts present in raw broadcast tracking.

The flowchart 220 then moves to a step 228, where one or more metrics are determined based on the imputed tracking data generated in the step 226. The metrics may include pass options, pressure analysis, line detection, and marking identification that transform the complete positional data into contextual tactical insights. The step 228 may apply frame-by-frame analysis techniques to the imputed tracking data, enabling comprehensive tactical analysis even for periods where agents were originally occluded in the broadcast footage. At step 230, an output based on the one or more metrics for the one or more agents is determined.

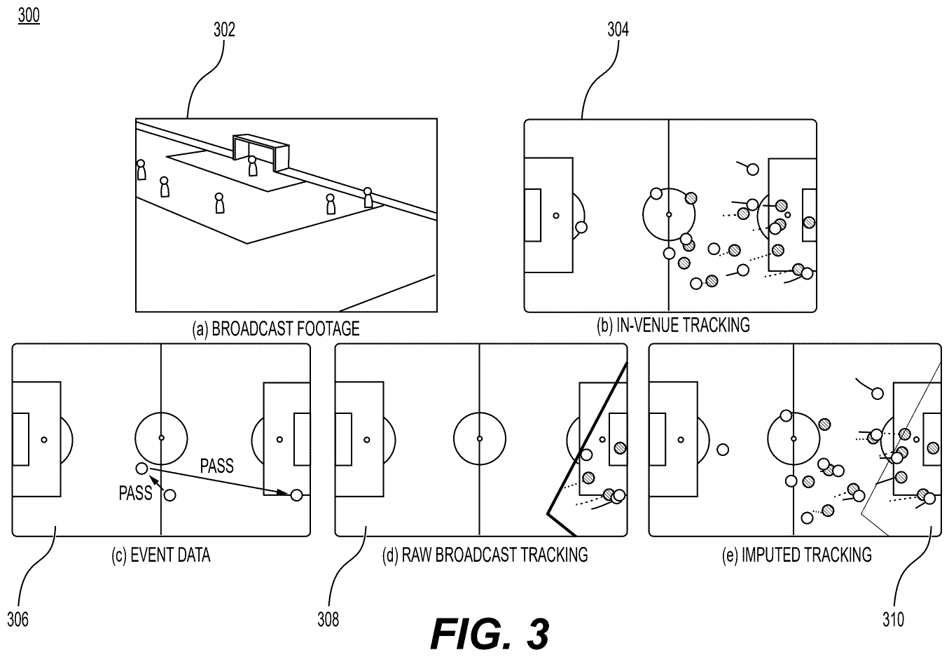

Referring to FIG. 3, illustrations 300 demonstrate the technical transformation process from incomplete broadcast data to complete tracking data through the automated sports data processing system described herein. The illustrations 300 show multiple data representations that collectively illustrate how the system addresses the fundamental challenge of incomplete positional data in sports analytics.

The illustrations 300 include a broadcast footage 302, which represents the raw video input captured during a sporting occasion. The broadcast footage 302 may contain inherent limitations including camera occlusions, limited field coverage, and periods where agents are not visible within the camera's receptive field. These limitations create gaps in the positional data that conventional systems cannot adequately address. The broadcast footage 302 may serve as the primary input to the tracking data system 116, which processes the video content to extract initial positional information for the one or more agents 112.

In-venue tracking data 304 may provide a reference representation of positional information for all agents on the playing field. The in-venue tracking data 304 may be generated using tracking systems that maintain visibility of all agents throughout the sporting occasion. This data may serve as ground truth for training and validation purposes, demonstrating the target output that the system aims to achieve through its automated transformation process. The in-venue tracking data 304 may include coordinate information for each agent at every time frame, providing the spatial context that may be missing from the broadcast footage 302. However, in-venue tracking data 304 may not be available for most sporting occasions. For example, most sporting occasions may only collect video data for broadcast feeds and, thus, may not generate in-venue tracking data 304 that includes more comprehensive coverage of the sporting occasion.

Event data 306 may represent the semantic layer of game information that provides contextual understanding of sporting actions and game states. The event data 306 may include discrete annotations of significant game occurrences such as passes, shots, tackles, and possession changes. This information may serve as a complementary data stream that the diffuser 210 utilizes to infer agent positions during periods of incomplete visual coverage. The event data 306 may provide temporal markers and contextual clues that enable the system to predict likely agent movements and positions based on the tactical context of the game situation.

Raw broadcast tracking 308 may demonstrate the output of computer vision processing applied to the broadcast footage 302. The raw broadcast tracking 308 may exhibit the gaps, inconsistencies, and missing positional data that result from the limitations of broadcast video analysis. Agents may appear and disappear from the tracking data as they move in and out of camera coverage, creating discontinuous trajectories that lack the smooth motion characteristics of actual player movement. The raw broadcast tracking 308 illustrates a technical problem that the present system addresses through its advanced processing methodology.

Imputed tracking 310 represents the final output of the automated transformation system after application of the diffusion model and spatiotemporal axial attention mechanisms, as discussed herein. The imputed tracking 310 may demonstrate complete positional data and/or movement data for all agents throughout the sporting occasion, including periods where agents were occluded or outside the camera's field of view in the original broadcast footage 302. The system generates the imputed tracking 310 by processing the broadcast tracking data 206 and the event data 208 through the diffuser 210, which applies machine learning algorithms to predict missing positional information based on available context.

The technical transformation from the raw broadcast tracking 308 to the imputed tracking 310 may occur through the application of the spatial axial attention module 214 of FIG. 2A and/or the spatiotemporal axial attention mechanism 211 within the diffuser 210 of FIG. 2B. For example, when an agent becomes occluded in the broadcast footage 302, the temporal attention 402 of FIG. 4 may be utilized to analyze the agent's movement history and the spatial attention 404 of FIG. 4 may be utilized to consider the spatial relationships with other agents. This information may be combined with contextual data from the event data 306 to predict the occluded agent's likely position and movement trajectory.

For example, when a player moves behind another player in the broadcast footage 302, creating an occlusion that results in missing data in the raw broadcast tracking 308, the system 201 applies the technical framework to generate predicted positions in the imputed tracking 310. The diffuser 210 may analyze the player's velocity and direction before the occlusion, consider the tactical context from the event data 306, and apply the spatiotemporal axial attention mechanism 211 to predict the player's continued movement path. The system 201 may account for typical player behavior patterns, field boundaries, and game dynamics to generate realistic positional estimates that maintain motion continuity.

The transformation process may address various types of data gaps in addition to simple occlusions. When the broadcast footage 302 shows a close-up view that excludes portions of the playing field, the raw broadcast tracking 308 may lack positional data for agents outside the camera's current field of view. The system may generate complete positional information in the imputed tracking 310 by utilizing the event data 306 to understand the game context and applying learned movement patterns to predict off-screen agent positions. The spatiotemporal axial attention mechanism 211 may process the available positional data for visible agents and infer the likely positions of occluded agents based on tactical formations and game flow.

The illustrations 300 demonstrate the system's capability to maintain temporal consistency in agent tracking across periods of incomplete visual coverage. The imputed tracking 310 shows smooth, continuous trajectories that bridge gaps in the raw broadcast tracking 308, ensuring that agent movements appear realistic and physically plausible. The system achieves this consistency by applying the diffusion model framework, which iteratively refines predicted positions to generate trajectories that conform to realistic human movement patterns while satisfying the constraints imposed by the available broadcast tracking data 206 and event data 208.

Referring to FIG. 4, the spatiotemporal axial attention mechanism may implement a sequential processing approach that addresses the fundamental permutation problem in multi-agent tracking systems. The temporal attention 402 and the spatial attention 404 may operate as interleaved attention modules that process temporal and spatial dimensions separately, enabling the system to model complex spatiotemporal dependencies without imposing artificial ordering constraints on the one or more agents 112.

The temporal attention 402 may encode individual agent motion by completing self-attention operations between each agent's past locations across multiple time frames. For each agent in the tracking data, the temporal attention 402 may analyze the agent's movement history to capture patterns such as velocity changes, directional shifts, and acceleration profiles. The temporal attention 402 may process sequences of positional coordinates for a single agent across time steps, enabling the system to learn temporal dependencies that characterize individual movement behaviors. When an agent becomes occluded in the broadcast tracking data 206, the temporal attention 402 may utilize the agent's historical movement patterns to predict likely future positions based on established motion trajectories.

The spatial attention 404 may model collective group dynamics by completing self-attention operations between agent locations within a single time frame. The spatial attention 404 may analyze spatial relationships among all agents at a specific temporal instant, capturing tactical formations, inter-agent distances, and collective positioning patterns. The spatial attention 404 may process the spatial configuration of agents without requiring a predetermined ordering, addressing the permutation problem that arises when conventional systems attempt to impose artificial agent sequences. For example, when analyzing a defensive formation, the spatial attention 404 may identify spatial relationships between defensive players and attacking players without requiring the system to maintain consistent player numbering or positioning across different game situations.

The interleaved operation of the temporal attention 402 and the spatial attention 404 may enable the spatiotemporal axial attention mechanism 211 to jointly model both temporal and spatial dependencies within sporting occasions. The system may alternate between temporal attention operations that focus on individual agent histories and spatial attention operations that capture collective team dynamics. This sequential processing approach may allow the diffuser 210 to generate predictions that account for both individual player movement patterns and team-level tactical behaviors.

The axial attention approach may provide computational efficiency improvements compared to conventional joint attention mechanisms. Standard self-attention applied across both temporal and spatial dimensions simultaneously may exhibit quadratic performance complexity of O(T². E²), where T represents the temporal sequence length and E represents the number of agents. The spatiotemporal axial attention mechanism 211 may achieve computational complexity of O(T²)+O(E²) by processing temporal and spatial dimensions separately. In sporting applications where the temporal sequence length T may significantly exceed the number of agents E, the axial attention approach may reduce computational requirements to approximately O(T²) complexity.

The computational efficiency of the axial attention approach may enable the processing of considerably longer multi-agent trajectories than conventional systems. The system may process multiple minutes of tracking context simultaneously, addressing scenarios where agents remain occluded for extended periods during broadcast coverage. For example, when a player moves off-screen during a broadcast close-up that lasts for thirty seconds, the temporal attention 402 may maintain context from the player's movement patterns before the occlusion, while the spatial attention 404 may infer the player's likely position based on the spatial relationships with visible teammates and opponents.

The temporal attention 402 may capture agent-specific movement characteristics that enable accurate prediction of individual behaviors during occlusion periods. When processing tracking data for a specific player, the temporal attention 402 may identify patterns such as preferred running speeds, typical directional changes, and characteristic acceleration profiles. The temporal attention 402 may weigh recent positional information more heavily than distant historical data, enabling the system to adapt to changing game conditions while maintaining awareness of longer-term movement trends. For instance, when a midfielder consistently demonstrates a tendency to make forward runs during attacking phases, the temporal attention 402 may incorporate this behavioral pattern when predicting the player's movement during periods of visual occlusion.

The spatial attention 404 may model complex tactical relationships that emerge from collective agent positioning without requiring explicit formation templates or role assignments. The spatial attention 404 may identify spatial patterns such as defensive lines, attacking clusters, and positional triangles that characterize team tactics. The attention mechanism may dynamically weigh the importance of different spatial relationships based on the current game context, enabling the system to adapt to varying tactical situations. For example, during a corner kick situation, the spatial attention 404 may focus on the spatial relationships between attacking players in the penalty area and their corresponding defensive markers, while during open play, the attention mechanism may emphasize the spatial distribution of players across the entire field.

The permutation equivariance property of the spatiotemporal axial attention mechanism 211 may ensure consistent processing regardless of agent ordering in the input data. The system may satisfy the mathematical requirement that F_θ(y; σ, c)=F_θ(y\hat{ }p; σ, c\hat{ }p) for every permutation p of agent indices, where y\hat{ }p and c\hat{ }p represent permutations of the agent indices for tracking data and contextual vectors respectively. This property may eliminate the need for consistent agent ordering across different games or time periods, enabling the system to process tracking data from various sources without requiring preprocessing to establish uniform agent sequences.

The combination of the temporal attention 402 and the spatial attention 404 may enable the system to generate realistic agent trajectories that maintain both individual movement characteristics and collective tactical coherence. When generating imputed tracking 310 for occluded agents, the system may utilize temporal attention to ensure that predicted movements align with individual agent behavior patterns, while spatial attention may ensure that predicted positions maintain appropriate tactical relationships with other agents. The interleaved attention operations may create a feedback mechanism where individual movement predictions influence collective positioning estimates, and collective tactical context informs individual movement generation.

Referring to FIG. 5, a frame-by-frame metrics 500 system may process tracking data through real-time analysis of positional and movement information extracted from each frame of video data captured during a sporting occasion. The frame-by-frame metrics 500 discussed in FIG. 5 may be performed using tracking data such as imputed tracking data, broadcast tracking data, in-venue tracking data, etc., as further discussed in reference to FIGS. 6A-6D. The frame-by-frame metrics 500 may transform raw positional coordinates into contextual tactical metrics by applying differential analysis to consecutive positional coordinates with coordinate system transformations derived from broadcast camera calibration. The system may calculate instantaneous velocities, accelerations, and spatial relationships for each of the one or more agents 112 at sampling frequencies of 5-25 Hz, enabling real-time generation of tactical insights during live sporting occasions.

The frame-by-frame metrics 500 may include four primary components that process tracking data through distinct computational methodologies. It will be understood that other components in addition to the four primary components depicted in FIG. 5 may process tracking data in accordance with the techniques disclosed herein. The system may determine pass options 510, which identify available passing opportunities for a ball carrier based on positional data and movement data for each of the one or more agents 112. The system may calculate pressure 520, which quantifies defensive pressure applied to a ball carrier based on proximity of the one or more agents 112 determined by positional data and movement data. The frame-by-frame metrics 500 may further include line detection 530, which identifies line-breaking actions when movement of at least one of a ball or the one or more agents 112 successfully penetrates through a detected defensive line. The system may determine marking 540, which identifies defensive matchups by determining when defensive agents are within a threshold distance from an offensive agent.

The pass options 510 may process tracking data by applying differential analysis to consecutive positional coordinates to calculate passing probability values for each potential receiver on the attacking team. The system may transform coordinate data from broadcast camera calibration parameters, converting pixel coordinates to field coordinates using homographic transformation matrices. For each frame, the pass options 510 may calculate instantaneous velocities by applying differential analysis to consecutive positional coordinates [x1, y1] and [x2, y2], determining velocity vectors as v=[(x2−x1)/Δt, (y2−y1)/Δt], where Δt represents the time interval between frames. The coordinate transformation may involve matrix multiplication operations based on broadcast camera calibration parameters including focal length, camera position, and field geometry measurements.

The pass options 510 may utilize a Graph Convolutional Neural Network that processes positional data for all agents simultaneously to predict passing success probabilities. The system may calculate expected threat (xThreat) values by analyzing the probability of a shot occurring within ten seconds if the ball is passed to each potential receiver. The pass options 510 may determine expected receiver (xReceiver) values by evaluating each agent's availability as a pass target based on spatial positioning, movement patterns, and defensive coverage. The system may compute expected pass (xPass) values by analyzing the likelihood of successful pass completion to each potential receiver based on distance, angle, and defensive interference factors.

For example, when processing a frame where a midfielder possesses the ball at coordinates [45, 30] on a normalized field coordinate system, the pass options 510 may identify three potential receivers at positions [55, 25], [60, 35], and [50, 40]. The system may apply differential analysis to calculate each receiver's velocity by comparing their current positions to positions from the previous frame captured 0.04 seconds earlier. For the receiver at [55, 25], if the previous position was [54, 24], the system may calculate velocity as v=[(55−54)/0.04, (25−24)/0.04]=[25, 25] meters per second. The pass options 510 may then evaluate passing angles, defensive coverage, and movement trajectories to assign xReceiver values of 0.7, 0.2, and 0.1 respectively to the three potential receivers.

The pressure 520 may process tracking data by calculating proximity-based defensive intensity measurements through real-time analysis of spatial relationships between ball carriers and defensive agents. The system may apply differential analysis to consecutive positional coordinates to determine approach velocities and acceleration profiles of defensive players relative to the ball carrier. The pressure 520 may utilize a multi-class classifier that processes a plurality of feature vectors including locations, velocities, and accelerations of pressing players with respect to the ball-carrying player. The coordinate transformation may involve calculating relative position vectors and normalizing distances based on field dimensions and camera calibration parameters.

The pressure 520 may classify defensive pressure into four categories: no pressure, low pressure, medium pressure, and high pressure, based on a combination of proximity distance, approach velocity, and acceleration characteristics of defensive agents. The system may calculate pressure values by analyzing the distance between the ball carrier and the nearest defensive player, with pressure intensity increasing as distance decreases below threshold values. The pressure 520 may incorporate velocity analysis by measuring the rate of gap closure between defensive players and the ball carrier, applying differential analysis to consecutive positional coordinates to determine approach speeds.

For example, when a ball carrier is positioned at coordinates [40, 50] and a defensive player approaches from position [43, 52], the pressure 520 may calculate the separation distance as d=√[(43−40)²+(52−50)²]=√[9+4]=3.6 meters. If the defensive player's previous position was [44, 53], the system may apply differential analysis to calculate approach velocity as v=[(43−44)/0.04, (52−53)/0.04]=[−25, −25] meters per second, indicating movement toward the ball carrier. The pressure 520 may combine distance and velocity measurements with acceleration analysis to classify the defensive action as high pressure when the separation distance is less than 3 meters and the approach velocity exceeds 20 meters per second.

The line detection 530 may process tracking data by applying clustering algorithms to identify defensive formations and detect line-breaking movements through real-time analysis of agent positioning patterns. The system may utilize clustering techniques (e.g., Jenks Natural Break) to group players based on x-coordinate positions, automatically determining defensive lines, midfield lines, and attacking lines for each frame. The coordinate transformation may involve projecting three-dimensional player positions onto a two-dimensional field coordinate system using camera calibration parameters and perspective correction algorithms.

The line detection 530 may calculate line positions by analyzing the spatial distribution of defensive players and applying clustering algorithms that minimize within-group variance while maximizing between-group separation. The system may determine line-breaking actions by tracking ball and player movements that cross detected defensive line boundaries, applying differential analysis to consecutive positional coordinates to identify penetrating movements. The line detection 530 may process coordinate data at each frame to update line positions dynamically as defensive formations shift during gameplay.

For example, when analyzing a defensive formation with players positioned at x-coordinates [15, 17, 19, 35, 37, 39, 55, 57, 59], the line detection 530 may apply clustering to identify three distinct groups: defensive line at x=17, midfield line at x=37, and attacking line at x=57. When an attacking player moves from position [30, 25] to [40, 25] between consecutive frames, the system may apply differential analysis to detect that the player has crossed the midfield line boundary at x=37. The line detection 530 may classify this movement as a line-breaking action and update tactical metrics to reflect the penetrating run through the midfield line.

The marking 540 may process tracking data by calculating inter-agent distances and identifying defensive matchups through real-time analysis of spatial proximity relationships. The system may apply differential analysis to consecutive positional coordinates to track marking assignments that persist for minimum duration thresholds of three seconds with separation distances less than five meters. The coordinate transformation may involve calculating Euclidean distances between all possible agent pairs and applying filtering algorithms to identify sustained defensive coverage relationships.

The marking 540 may determine marking intensity by analyzing separation distance, movement similarity, and goal-side positioning between defensive and offensive players. The system may calculate movement similarity by comparing velocity vectors of potential marking pairs, applying differential analysis to determine correlation coefficients between defensive and offensive player movements. The marking 540 may evaluate goal-side positioning by analyzing the relative positions of defensive players with respect to offensive players and the goal location, ensuring that defensive coverage maintains appropriate tactical positioning.

A practical application of these marking calculations may be demonstrated through specific positional scenarios that illustrate the system's analytical capabilities. For example, when a defensive player at position [25, 30] tracks an offensive player at position [27, 32], the marking 540 may calculate separation distance as d=√[(27−25)²+(32−30)²]=√[4+4]=2.8 meters. The system may apply differential analysis to compare movement patterns by calculating velocity vectors for both players across multiple frames. If the defensive player moves from [25, 30] to [26, 31] while the offensive player moves from [27, 32] to [28, 33], the marking 540 may determine velocity correlation as both players exhibit similar movement vectors of [25, 25] meters per second. The system may classify this relationship as a marking assignment when the separation distance remains below 5 meters and movement correlation exceeds 0.7 for a duration of at least 3 seconds.

The marking 540 may implement a constraint-based assignment system where each defensive player may be assigned to mark only one offensive player at any given time, while each offensive player may be simultaneously marked by multiple defensive players. This one-to-many relationship structure may enable the system to model realistic defensive scenarios where multiple defenders may converge on a single high-threat offensive player while maintaining individual marking responsibilities. The system may process marking assignments by evaluating all possible defensive-offensive player pairs and selecting the optimal assignment for each defensive player based on proximity, movement correlation, and tactical positioning factors. When multiple defensive players are positioned within marking distance of the same offensive player, the marking 540 may assign each defensive player to that single offensive target, creating multiple concurrent marking relationships for the offensive player while ensuring each defensive player maintains focus on one specific target.

The frame-by-frame metrics 500 may process tracking data through parallel computational pipelines that enable simultaneous calculation of all four metric types for each frame of video data. The system may apply coordinate system transformations consistently across all metric calculations, ensuring spatial accuracy through broadcast camera calibration parameters that account for camera position, lens distortion, and perspective correction. The real-time processing methodology may utilize vectorized operations and optimized algorithms to maintain processing speeds that match or exceed the 5-25 Hz sampling frequency of the input tracking data.

The computational efficiency of the frame-by-frame metrics 500 may enable real-time tactical analysis during live sporting occasions, providing immediate insights for coaches, analysts, and broadcasters. The system may generate metric outputs that quantify tactical situations with numerical precision, transforming subjective tactical observations into objective measurements that can be compared across different games, players, and time periods. The frame-by-frame processing approach may ensure that tactical insights are available with minimal latency, supporting real-time decision-making applications in professional sports environments.

FIGS. 6A-6D illustrate comparative analysis of receiver prediction models across different tracking data scenarios according to embodiments of the present invention. FIG. 6A depicts output data comparing broadcast tracking, imputed, and in-venue xReceiver models for a specific passing scenario, showing the accuracy of receiver predictions and intersection over union (IoU) metrics. FIGS. 6B-6D present additional comparative scenarios demonstrating the performance differences between broadcast tracking models and imputed tracking models when evaluated against in-venue tracking ground truth data.

Output data 600A of the imputed tracking data (e.g., from the xReceiver), as shown in FIG. 6A, depicts that a play ends with Player #20 crossing the ball to Player #28, who registers a shot-on-target form near the penalty play. Examining this scenario, the system may further be configured to analyze what other players were available for passes and the potential success based on the pass play. For example, the system may consider what pass is the most threatening (e.g., likely to result in a goal) or how likely a pass is to succeed in accordance with the pass options 510 of FIG. 5. The pass options 510 may utilize a Graph Convolutional Neural Network that processes positional data for all agents simultaneously to predict passing success probabilities. The system may calculate expected threat (xThreat) values by analyzing the probability of a shot occurring within ten seconds if the ball is passed to each potential receiver. The pass options 510 may determine expected receiver (xReceiver) values by evaluating each agent's availability as a pass target based on spatial positioning, movement patterns, and defensive coverage. The system may compute expected pass (xPass) values by analyzing the likelihood of successful pass completion to each potential receiver based on distance, angle, and defensive interference factors.

In FIG. 6A, the broadcast tracking's xReceiver model 602A may determine that there are three likely receivers (e.g., Player #13, Player #37, and Player #38), none of which are the actual receiver. This inaccurate output is representative of the negative impact of incomplete tracking data on downstream analysis. It is also notable that regardless of the predictive outputs of the xReceiver model, without complete tracking data, these predictions may be incredibly difficult to interpret (e.g., why certain occluded players are deemed more likely than others to receive the pass?). The xReceiver model may have been trained and validated on a set of sporting occasion games, for example, trained on a set of one hundred games from a particular league (e.g., English Premier League season) and from a particular season of a sport (e.g., from 2023 to 2024). The training and validation data may include both the both the in-venue tracking and broadcast tracking data. The training may focus on predicting successful passes with a focus on the five seconds of tracking context leading up to the 0.2 seconds before a pass is performed.

The imputed xReceiver model 604A may predict that there are four likely pass receivers (e.g., the four circles each surrounded by a square), of which the actual receiver is included. Upon review, this output appears viable as the four players clearly making attacking runs towards the box as the passer is set to cross the ball. Visually, the locations of imputed players closely match the in-venue locations. Furthermore, the player trajectories resemble smooth human motion. The xReceiver model may utilize SAA as the underlying architecture, as this may extract spatiotemporal dependencies from tracking data. All agents' trajectories may be processed by a SAA module followed by a linear projection. Next, each attacking agent's outputs may be fed through an activation function (e.g., a softmax activation function), which may ensure that the xReceiver model maintains the Law of Total Probability (all player xReceiver values sum to 1). The models may be trained using cross entropy loss.

The in-venue xReceiver model 606A may predict that there are three likely receivers of the pass (e.g., the four circles each surrounded by a square), one of which is the actual receiver. The discrepancy between the imputed and in-venue result is that the in-venue xReceiver model does not deem Player #28 as a high likelihood receiver. Qualitatively, this may only be a minor discrepancy, as Player #28 appears the least likely of the four candidate players predicted by the in-venue stream to receive the ball. Two instances of this model may be trained, one using in-venue tracking to comprise agent locations, and another that uses broadcast tracking. The results of the xReceiver model may have been tested, for example, on a single game using three datasets: in-venue tracking, raw broadcast tracking, and the determined imputed tracking.

FIGS. 6B-6D may depict further example scenarios applying the xReceiver model to different scenarios. Output data 600B, 600C, and 600D may be depicted in FIGS. 6B-6D. FIGS. 6B-6D may all depict how the broadcast tracking model (602B, 602C, and 602D) made less accurate predictions as compared to the imputed xReceiver model 604B, 604C, 604D when compared to the in-venue xReceiver model 606B, 606C, 606D results. In these examples, potential receivers and/or possessors of the ball are each surrounded by a square. Two metrics may be used to compare the quality of the raw broadcast and imputed tracking's xReceiver outputs with the in-venue outputs. The first metric may be how frequently the true receiver is among the top-k most likely predicted receivers from each dataset. The second metric may be the similarity between the high likelihood receivers (e.g., receivers with an xReceiver value over 0.1) in the in-venue data, and in the raw broadcast and imputed data. To quantify this similarity, the system may compute the Intersection over Union (IoU) separately between the in-venue and raw broadcast outputs, and in-venue and imputed outputs.

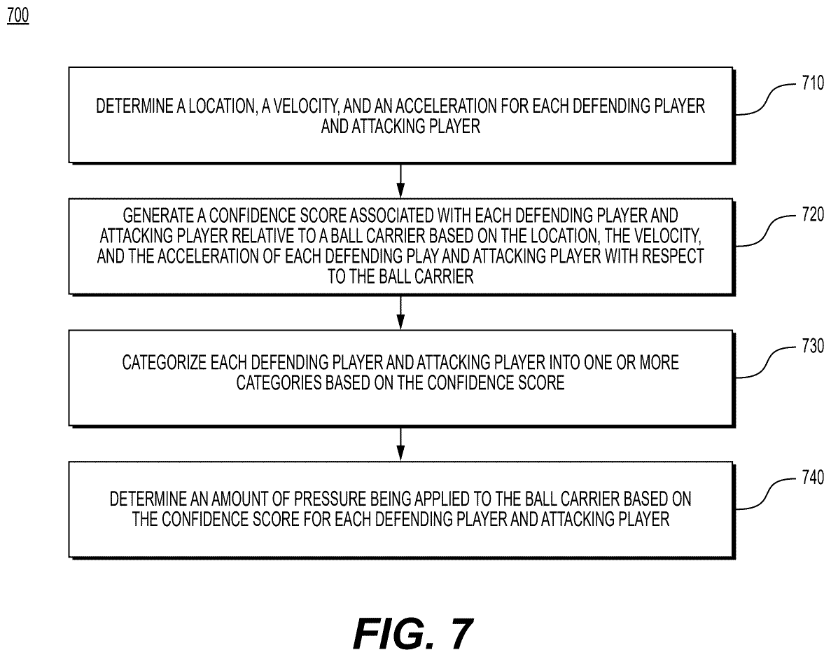

Referring to FIG. 7, a flowchart 700 illustrates the automated transformation process for determining defensive pressure (e.g., as discussed in reference to pressure 520 of FIG. 5) applied to ball carriers through computational analysis of agent positioning and movement characteristics. The flowchart 700 may implement a systematic approach that processes tracking data (e.g., imputed tracking data) through sequential operations to quantify defensive pressure levels using machine learning classification techniques. The flowchart 700 may demonstrate the technical methodology for transforming raw positional coordinates into contextual pressure metrics that provide tactical insights for sports analysis applications.

The flowchart 700 may begin with an operation 710, where a location, a velocity, and/or an acceleration for each defending player and attacking player are determined through differential analysis of consecutive positional coordinates extracted from the tracking data. The operation 710 may process positional data by applying coordinate system transformations that convert pixel coordinates from broadcast footage to field coordinates using homographic transformation matrices derived from camera calibration parameters. The system may calculate instantaneous velocities by applying differential analysis to consecutive positional coordinates, determining velocity vectors as v=[(x2−x1)/Δt, (y2−y1)/Δt] where Δt represents the time interval between frames captured at sampling frequencies of 5-25 Hz.

The operation 710 may determine acceleration values through second-order differential analysis of positional coordinates across multiple consecutive frames. For each agent, the system may calculate acceleration vectors by analyzing velocity changes between consecutive time intervals, applying the formula a=[(v2−v1)/Δt] where v1 and v2 represent velocity vectors at consecutive time points. The coordinate transformation process may involve matrix multiplication operations that account for camera position, lens distortion, and perspective correction to ensure accurate spatial measurements. The operation 710 may process location data for all agents simultaneously, generating comprehensive kinematic profiles that include position coordinates, velocity vectors, and acceleration measurements for each defending player and attacking player on the field.

Following the determination of kinematic parameters, the flowchart 700 may proceed to an operation 720, where a confidence score is generated for each defending player and attacking player relative to a ball carrier based on the location, velocity, and acceleration measurements calculated in the operation 710. The operation 720 may implement a multi-class classifier (e.g., LightGBM) that processes eight distinct feature vectors derived from the kinematic analysis of pressing players with respect to the ball-carrying player. The confidence score generation may involve calculating relative position vectors between defensive players and the ball carrier, normalizing distances based on field dimensions, and analyzing approach velocities to determine the likelihood of defensive pressure application.

The operation 720 may utilize the multi-class classifier to process feature vectors that include locations, velocities, and accelerations of pressing players relative to the ball carrier's position and movement characteristics. The eight features processed by the classifier may include separation distance between the defensive player and ball carrier, approach velocity magnitude, approach velocity direction, relative acceleration, gap closure rate, angular positioning relative to the goal, defensive player's distance from goal, and temporal persistence of the defensive approach. The confidence score calculation may involve weighted analysis of these feature vectors to generate probability distributions across four pressure classification categories.

The operation 720 may generate confidence scores by analyzing the spatial and temporal relationships between defensive players and the ball carrier through real-time processing of tracking data. For example, when a defensive player positioned at coordinates [43, 52] approaches a ball carrier at position [40, 50], the operation 720 may calculate the separation distance as d=√[(43−40)²+(52−50)²]=3.6 meters. The system may apply differential analysis to determine approach velocity by comparing the defensive player's current position to the previous frame position, calculating velocity vectors that indicate movement direction and speed relative to the ball carrier. The confidence score may incorporate acceleration analysis by examining velocity changes across multiple consecutive frames to assess the intensity and persistence of the defensive approach.

The flowchart 700 may advance to an operation 730, where each defending player and attacking player is categorized into one or more pressure classification categories based on the confidence scores generated in the operation 720. The operation 730 may implement a multi-class classification system that assigns pressure levels of none, low, medium, or high based on the confidence score distributions calculated by the multi-class classifier. The categorization process may utilize threshold-based classification where confidence scores above predetermined values trigger assignment to specific pressure categories, enabling the system to distinguish between different levels of defensive intensity.

The operation 730 may process confidence scores through a classification framework that evaluates the maximum confidence score among multiple potential pressure applicants to determine the overall pressure level experienced by the ball carrier. When multiple defensive players simultaneously apply pressure to a single ball carrier, the operation 730 may select the highest pressure classification among all defensive players within the proximity threshold. For example, if two defensive players apply medium pressure and low pressure respectively to the same ball carrier, the operation 730 may classify the overall pressure situation as medium pressure based on the maximum pressure level detected.

The categorization process implemented in the operation 730 may distinguish between different pressure intensities based on the combination of proximity distance, approach velocity, and acceleration characteristics of defensive agents. The system may classify defensive actions as no pressure when separation distances exceed threshold values and approach velocities remain below minimum thresholds. Low pressure classification may occur when defensive players maintain moderate proximity to the ball carrier without aggressive approach movements. Medium pressure may be assigned when defensive players demonstrate sustained approach movements with moderate gap closure rates. High pressure classification may result from scenarios where defensive players exhibit rapid approach velocities, close proximity distances, and sustained acceleration toward the ball carrier.

The flowchart 700 may conclude with an operation 740, where an amount of pressure being applied to the ball carrier is determined based on the confidence scores calculated for each defending player and attacking player in the previous operations. The operation 740 may quantify defensive pressure through numerical analysis that combines the classification results from the operation 730 with temporal persistence measurements to generate comprehensive pressure metrics. The pressure quantification may account for the duration of defensive pressure application, the number of defensive players involved in pressure situations, and the intensity levels maintained throughout the pressure episode.

The operation 740 may implement pressure quantification by analyzing the temporal consistency of pressure classifications across multiple consecutive frames to ensure that brief or intermittent defensive actions do not generate misleading pressure measurements. The system may require pressure classifications to persist for minimum duration thresholds before registering significant pressure values, filtering out momentary defensive movements that do not constitute sustained pressure application. The pressure quantification may incorporate weighted analysis where higher pressure classifications contribute more significantly to the overall pressure measurement than lower classifications.

The pressure determination process implemented through the flowchart 700 may enable real-time quantification of defensive pressure during live sporting occasions, providing immediate tactical insights for coaches, analysts, and broadcasters. The automated pressure calculation may transform subjective assessments of defensive intensity into objective numerical measurements that can be compared across different games, players, and time periods. The multi-class classifier may process tracking data with computational efficiency that matches the real-time requirements of live sports analysis, generating pressure classifications with minimal latency while maintaining high accuracy in pressure level determination.

The technical implementation of the pressure determination process may address the challenge of quantifying defensive pressure in team sports where multiple agents interact simultaneously in dynamic tactical situations. The system may process complex multi-agent scenarios where several defensive players converge on a single ball carrier, generating pressure measurements that account for collective defensive intensity rather than individual defensive actions. The flowchart 700 may demonstrate a systematic approach to pressure analysis that combines machine learning classification with real-time tracking data processing to generate actionable tactical insights for professional sports applications.

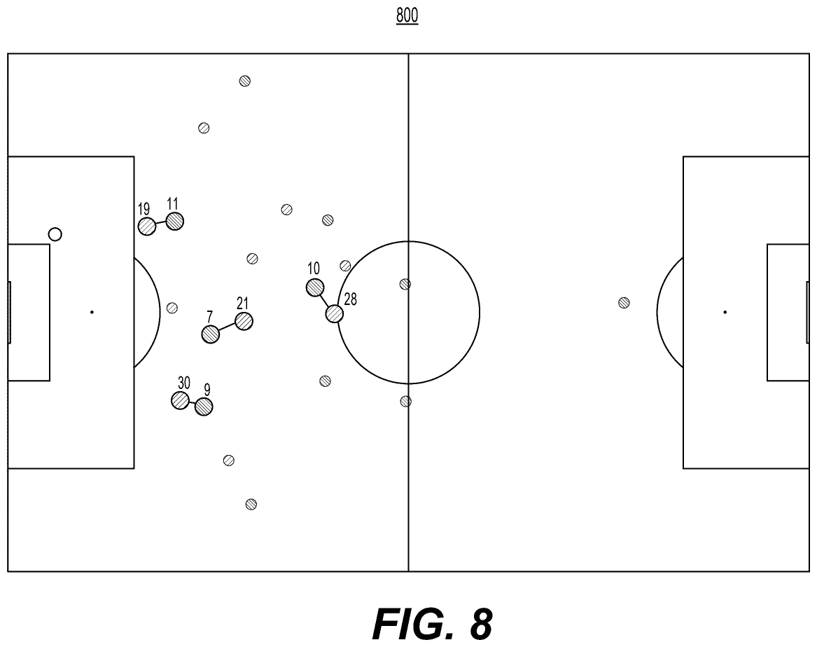

Referring to FIG. 8, a marking interface 800 may provide an orthogonal top view of a sports field that displays agent (e.g., the one or more agents 112 of FIG. 1) positions as circular markers to facilitate identification of defensive matchups through real-time analysis of spatial proximity relationships. The marking interface 800 may present a rectangular playing field with standard field markings including penalty areas, center circle, and goal boxes, enabling visual representation of agent positioning and spatial relationships during sporting occasions. The marking interface 800 may display multiple circular markers distributed across the field, with markers appearing in different sizes to indicate different roles or statuses of the one or more agents 112. Several markers may be labeled with numbers including 23, 10, 21, 7, 9, 30, 11, and 19, corresponding to individual agents on the field for identification and tracking purposes.

The marking interface 800 may implement technical criteria for identifying marking pairs where defenders and attackers maintain less than 5 meters separation distance for at least 3 seconds duration. The system may process tracking data through computational operations that calculate Euclidean distances between all possible agent pairs using the formula d=[(x2−x1)²+(y2−y1)²], where (x1, y1) and (x2, y2) represent the positional coordinates of potential marking pairs. The marking interface 800 may apply filtering algorithms to identify sustained defensive coverage relationships by monitoring separation distances across consecutive frames and maintaining temporal tracking of proximity relationships that exceed the minimum duration threshold.

The computational implementation for measuring separation distance may involve real-time processing of positional coordinates extracted from the tracking data system 116, with coordinate transformations applied to ensure accurate spatial measurements based on field dimensions and camera calibration parameters. The system may calculate separation distances at sampling frequencies of 5-25 Hz, generating continuous proximity measurements between all defensive and offensive agent pairs throughout the sporting occasion. When a defensive agent at position [25, 30] tracks an offensive agent at position [27, 32], the marking interface 800 may calculate separation distance as d=√[(27−25)²+(32−30)²]=√[4+4]=2.8 meters, determining that the proximity threshold of 5 meters has been satisfied.

The marking interface 800 may determine movement similarity through differential analysis of velocity vectors for potential marking pairs, applying correlation analysis to compare movement patterns between defensive and offensive agents. The system may calculate velocity vectors for each agent by applying differential analysis to consecutive positional coordinates, determining movement correlation coefficients that quantify the similarity between defensive and offensive player movements. When both a defensive player and offensive player exhibit similar movement vectors across multiple frames, the marking interface 800 may identify high movement correlation values that indicate sustained tracking behavior characteristic of marking relationships.

For example, when a defensive player moves from position [25, 30] to [26, 31] while an offensive player moves from [27, 32] to [28, 33], the marking interface 800 may calculate velocity vectors of [25, 25] meters per second for both players. The system may determine movement correlation by analyzing the similarity between these velocity vectors across multiple consecutive frames, generating correlation coefficients that exceed threshold values of 0.7 when sustained tracking behavior is detected. The marking interface 800 may combine proximity measurements with movement correlation analysis to identify marking relationships that satisfy both spatial and temporal criteria.

The distance goal side measurement may involve analyzing the relative positions of defensive players with respect to offensive players and goal locations to ensure appropriate tactical positioning in marking assignments. The marking interface 800 may calculate goal-side positioning by determining whether defensive agents maintain positions between offensive agents and the goal they are defending, applying geometric analysis to evaluate defensive coverage angles and positioning effectiveness. The system may process goal-side distance measurements by calculating the perpendicular distance from the defensive agent's position to the line connecting the offensive agent and the goal center, ensuring that marking assignments maintain tactically sound defensive positioning.

The marking interface 800 may implement a constraint-based assignment system where each defensive agent may be assigned to mark only one offensive agent at any given time, while each offensive agent may be simultaneously marked by multiple defensive agents. This one-to-many relationship structure may enable the system to model realistic defensive scenarios where multiple defenders converge on high-threat offensive players while maintaining individual marking responsibilities. The system may process marking assignments by evaluating all possible defensive-offensive agent pairs and selecting optimal assignments for each defensive agent based on proximity, movement correlation, and goal-side positioning factors.

The technical implementation for identifying defensive matchups may involve processing tracking data through parallel computational pipelines that simultaneously evaluate proximity thresholds, temporal persistence requirements, and movement correlation criteria for all potential marking pairs. The marking interface 800 may maintain temporal tracking of marking relationships by storing historical proximity and correlation data across multiple frames, enabling the system to identify marking assignments that persist for the required 3-second minimum duration. When multiple defensive agents are positioned within the 5-meter proximity threshold of the same offensive agent, the marking interface 800 may assign each defensive agent to that single offensive target, creating multiple concurrent marking relationships.

The marking interface 800 may provide visual representation of identified marking relationships through graphical indicators that connect defensive and offensive agents when marking criteria are satisfied. The system may display marking assignments using connecting lines, color coding, or highlighting mechanisms that enable analysts and coaches to quickly identify defensive coverage patterns and tactical formations. The visual representation may update in real-time as marking relationships form and dissolve throughout the sporting occasion, providing immediate feedback on defensive organization and coverage effectiveness.

The automated identification of defensive matchups through the marking interface 800 may enable quantitative analysis of defensive performance by measuring marking consistency, coverage effectiveness, and tactical discipline across different game situations. The system may generate marking statistics that quantify the percentage of time each defensive agent maintains appropriate marking assignments, the frequency of marking breakdowns, and the effectiveness of defensive coverage in preventing offensive opportunities. The marking interface 800 may transform subjective assessments of defensive performance into objective measurements that can be compared across different players, teams, and tactical systems.

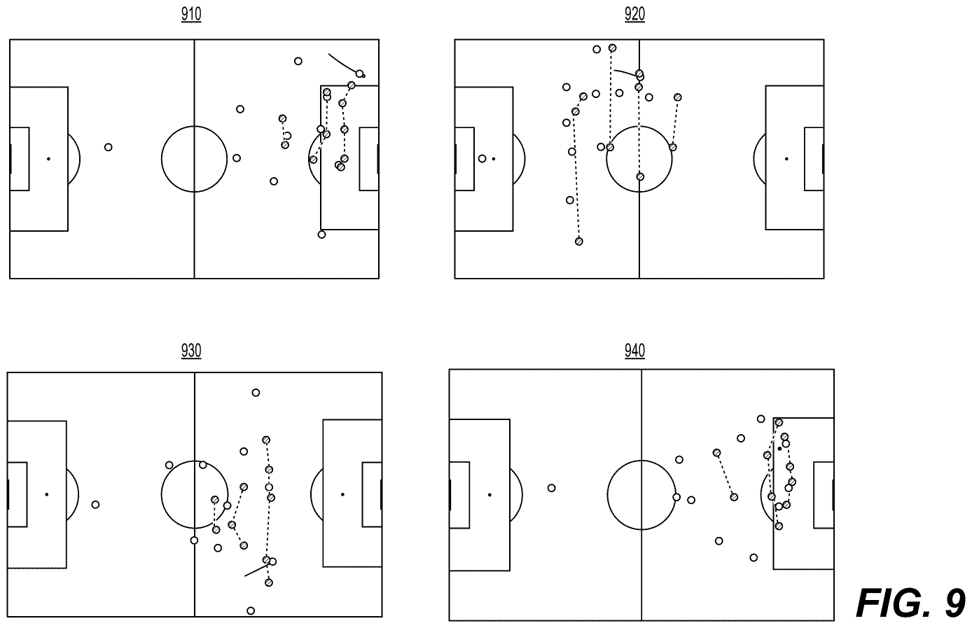

Referring to FIG. 9, the system may implement distinct line-breaking patterns that demonstrate different tactical approaches for penetrating defensive formations through automated detection of movement trajectories that successfully breach detected defensive lines. The line detection 530 may employ a clustering technique to group players into defensive lines, midfield lines, and attacking lines based on x-coordinate positioning, enabling the system to identify when ball movement or agent movement successfully penetrates through detected defensive formations. The clustering algorithm may analyze the spatial distribution of players at each frame and apply statistical methods to determine natural breakpoints that separate players into tactically meaningful groups.

A line breaking around the defense 910 may occur when the ball carrier or attacking agents circumvent the defensive line by moving laterally around the perimeter of the defensive formation rather than attempting direct penetration through the center. The system may detect this pattern when the ball or agent movement transitions from one side of the defensive line cluster to the other side while maintaining a y-coordinate position that avoids direct confrontation with the central defensive players. The clustering algorithm may identify the defensive line boundaries by analyzing x-coordinate positions of defensive players and determining the natural breakpoints that define the extent of the defensive formation. When the ball carrier moves from an x-coordinate position of 25 to an x-coordinate position of 75 while maintaining a y-coordinate that bypasses the defensive cluster centered at x-coordinate 50, the system may classify this movement as line breaking around the defense 910.

The technical implementation for detecting line breaking around the defense 910 may involve monitoring ball and agent trajectories that exhibit lateral movement patterns designed to avoid direct engagement with the defensive line cluster. The system may calculate the minimum distance between the ball carrier's trajectory and the defensive line centroid, determining that circumvention has occurred when the trajectory maintains distances greater than threshold values while successfully advancing beyond the defensive line's x-coordinate boundaries. The clustering algorithm may update defensive line boundaries dynamically as defensive formations shift during gameplay, ensuring that the detection system accurately identifies circumvention patterns even when defensive lines adjust their positioning.

A line braking through the midfield 920 may represent direct penetration through the midfield line cluster where ball movement or agent movement successfully passes between or through midfield players positioned in the central areas of the field. The system may detect this pattern when the ball or attacking agents cross the x-coordinate boundaries of the midfield line cluster while maintaining trajectories that pass through the spatial gaps or directly challenge midfield players. The clustering technique may group midfield players based on their x-coordinate positioning, typically identifying players positioned in the central third of the field as belonging to the midfield line cluster.

The detection mechanism for line braking through the midfield 920 may analyze ball and agent trajectories that exhibit forward movement patterns designed to penetrate the midfield defensive structure. When the ball moves from an x-coordinate position of 30 to an x-coordinate position of 60 while passing through a midfield line cluster centered at x-coordinate 45, the system may identify this movement as successful midfield line penetration. The clustering algorithm may determine midfield line boundaries by analyzing the spatial distribution of midfield players and identifying natural breakpoints that separate midfield positioning from defensive and attacking positioning.

A line breaking around the midfield and through the defense 930 may demonstrate a combination pattern where attacking play circumvents the midfield line through lateral movement before subsequently penetrating directly through the defensive line. The system may detect this complex pattern by analyzing multi-phase movement sequences that exhibit both circumvention and penetration characteristics across different defensive layers. The clustering algorithm may simultaneously track both midfield and defensive line boundaries, enabling the system to identify when ball or agent movement successfully bypasses one defensive layer while penetrating another.

The technical implementation for detecting line breaking around the midfield and through the defense 930 may involve sequential analysis of movement patterns that first exhibit lateral circumvention of the midfield cluster followed by forward penetration of the defensive cluster. The system may track ball trajectories that move laterally from x-coordinate 25 to x-coordinate 75 to bypass a midfield line cluster, then advance forward through a defensive line cluster positioned at x-coordinate 85. The clustering algorithm may maintain separate boundary definitions for midfield and defensive lines, enabling the system to distinguish between circumvention of one line and penetration of another within the same attacking sequence.

A line breaking through the midfield 940 may represent another variation of direct midfield penetration where ball movement or agent movement successfully crosses midfield line boundaries through different tactical approaches or spatial locations compared to the line braking through the midfield 920. The system may distinguish between different types of midfield penetration based on the specific trajectories, velocities, and spatial characteristics of the penetrating movement. The clustering algorithm may identify multiple potential penetration points within the midfield line cluster, enabling the system to classify different penetration patterns based on their tactical characteristics.

The clustering technique may implement statistical analysis that minimizes within-group variance while maximizing between-group separation to determine optimal breakpoints for defensive line identification. The algorithm may process x-coordinate positions of all players at each frame and apply iterative optimization to identify the cluster boundaries that best represent natural tactical formations. The clustering process may require specification of the number of clusters, typically defaulting to three clusters representing defensive, midfield, and attacking lines, though the system may adapt to different tactical formations by adjusting cluster numbers based on player distribution patterns.

The clustering algorithm may calculate within-group variance by measuring the sum of squared deviations between individual player x-coordinates and their respective cluster centroids. The system may minimize this variance while simultaneously maximizing the separation between cluster centroids to ensure that defensive lines are clearly distinguished from midfield and attacking lines. When players are positioned at x-coordinates [15, 17, 19, 35, 37, 39, 55, 57, 59], the clustering algorithm may identify optimal breakpoints at x-coordinates 27 and 47, creating three clusters with centroids at approximately x-coordinates 17, 37, and 57.

The system may detect successful line penetration by monitoring ball and agent movements that cross the cluster boundaries identified by the clustering algorithm. When an attacking player moves from position [30, 25] to position [40, 25] between consecutive frames, the system may apply differential analysis to determine that the player has crossed a midfield line boundary at x-coordinate 37. The line detection 530 may classify this movement as a line-breaking action and update tactical metrics to reflect the penetrating movement through the midfield line cluster.

The detection capabilities for movement penetration may involve real-time analysis of ball trajectories and agent trajectories that successfully breach defensive line boundaries as defined by the clustering algorithm. The system may monitor ball movement by tracking the ball's x-coordinate position across consecutive frames and identifying when the ball crosses cluster boundaries in the forward direction toward the opponent's goal. When the ball moves from x-coordinate 25 to x-coordinate 45, crossing a defensive line boundary at x-coordinate 35, the system may register this movement as successful ball penetration through the defensive line.

Agent movement penetration may be detected through similar trajectory analysis applied to individual player movements that cross defensive line boundaries. The system may track each attacking player's x-coordinate position and identify when players successfully advance beyond defensive line clusters through running movements, positioning changes, or tactical runs. When an attacking midfielder positioned at x-coordinate 30 makes a forward run to x-coordinate 50, crossing a defensive line boundary at x-coordinate 40, the system may classify this movement as successful agent penetration through the defensive line.

The line detection system may process multiple simultaneous penetration events when several attacking players or the ball cross defensive line boundaries within the same time period. The system may track concurrent line-breaking actions by monitoring all attacking agents and the ball simultaneously, identifying complex attacking patterns where multiple penetration events occur in coordination. When three attacking players and the ball simultaneously cross midfield line boundaries during a coordinated attacking move, the system may register multiple line-breaking actions and analyze their collective impact on defensive line integrity.

The dynamic updating of cluster boundaries may enable the system to adapt to changing defensive formations throughout the sporting occasion. As defensive players adjust their positioning in response to attacking threats or tactical changes, the clustering algorithm may recalculate cluster boundaries to reflect the updated defensive structure. The system may maintain temporal consistency in line detection by applying smoothing algorithms that prevent rapid fluctuations in cluster boundaries while ensuring that significant formation changes are accurately captured and reflected in the line-breaking detection system.

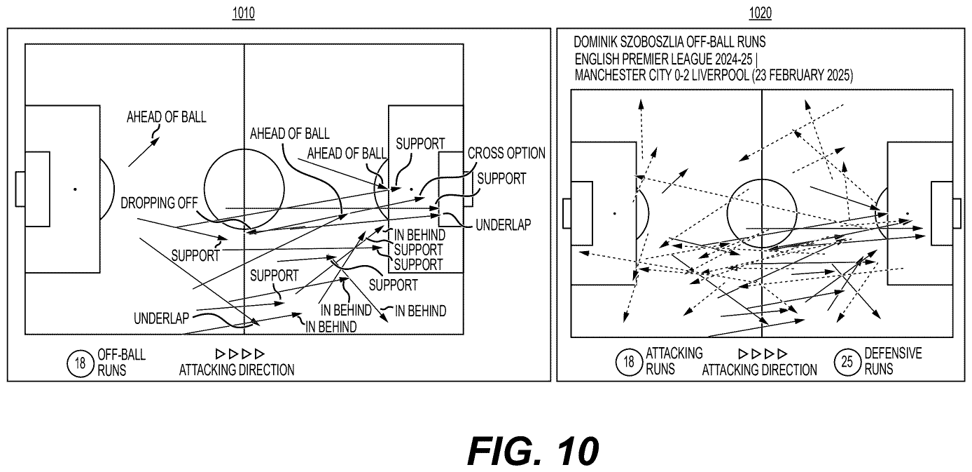

Referring to FIG. 10, an off-ball runs output 1010 and an off-ball runs output 1020 may demonstrate the system's capability to identify and visualize player movement patterns through automated detection of sustained movement episodes that occur when agents do not possess the ball. The off-ball runs output 1010 may display multiple directional arrows radiating from player positions, indicating various attacking runs and movement options that attacking players execute to create scoring opportunities or provide passing alternatives for teammates. The off-ball runs output 1020 may similarly display directional arrows representing defensive runs and tracking movements across the field, illustrating how defensive players position themselves to counter-attacking threats and maintain tactical organization.

The system may process tracking data to identify and classify off-ball runs through pattern recognition algorithms that analyze velocity profiles and distance thresholds to distinguish meaningful movement episodes from routine positional adjustments. For example, the tracking data system 116 of FIG. 1 may monitor each of the one or more agents 112 of FIG. 1 continuously throughout the sporting occasion, applying differential analysis to consecutive positional coordinates to calculate instantaneous velocities and movement characteristics. The pattern recognition algorithms may detect sustained movement episodes by identifying periods where agents maintain movement above predefined velocity thresholds while covering minimum distance requirements that indicate purposeful tactical movement rather than casual repositioning.

The technical criteria for player run detection may require agents to maintain movement above 5 m/s for 18 consecutive frames, ensuring that detected runs represent sustained effort rather than brief acceleration bursts. The system may process tracking data at sampling frequencies of 5-25 Hz, where 18 consecutive frames may correspond to approximately 0.72 to 1.8 seconds of sustained movement depending on the capture rate. The velocity threshold of 5 m/s may distinguish between walking, jogging, and running movements, ensuring that detected runs represent significant physical effort characteristic of tactical positioning or attacking movement patterns.

The pattern recognition algorithms may implement additional technical criteria requiring maximum speed during the run to reach at least 5.5 m/s, ensuring that detected movement episodes include periods of elevated intensity that characterize purposeful tactical runs. The system may calculate maximum speed by monitoring velocity measurements across all frames within the detected movement episode, identifying peak velocity values that exceed the minimum threshold. The minimum duration requirement of 2 seconds may ensure that detected runs represent sustained tactical movement rather than momentary speed changes, filtering out brief acceleration episodes that do not constitute meaningful off-ball movement patterns.

The velocity profile analysis may involve continuous monitoring of speed changes throughout the detected movement episode, enabling the system to characterize different types of runs based on acceleration patterns, sustained speed phases, and deceleration characteristics. The system may apply differential analysis to consecutive velocity measurements to calculate acceleration profiles that distinguish between explosive starts, sustained running phases, and controlled deceleration periods. When an agent accelerates from 3 m/s to 6 m/s over 4 frames, maintains 6 m/s for 12 frames, then decelerates to 4 m/s over 2 frames, the pattern recognition algorithms may identify this velocity profile as a sustained tactical run meeting the technical criteria for off-ball movement detection.

The distance threshold analysis may complement velocity monitoring by ensuring that detected runs cover sufficient spatial distance to represent meaningful tactical movement across the playing field. The system may calculate total distance covered during the movement episode by integrating velocity measurements over time, applying the formula d=Σ(v×Δt) where v represents instantaneous velocity and Δt represents the time interval between consecutive measurements. The distance threshold may ensure that detected runs represent significant positional changes rather than stationary high-intensity movements such as rapid direction changes without substantial displacement.

The off-ball runs output 1010 may visualize attacking movement patterns through directional arrows that indicate the trajectory, distance, and intensity of detected runs executed by offensive players. The system may generate visual representations that display run start positions, end positions, and trajectory paths using vector graphics that convey the spatial and temporal characteristics of the movement. The directional arrows may vary in length, thickness, or color to represent different run characteristics such as distance covered, maximum speed achieved, or duration of the movement episode. When an attacking midfielder executes a run from position [30, 40] to position [50, 25] over 2.5 seconds with a maximum speed of 6.2 m/s, the off-ball runs output 1010 may display a directional arrow connecting these positions with visual attributes that convey the run's intensity and tactical significance.

The off-ball runs output 1020 may demonstrate defensive movement patterns through similar visualization techniques applied to defensive players who execute tracking runs, recovery runs, and positional adjustments in response to attacking threats. The system may identify defensive runs using the same technical criteria of velocity thresholds, frame duration, and maximum speed requirements, ensuring consistent detection methodology across both attacking and defensive movement patterns. The defensive run visualization may display how defensive players adjust their positioning to maintain marking assignments, close down attacking threats, or recover defensive shape following tactical transitions.

The pattern recognition algorithms may distinguish between different types of off-ball runs based on directional characteristics, spatial context, and tactical timing relative to ball possession and game events. The system may classify runs as forward runs when movement exhibits positive progression toward the opponent's goal, lateral runs when movement occurs primarily along the y-axis without significant forward progression, and recovery runs when movement exhibits negative progression toward the player's own goal. The classification process may analyze run trajectories using vector analysis to determine primary movement direction and tactical purpose based on spatial relationships with the ball, teammates, and opponents.

The automated detection of off-ball runs may enable the system to generate comprehensive movement analysis that quantifies player work rate, tactical discipline, and positional effectiveness throughout the sporting occasion. The system may calculate run frequency statistics that measure how often each player executes off-ball movements meeting the technical criteria, providing objective measurements of player activity levels and tactical engagement. The run distance analysis may quantify total distance covered through off-ball movements, enabling comparison of work rate across different players, positions, and tactical systems.

The technical implementation for off-ball run detection may process tracking data through parallel computational pipelines that simultaneously monitor all agents for movement patterns meeting the velocity, duration, and distance criteria. The system may maintain temporal buffers that store velocity measurements across consecutive frames, enabling real-time evaluation of whether current movement episodes satisfy the 18-frame duration requirement. When an agent's velocity exceeds 5 m/s for the first frame, the system may begin monitoring subsequent frames to determine whether the velocity threshold is maintained for the required duration while tracking maximum speed achievement and total distance covered.

The player run identification may serve as one of the one or more metrics determined by the system for automated transformation of sports data, providing contextual information about agent movement patterns that complement positional analysis with behavioral insights. The computer implemented method may utilize player run detection to identify one or more movement patterns for each of the one or more agents 112, enabling comprehensive analysis of both individual player behavior and collective team movement dynamics. The system may determine an output based on the one or more metrics including player runs, generating tactical insights that combine positional data with movement pattern analysis to provide enhanced understanding of sporting occasion dynamics and player performance characteristics.

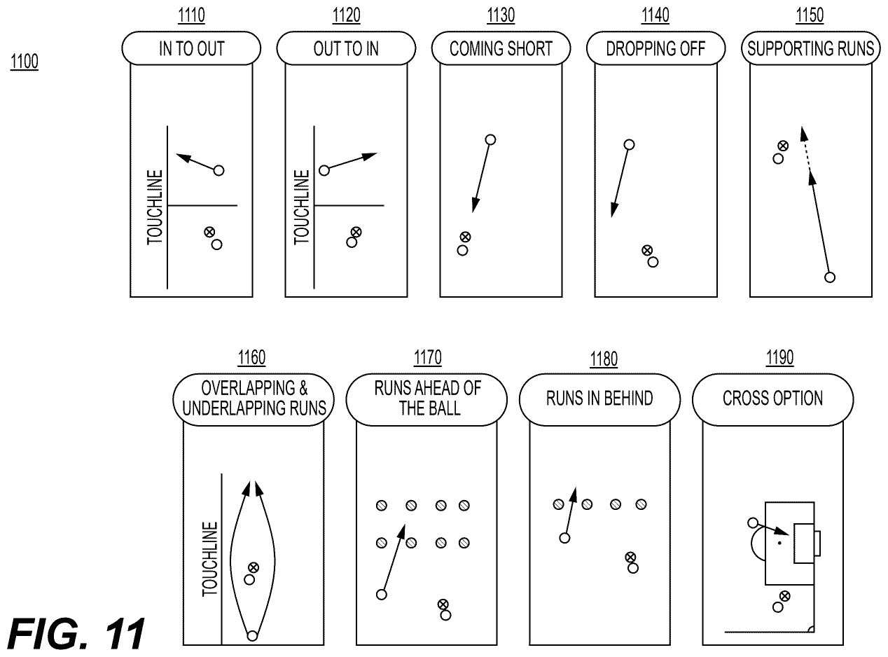

Referring to FIG. 11, in-possession player runs 1100 may represent a comprehensive categorization system that processes tracking data to identify and classify movement patterns executed by agents when their team maintains possession of the ball. The in-possession player runs 1100 may implement pattern recognition algorithms that analyze directional patterns, field locations, and team formations to distinguish between nine distinct types of offensive movement behaviors based on positional data and movement data extracted from each frame of video data. The system may utilize rules-based definitions combined with computational operations including cosine similarity calculations, distance thresholds, and directional change analysis to automatically classify agent movements into tactical categories that provide contextual understanding of offensive positioning and movement strategies.

The in-possession player runs 1100 may process tracking data through real-time analysis that monitors agent movement patterns relative to ball position, teammate positions, and field geometry to determine tactical intent and movement characteristics. The system may apply differential analysis to consecutive positional coordinates to calculate velocity vectors, directional changes, and spatial relationships that enable classification of movement patterns into specific run types. The pattern recognition algorithms may evaluate movement trajectories using vector analysis to determine primary movement direction, spatial context relative to the ball carrier, and tactical timing within the possession sequence.

An in to out 1110 may represent movement patterns where an agent transitions from a central field position to a wider field position during possession phases. The system may detect the in to out 1110 through analysis of y-coordinate changes that indicate lateral movement from central areas toward the sideline boundaries of the playing field. The pattern recognition algorithms may calculate the agent's starting position relative to the field center line and monitor movement trajectories that exhibit increasing distance from the central axis. The system may apply distance threshold analysis to determine when an agent's y-coordinate position changes by more than 10 meters in the direction away from the field center, indicating transition from central positioning to wide positioning.

The technical implementation for detecting the in to out 1110 may involve monitoring agent positions relative to field geometry boundaries and calculating lateral displacement vectors that indicate movement toward the sideline areas. The system may process field location data by dividing the playing field into central and wide zones based on y-coordinate thresholds, typically defining central zones as areas within 15 meters of the field center line and wide zones as areas beyond this boundary. When an agent moves from a y-coordinate position of 8 meters from center to a y-coordinate position of 22 meters from center, the system may classify this movement as the in to out 1110 based on the transition from central zone to wide zone positioning.

An out to in 1120 may represent the inverse movement pattern where an agent transitions from a wide field position to a central field position during possession phases. The system may detect the out to in 1120 through analysis of y-coordinate changes that indicate lateral movement from sideline areas toward the central axis of the playing field. The pattern recognition algorithms may monitor movement trajectories that exhibit decreasing distance from the field center line, applying similar distance threshold analysis to identify transitions from wide positioning to central positioning. The system may calculate lateral displacement vectors that indicate movement toward the central areas of the field, distinguishing this pattern from other types of lateral movement.

The computational operations for detecting the out to in 1120 may involve cosine similarity calculations between the agent's movement vector and the vector pointing toward the field center line. The system may calculate the cosine similarity including the agent's movement and the agent's position to the field center. When the cosine similarity exceeds a threshold value, indicating strong directional alignment toward the center, and the agent's movement covers a minimum distance of 8 meters, the system may classify the movement as the out to in 1120.

A coming short 1130 may represent movement patterns where an agent moves directly toward the ball carrier to provide a short passing option during possession phases. The system may detect the coming short 1130 through analysis of movement vectors that exhibit strong directional alignment toward the ball carrier's position, combined with distance reduction measurements that indicate the agent is approaching the ball. The pattern recognition algorithms may calculate the cosine similarity between the agent's movement vector and the vector pointing from the agent's position to the ball carrier's position, identifying high correlation values that indicate purposeful movement toward the ball.

The technical implementation for detecting the coming short 1130 may involve continuous monitoring of the distance between the agent and the ball carrier, identifying movement episodes where this distance decreases consistently over multiple consecutive frames. The system may apply distance threshold analysis to ensure that the agent moves within a proximity range of 5-15 meters from the ball carrier, distinguishing short support runs from longer-range movement patterns. When an agent positioned 12 meters from the ball carrier moves to within 6 meters while maintaining a cosine similarity of a predetermined value or higher with the ball-directed vector, the system may classify this movement as the coming short 1130.

A dropping off 1140 may represent movement patterns where an agent moves backward away from an advanced position to create space or receive the ball in a deeper area of the field. The system may detect the dropping off 1140 through analysis of movement vectors that exhibit directional alignment away from the opponent's goal, combined with positional analysis that indicates the agent is moving to a less advanced field position. The pattern recognition algorithms may calculate the agent's movement direction relative to the goal direction vector, identifying movement patterns that exhibit negative progression toward the opponent's goal.

The computational operations for detecting the dropping off 1140 may involve analyzing the agent's x-coordinate changes to determine backward movement relative to the attacking direction. The system may calculate directional change analysis by comparing the agent's current movement vector to the forward attacking direction, identifying movement patterns where the cosine similarity with the goal direction vector falls below a predetermined value, indicating movement in the opposite direction from the attacking goal. The system may apply distance thresholds requiring minimum backward movement of 8 meters to distinguish meaningful dropping off movements from minor positional adjustments.

Supporting runs 1150 may represent movement patterns that start from behind the ball carrier's position and may end either behind or in front of the ball carrier to provide passing options and tactical support. The system may detect the supporting runs 1150 through analysis of starting positions relative to the ball carrier's x-coordinate, identifying agents who begin their movement from positions closer to their own goal than the ball carrier. The pattern recognition algorithms may monitor movement trajectories that maintain tactical support positioning while providing passing alternatives for the ball carrier.

The technical implementation for detecting the supporting runs 1150 may involve analyzing the agent's starting position relative to the ball carrier's x-coordinate position at the beginning of the movement episode. The system may classify movements as supporting runs when the agent's initial x-coordinate position is at least 5 meters behind the ball carrier's position, indicating a supporting role rather than an advanced attacking position. The system may apply directional pattern analysis to distinguish between supporting runs that end behind the ball carrier and those that progress to positions ahead of the ball carrier, enabling classification of different types of support movement.

Overlapping and underlapping runs 1160 may represent movement patterns where an agent starts from behind the ball carrier in wide or half-space areas and progresses beyond the ball carrier on either the outside (overlapping) or inside (underlapping) trajectory. The system may detect the overlapping and underlapping runs 1160 through analysis of starting positions, movement trajectories, and final positions relative to the ball carrier's location and field geometry. The pattern recognition algorithms may distinguish between overlapping runs that progress toward the sideline and underlapping runs that progress toward the central areas of the field.

The computational operations for detecting the overlapping and underlapping runs 1160 may involve analyzing the agent's movement trajectory relative to the ball carrier's position and the field boundaries. The system may calculate the agent's starting position in wide areas or half-spaces by evaluating y-coordinate positioning relative to field geometry, identifying agents positioned in areas suitable for overlapping or underlapping movement. When an agent starts from a position 3 meters behind the ball carrier and 8 meters from the sideline, then moves to a position 3 meters ahead of the ball carrier and 4 meters from the sideline, the system may classify this movement as an overlapping run based on the progression beyond the ball carrier toward the outside boundary.

Runs ahead of the ball 1170 may represent movement patterns that start ahead of the ball carrier's position but do not progress beyond the opposition's defensive line. The system may detect the runs ahead of the ball 1170 through analysis of starting positions relative to the ball carrier's x-coordinate and movement trajectories that maintain positioning ahead of the ball without penetrating the defensive line boundaries identified through the line detection 530. The pattern recognition algorithms may monitor agent movements that provide advanced passing options while respecting defensive line constraints.

The technical implementation for detecting the runs ahead of the ball 1170 may involve analyzing the agent's starting x-coordinate position relative to the ball carrier's position and the defensive line position determined through clustering. The system may classify movements as runs ahead of the ball when the agent's initial x-coordinate position is at least 3 meters ahead of the ball carrier's position and the movement trajectory does not cross the defensive line boundary. The system may apply distance threshold analysis to ensure that the agent maintains positioning ahead of the ball while avoiding offside positioning relative to the defensive line.

Runs in behind 1180 may represent movement patterns that start ahead of the ball carrier's position and successfully progress beyond the opposition's defensive line while maintaining onside positioning. The system may detect the runs in behind 1180 through analysis of movement trajectories that cross the defensive line boundaries identified through the line detection 530, combined with offside analysis that ensures the movement remains within legal positioning constraints. The pattern recognition algorithms may monitor agent movements that penetrate defensive formations while maintaining tactical legality.

The computational operations for detecting the runs in behind 1180 may involve analyzing the agent's movement trajectory relative to the defensive line position and the offside line position determined by the second-to-last defender's x-coordinate. The system may calculate the timing of the agent's movement relative to the ball carrier's actions to ensure that the run begins before the ball is played, maintaining onside positioning according to offside rules. When an agent positioned 2 meters ahead of the ball carrier accelerates to cross the defensive line boundary while remaining behind the second-to-last defender, the system may classify this movement as the runs in behind 1180.

A cross option 1190 may represent movement patterns where an agent runs directly toward the goal to receive a cross when the ball carrier is positioned in wide areas outside the penalty area. The system may detect the cross option 1190 through analysis of the ball carrier's position in wide areas combined with agent movement toward goal-scoring positions within the penalty area. The pattern recognition algorithms may identify scenarios where the ball carrier is positioned outside the penalty area in wide zones while teammates execute movement patterns designed to receive crossing opportunities.

The technical implementation for detecting the cross option 1190 may involve analyzing the ball carrier's position relative to field geometry to determine when crossing situations are likely to occur. The system may identify crossing scenarios when the ball carrier is positioned within 5 meters of the sideline and within 30 meters of the goal line, indicating positioning suitable for cross delivery. The system may monitor agent movements that exhibit directional alignment toward the goal area, calculating movement vectors that point toward positions within the penalty area where crosses may be received. When an agent moves from a position outside the penalty area to a position within the penalty area while the ball carrier is in a wide crossing position, the system may classify this movement as the cross option 1190.

The pattern recognition algorithms for the in-possession player runs 1100 may process all nine run types simultaneously through parallel computational pipelines that analyze agent movements in real-time during possession phases. The system may maintain temporal tracking of possession status through integration with the event data 208, ensuring that run classification occurs only when the agent's team maintains ball possession. The computational efficiency of the run classification system may enable real-time processing during live sporting occasions, providing immediate tactical insights for coaches, analysts, and broadcasters who require understanding of offensive movement patterns and tactical positioning strategies.

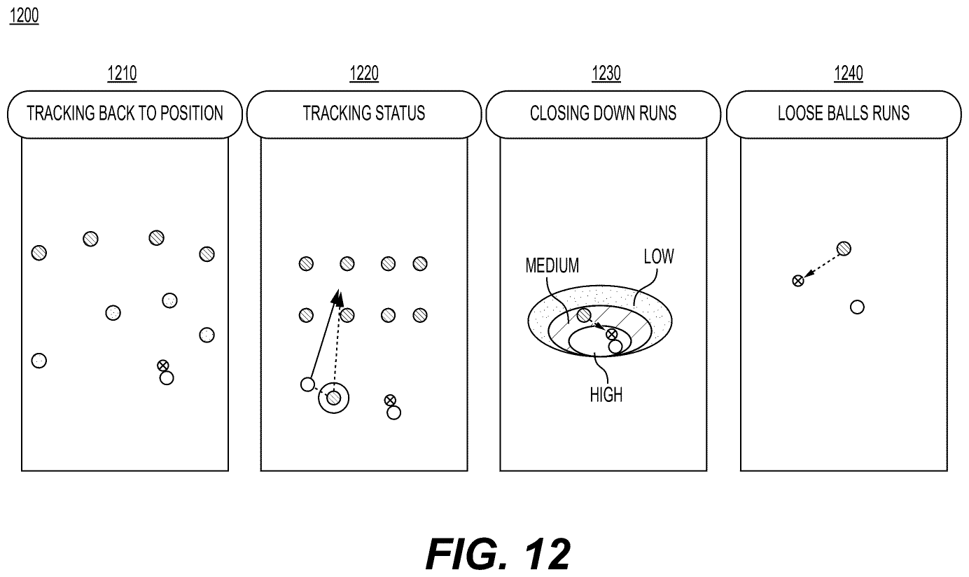

Referring to FIG. 12, out-of-possession player runs 1200 may represent a comprehensive categorization system that processes tracking data to identify and classify movement patterns executed by agents when their team does not maintain-possession of the ball. The out-of-possession player runs 1200 may implement pattern recognition algorithms that analyze defensive positioning, opponent tracking, and ball recovery movements to distinguish between four distinct types of defensive movement behaviors based on positional data and movement data extracted from each frame of video data. The system may utilize rules-based definitions combined with computational operations including distance calculations, directional analysis techniques, and marking percentages methodology to automatically classify agent movements into tactical categories that provide contextual understanding of defensive positioning and movement strategies.

The out-of-possession player runs 1200 may process tracking data through real-time analysis that monitors agent movement patterns relative to opponent positions, ball location, and defensive formation requirements to determine tactical intent and defensive responsibilities. The system may apply differential analysis to consecutive positional coordinates to calculate velocity vectors, directional changes, and spatial relationships that enable classification of movement patterns into specific defensive run types. The pattern recognition algorithms may evaluate movement trajectories using vector analysis to determine primary movement direction, spatial context relative to opposing players, and tactical timing within the defensive sequence.

The technical implementation for identifying defensive runs may involve continuous monitoring of agent positions relative to opponent positions, ball location, and team formation requirements throughout periods when the agent's team does not possess the ball. The system may calculate marking percentages by analyzing the proportion of frames where defensive agents maintain proximity to assigned opponents, applying distance threshold analysis to determine when defensive coverage criteria are satisfied. The marking percentages methodology may require defensive agents to maintain positioning within 5 meters of assigned opponents for specified percentages of frames to qualify for different types of defensive run classifications.

The distance calculations approach may involve real-time computation of separation distances between defensive agents and their assigned targets using Euclidean distance formulas applied to positional coordinates extracted from the tracking data system 116. The directional analysis techniques may process movement vectors to determine whether defensive agents are moving toward assigned targets, toward the ball, or toward specific field positions based on tactical requirements.

The computational criteria for defensive run classification may implement specific thresholds that distinguish between different types of defensive movement patterns based on the target being tracked and the consistency of the tracking behavior. When tracking a player with the ball, the system may require defensive agents to maintain proximity and directional alignment for at least 60% of frames within the movement episode to qualify as a valid defensive run. When tracking a player without the ball, the system may apply more stringent criteria requiring defensive agents to maintain proximity and directional alignment for at least 80% of frames within the movement episode, reflecting the increased difficulty and tactical importance of tracking off-ball opponents.

A tracking back to position 1210 may represent movement patterns where an agent returns to their designated defensive position following a tactical transition or possession change. The system may detect the tracking back to position 1210 through analysis of movement vectors that exhibit directional alignment toward predetermined defensive positions based on tactical formation requirements. The pattern recognition algorithms may identify scenarios where agents move from advanced or displaced positions back toward their assigned defensive zones following loss of possession or tactical transitions.

The technical detection method for the tracking back to position 1210 may involve analyzing the agent's current position relative to their designated defensive position as determined by tactical formation analysis and team shape recognition algorithms. The system may calculate the distance between the agent's current position and their assigned defensive position, identifying movement patterns that exhibit consistent progression toward the designated area. The specific parameters may require agents to cover a minimum distance of 15 meters toward their defensive position while maintaining directional consistency for at least 70% of the movement episode duration.

For example, when a defensive midfielder positioned at coordinates [60, 30] following an attacking phase needs to return to their designated defensive position at coordinates [35, 30], the system may monitor the agent's movement trajectory as they progress from the advanced position back toward their defensive zone. The tracking back to position 1210 detection may identify this movement when the agent maintains directional alignment toward the defensive position for at least 70% of frames while covering the required 25-meter distance. The system may distinguish this movement from other defensive runs by analyzing the target destination as a positional zone rather than a specific opponent or ball location.

A tracking status 1220 may represent movement patterns where an agent follows and monitors an opposing player to maintain defensive coverage and prevent offensive opportunities. The system may detect the tracking status 1220 through analysis of movement correlation between the defensive agent and the assigned opponent, calculating movement similarity coefficients that indicate sustained tracking behavior. The pattern recognition algorithms may identify scenarios where defensive agents maintain proximity to specific opponents while mirroring their movement patterns to provide effective defensive coverage.

The technical detection method for the tracking status 1220 may involve calculating movement correlation coefficients between the defensive agent and the assigned opponent by comparing velocity vectors and directional changes across consecutive frames. The system may apply the marking percentages methodology to determine whether the defensive agent maintains appropriate proximity to the opponent for the required percentage of frames. When tracking a player without the ball, the system may require the defensive agent to maintain positioning within 5 meters of the opponent for at least 80% of frames within the movement episode, ensuring consistent defensive coverage of off-ball threats.

The specific parameters for the tracking status 1220 may include distance threshold analysis requiring defensive agents to maintain separation distances below 5 meters for the specified percentage of frames, combined with movement correlation analysis requiring correlation coefficients above 0.6 between defensive and opponent movement vectors. For example, when a center-back positioned at coordinates [25, 35] tracks an opposing striker positioned at coordinates [27, 37], the system may monitor both agents' movement patterns across multiple frames. If the center-back maintains positioning within 5 meters of the striker for 85% of frames while exhibiting movement correlation of 0.7, the system may classify this behavior as the tracking status 1220 based on the sustained tracking criteria for a player without the ball.

Closing down runs 1230 may represent movement patterns where a defensive agent approaches and applies pressure to an opponent who possesses the ball. The system may detect the closing down runs 1230 through analysis of movement vectors that exhibit directional alignment toward the ball carrier combined with distance reduction measurements that indicate the defensive agent is approaching the opponent. The pattern recognition algorithms may identify scenarios where defensive agents execute aggressive movement toward ball carriers to limit time and space available for offensive actions.

The technical detection method for the closing down runs 1230 may involve calculating the cosine similarity between the defensive agent's movement vector and the vector pointing from the agent's position to the ball carrier's position, identifying high correlation values that indicate purposeful movement toward the ball. The system may apply distance calculations to monitor the separation distance between the defensive agent and the ball carrier, identifying movement episodes where this distance decreases consistently over multiple consecutive frames. When tracking a player with the ball, the system may require the defensive agent to maintain directional alignment toward the ball carrier for at least 60% of frames while demonstrating consistent gap closure.

The specific parameters for the closing down runs 1230 may include minimum approach velocity requirements of 4 m/s combined with directional consistency thresholds requiring cosine similarity values above 0.8 between the agent's movement vector and the ball-directed vector. For example, when a defensive midfielder positioned at coordinates [45, 25] identifies an opposing midfielder with the ball at coordinates [50, 30], the system may monitor the defensive agent's movement as they approach the ball carrier. If the defensive agent maintains approach velocity above 4 m/s while exhibiting cosine similarity of 0.85 with the ball-directed vector for 65% of frames, the system may classify this movement as the closing down runs 1230 based on the sustained pressure application criteria for tracking a player with the ball.

Loose balls runs 1240 may represent movement patterns where an agent moves toward an uncontrolled ball following defensive actions such as tackles, interceptions, or deflections. The system may detect the loose balls runs 1240 through analysis of movement vectors that exhibit directional alignment toward ball positions during periods when no agent maintains clear possession. The pattern recognition algorithms may identify scenarios where agents execute recovery movements toward loose balls to regain-possession or prevent opponent ball recovery.

The technical detection method for the loose balls runs 1240 may involve monitoring ball possession status through integration with the event data 208 to identify periods when the ball is not under clear control by any agent. The system may calculate movement vectors pointing toward the ball's predicted position based on ball trajectory analysis, identifying agents whose movement exhibits strong directional alignment toward ball recovery positions. The distance calculations approach may monitor the separation distance between the agent and the ball, identifying movement episodes where agents demonstrate consistent progression toward ball recovery.

The specific parameters for the loose balls runs 1240 may include minimum approach velocity requirements of 5 m/s combined with directional consistency thresholds requiring cosine similarity values above 0.9 between the agent's movement vector and the ball-directed vector. The system may apply temporal constraints requiring the loose ball situation to persist for at least 1 second to distinguish meaningful ball recovery attempts from brief possession transitions. For example, when a tackle results in a loose ball at coordinates [40, 45] and a defensive agent positioned at coordinates [35, 40] moves toward the ball location, the system may monitor the agent's approach velocity and directional alignment. If the agent maintains approach velocity above 5 m/s while exhibiting cosine similarity of 0.92 with the ball-directed vector during the loose ball period, the system may classify this movement as the loose balls runs 1240 based on the ball recovery criteria.

The system may distinguish between different defensive run types through comparative analysis of target destinations, movement characteristics, and tactical context. The tracking back to position 1210 may be distinguished from other run types by its target destination being a positional zone rather than a specific opponent or ball location, combined with movement patterns that exhibit consistent progression toward predetermined defensive areas. The tracking status 1220 may be distinguished by its focus on opponent tracking with sustained proximity maintenance and movement correlation, requiring higher frame percentage thresholds when tracking players without the ball compared to players with the ball.

The closing down runs 1230 may be distinguished from the tracking status 1220 by its aggressive approach characteristics and focus on ball carriers rather than off-ball opponents, requiring demonstration of gap closure and pressure application rather than sustained proximity maintenance. The loose balls runs 1240 may be distinguished from other run types by its target being an uncontrolled ball rather than an opponent or positional zone, combined with temporal constraints that ensure the ball recovery situation persists for sufficient duration to constitute a meaningful recovery attempt.

The computational efficiency of the out-of-possession player runs 1200 classification system may enable real-time processing during live sporting occasions through parallel analysis pipelines that simultaneously evaluate all four defensive run types for each agent. The system may maintain temporal tracking of possession status, opponent assignments, and defensive formation requirements to ensure accurate classification of defensive movement patterns throughout periods when the agent's team does not possess the ball. The automated classification of defensive runs may provide immediate tactical insights for coaches, analysts, and broadcasters who require understanding of defensive work rate, tactical discipline, and positional effectiveness during out-of-possession phases of play.

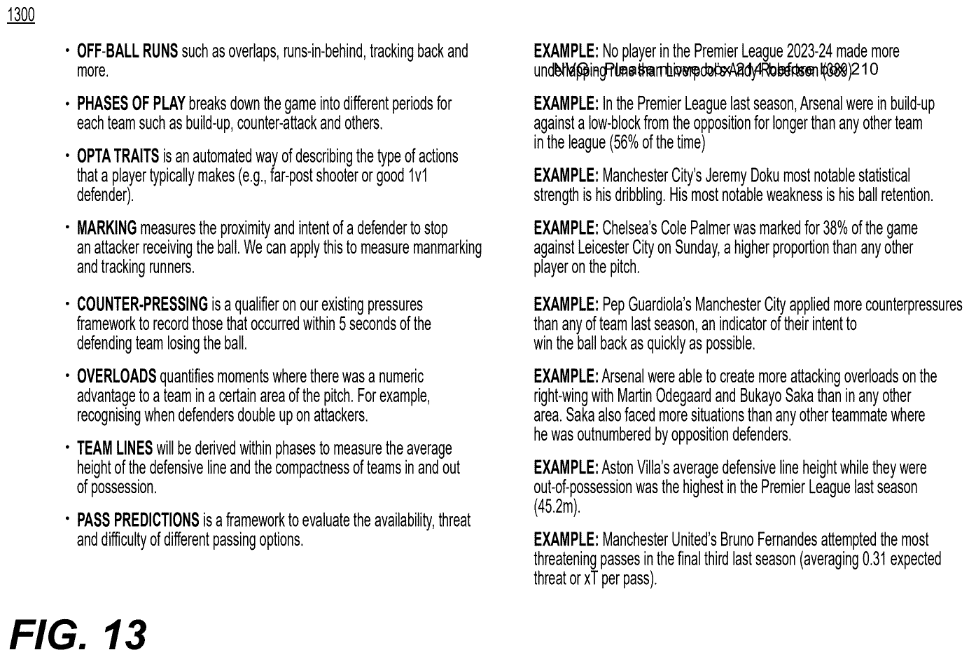

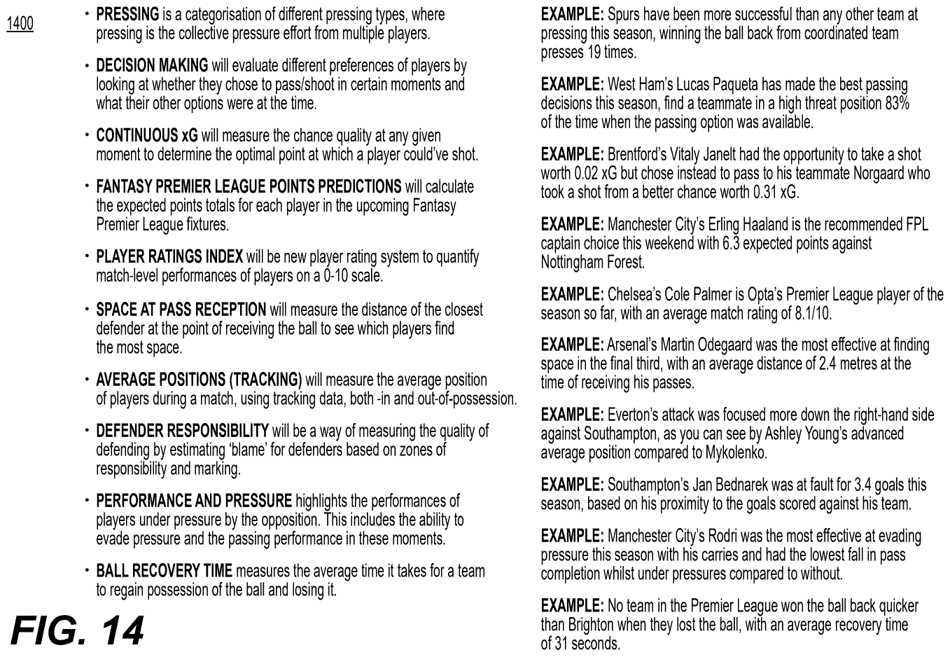

FIGS. 13 and 14 including table 1300 and table 1400 depict exemplary trait definitions, according to example embodiments. Traits may be generated based on the broadcast tracking data 206 of FIGS. 2A and 2B, the event data 208 of FIGS. 2A and 2B, and/or one or more trajectories for one or more agents, as described above. Traits may be used for agents and/or teams. For example, some traits may apply to both an agent and a team (e.g., decision making). Traits may include, for example, off-ball runs, phases of play, OPTA traits, marking, counter-pressing, overloads, team lines, pass predictions, pressing, decision making, continuous xG, fantasy premier league point predictions, player ratings index, space at pass reception, average positions, defender responsibility, performance under pressure, and ball recovery time.

Some traits (e.g., pass prediction, decision making, continuous xG) may be used by one or more machine-learning models to predict outcomes for an agent and/or a team. For example, the broadcast tracking data 206 of FIGS. 2A and 2B, the event data 208 of FIGS. 2A and 2B, and/or one or more trajectories for one or more agents may include information relating to an option or availability to pass or shoot an object (e.g., a ball) at one or more points in time during a match. This information may be used to generate a pass prediction trait for an agent and/or a team. The pass prediction trait may be further used by one or more machine-learning models to predict a pass versus shot in a future scenario based on the aggregated information for the agent and/or team. This information may be used to generate graphic and/or text information for broadcasters or individual users.

Another example of trait information may include performance under pressure. As similarly described above, the broadcast tracking data 206 of FIGS. 2A and 2B, the event data 208 of FIGS. 2A and 2B, and/or one or more trajectories for one or more agents relating to performance under pressure may be collected and/or aggregated. Once the trait (e.g., performance under pressure) has been generated, individual users may utilize this trait. For example, a coach may use this information in preparation for an upcoming match. The trait information may relate to one or more individuals on either team as a whole. Coaches may utilize this information to determine different match-ups or markings for an upcoming match as well as which players to use to optimize their chances throughout the match. In addition, individual end users (e.g., fans, fantasy players, etc.) may utilize this information to determine how to set their line-up for an upcoming match in their fantasy league.

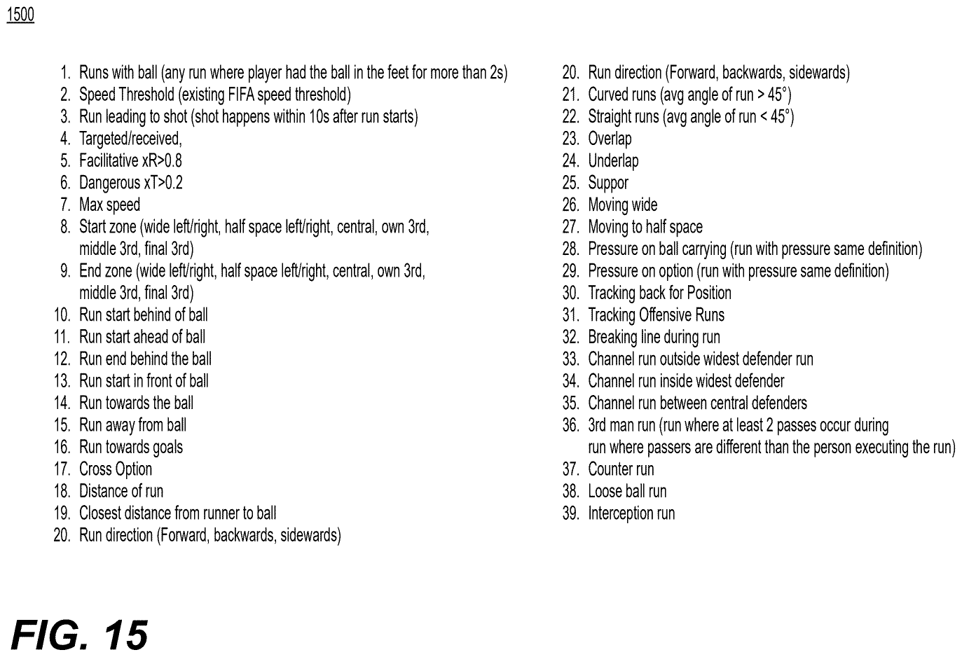

FIG. 15 illustrates a table 1500 having a list of exemplary qualifiers, according to example embodiments. One or more qualifiers may be used to determine a specific trait using the broadcast tracking data 206 of FIGS. 2A and 2B, the event data 208 of FIGS. 2A and 2B, and/or one or more trajectories for one or more agents. For example, a trait (e.g., off-ball runs) may be related to one or more qualifiers listed in FIG. 15. Player A, for example, may be associated with one or more trajectories that indicate that Player A runs away from the ball, runs towards a goal, overlaps, etc. Such qualifiers indicate that Player A has the off-ball runs trait.

In a further example, Player B may be associated with one or more trajectories that indicate that Player B pressures on ball carrying and pressures on option. Such qualifiers indicate that Player B has the pressing trait. In yet a further example, Team A may be associated with one or more trajectories that indicate that Team A has a particular end zone and channel runs with defenders. Such qualifiers indicate that Team A has the team lines trait. It is appreciated that the list of qualifiers is limited, and that additional qualifiers may be considered.

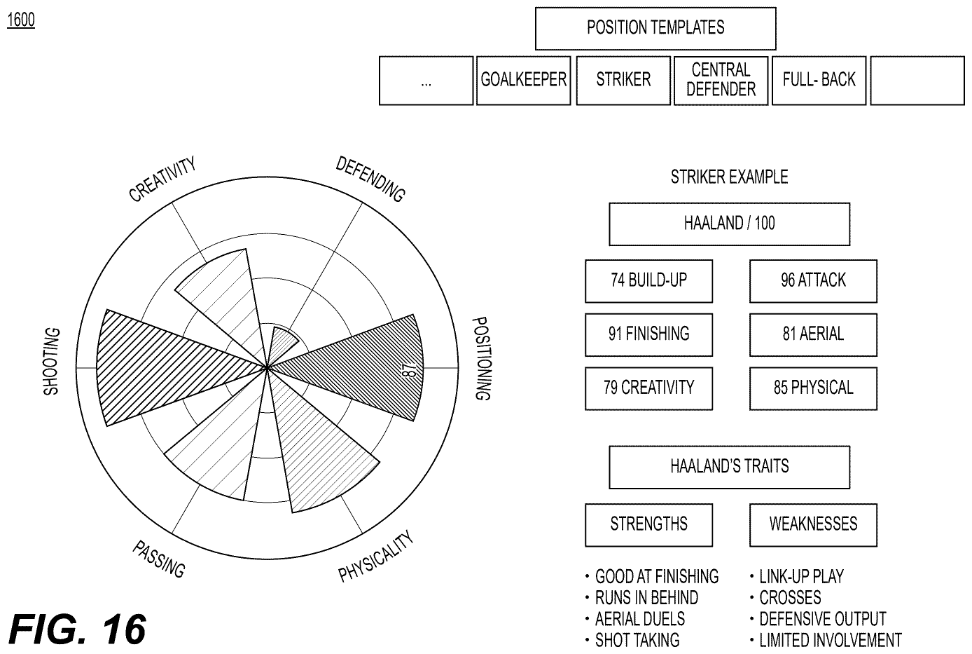

FIG. 16 illustrates the use of traits to provide an index score for an individual player (e.g., Haaland) using, for example, both offensive and defensive traits. For example, the index score may include position themes and traits. Position themes may include build-up play, finishing, creativity, attacking, aerial ability, and physical. Traits may include good at finishing, shot taking, etc. The information may be aggregated to determine an index score for each of the themes and traits as described above. The index score for each player may be given based on a numerical scale of 0-100, but other types (e.g., alphanumeric) or the like may be used. Each of the index score may be accompanied by a graphic 1600 to display the overall index score of the individual player. The graphic 1600 may include one or more categories accompanied by a color and/or shape identifying each category and their respective score. Additional graphics may be used in place of or in addition to the graphic 1600 as displayed in FIG. 16.

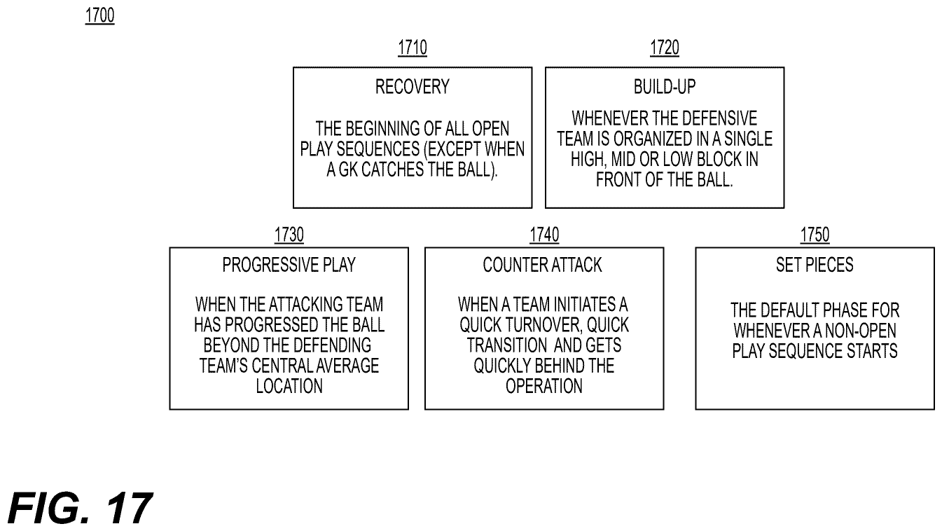

Referring to FIG. 17, one or more phases of play 1700 may implement a comprehensive categorization framework that processes tracking data and event data through rules-based definitions to classify different portions of a sporting occasion into five distinctive phases based on ball possession indicators, spatial distribution patterns, and movement characteristics. The one or more phases of play 1700 may utilize machine learning algorithms combined with expert-defined computational criteria to automatically segment continuous gameplay into tactical phases that provide contextual understanding of team strategies and game dynamics. The system may apply rules-based definitions developed through collaboration with sports experts and professional clubs to establish technical parameters including distance thresholds, time limits, ball location relative to field zones, and team formation analysis for each phase classification.

The one or more phases of play 1700 may process tracking data through real-time analysis that monitors ball possession status, team positioning patterns, and tactical transitions to determine appropriate phase classifications for each temporal segment of the sporting occasion. The system may integrate the broadcast tracking data 206 and the event data 208 to generate comprehensive contextual information that enables accurate phase determination based on both positional measurements and semantic game events. The machine learning algorithms may analyze collective team behavior by examining centroid movements, formation compactness, and directional tendencies of player groups to distinguish between different tactical phases.

A recovery 1710 may represent the initial phase where a team regains possession of the ball following a possession change or game stoppage. The system may detect the recovery 1710 through analysis of possession transitions identified in the event data 208, applying rules-based definitions that establish specific criteria for recovery phase initiation and termination. The computational criteria for the recovery 1710 may include distance limits requiring ball movement exceeding 10 meters, carry thresholds requiring individual ball carries exceeding 10 meters, pass completion requirements of 3 completed passes, and time limits restricting individual ball possession to maximum 2 seconds duration.

The technical implementation for the recovery 1710 may involve monitoring ball possession status through integration with the event data 208 to identify the precise moment when possession transitions occur. The system may apply distance threshold analysis by calculating cumulative ball movement from the initial possession point, terminating the recovery phase when total ball displacement exceeds 10 meters through any combination of passes, carries, or ball movement. The pass completion tracking may monitor successful pass events to determine when 3 completed passes have occurred within the possession sequence, triggering transition from the recovery 1710 to subsequent phases.

For example, when a defensive midfielder regains possession following an interception, the system may initiate the recovery 1710 and monitor subsequent ball movement. If the midfielder carries the ball 6 meters, then completes a pass to a teammate who carries the ball an additional 5 meters, the system may calculate total ball movement as 11 meters, exceeding the 10-meter distance threshold and triggering termination of the recovery 1710. The system may apply temporal constraints by monitoring individual ball possession duration, ensuring that no single player maintains possession for more than 2 seconds during the recovery phase.

A build-up 1720 may represent the phase where a team organizes and initiates offensive movement from defensive positions against organized defensive formations. The system may detect the build-up 1720 through analysis of defensive team positioning patterns combined with attacking team ball possession in areas where the defensive team maintains organized blocking structures. The computational criteria for the build-up 1720 may involve defensive block classification that categorizes opposing team formations as low block, medium block, or high block based on defensive team centroid positioning and defensive line locations.

The technical implementation for the build-up 1720 may utilize the line detection 530 to identify defensive formations and classify defensive block heights based on field positioning relative to goal locations. The system may calculate defensive team centroid by averaging x-coordinate positions of all defensive outfield players, applying field zone analysis to determine whether the defensive formation qualifies as low block (defensive centroid in quarter 1 of pitch, less than 26.25 meters from own goal), medium block (defensive centroid in quarter 2 or 3 with defensive line in own 5/12ths of pitch), or high block (defensive centroid in quarter 3 or 4 with defensive line outside own 5/12ths of pitch).

The build-up 1720 may require sustained defensive block positioning for at least 2 seconds to ensure stable formation analysis, preventing brief positional changes from triggering incorrect phase classifications. For example, when an attacking team maintains possession while facing a defensive formation with centroid positioned at x-coordinate 20 meters from the defensive goal and defensive line positioned at x-coordinate 15 meters from the defensive goal, the system may classify this scenario as build-up against low block. The system may combine the build-up 1720 classification with the specific block height designation to generate comprehensive phase labels such as “build-up against low block,” “build-up against medium block,” or “build-up against high block.”

A progressive play 1730 may represent the phase when the attacking team has progressed the ball beyond the defending team's central average location, indicating successful advancement into threatening field positions. The system may detect the progressive play 1730 through analysis of ball position relative to the defending team centroid, applying computational criteria that require the ball to remain behind the defending team centroid for at least 2 seconds while the attacking team maintains control. The technical implementation may involve continuous monitoring of ball x-coordinate position relative to the calculated defending team centroid position.

The computational criteria for the progressive play 1730 may include ball positioning requirements where the attacking team maintains control of the ball behind the defending team centroid for the specified duration threshold. The system may apply termination criteria that end the progressive play 1730 when the ball moves back in front of the defending team centroid for at least 1 second, or when ball movement characteristics indicate reduced attacking intensity. The reduced intensity detection may involve analyzing ball speed metrics where x-axis ball speed falls below 3 m/s and ball distance to goal speed falls below 1.5 m/s for the past 2 seconds.

For example, when an attacking team advances the ball from x-coordinate position 40 to x-coordinate position 65 while the defending team centroid is positioned at x-coordinate 60, the system may initiate the progressive play 1730 when the ball crosses behind the defending team centroid and maintains that positioning for 2 seconds. The system may monitor ball movement characteristics throughout the progressive play phase, terminating the phase when the ball retreats to x-coordinate position 58 (in front of the defending team centroid) for 1 second, or when ball speed measurements indicate reduced attacking momentum according to the velocity thresholds.

A counter-attack 1740 may represent the phase when a team initiates a quick transition and gets behind the opposition quickly following a possession change. The system may detect the counter-attack 1740 through analysis of three specific computational criteria: quick turnover requirements, quick transition characteristics, and quickly behind opposition positioning. The quick turnover criterion may require the current possession to start within 5 seconds of the previous possession, indicating rapid possession transition characteristic of counter-attacking situations.

The technical implementation for the counter-attack 1740 may involve monitoring possession timing through integration with the event data 208 to calculate the time interval between possession changes. The quick transition analysis may require the current possession's ball distance to goal to reach less than 30 meters within 15 seconds of possession starting, combined with ball speed toward the opposition goal center exceeding 5 m/s for at least 3 seconds. The quickly behind opposition criterion may require the attacking team to achieve ball possession behind the defending team centroid within 6 seconds of possession starting while the defensive team's centroid remains outside its own half.

The counter-attack 1740 may implement temporal constraints that prevent multiple counter-attacks within the same possession sequence, ensuring that each possession can generate only one counter-attack classification. The system may apply initiation timing requirements that restrict counter-attack detection to the first 15 seconds of in-play time following possession start, preventing delayed counter-attack classifications that do not reflect the rapid transition characteristics of authentic counter-attacking play.

For example, when a defensive team regains possession at x-coordinate 30 following an interception and immediately advances the ball toward the opposition goal, the system may evaluate counter-attack criteria by monitoring possession timing, ball advancement speed, and positioning relative to the defending team centroid. If the ball reaches x-coordinate 70 (less than 30 meters from goal) within 12 seconds while maintaining speed toward goal exceeding 5 m/s for 4 seconds, and the ball crosses behind the defending team centroid within 5 seconds while the defending centroid remains at x-coordinate 45 (outside their own half), the system may classify this sequence as the counter-attack 1740.

Set pieces 1750 may represent the default phase for non-open play sequences including corner kicks, free kicks, throw-ins, and other dead-ball situations. The system may detect the set pieces 1750 through analysis of game event classifications in the event data 208 that identify when play sequences begin with non-open play events rather than continuous gameplay transitions. The computational criteria for the set pieces 1750 may distinguish between attacking set pieces and standard set pieces based on ball proximity to goal at the time of the set piece initiation.

The technical implementation for the set pieces 1750 may involve analyzing ball position relative to goal location within 3 seconds of set piece initiation to determine set piece classification. Attacking set pieces may be identified when the ball distance to goal is 30 meters or less within 3 seconds of the set piece event, indicating proximity to scoring areas that requires specialized tactical analysis. Standard set pieces may be identified when the minimum ball distance to goal exceeds 30 meters within 3 seconds of the set piece event, indicating positioning in less threatening field areas.

The termination criteria for the set pieces 1750 may vary based on the attacking or standard classification, with attacking set pieces requiring more permissive criteria to account for extended tactical sequences in scoring areas. Attacking set pieces may terminate when ball carries exceed 5 meters outside the opposition box, controlled completions exceed 5 meters outside the opposition box, the ball leaves the opposition box after having been inside, or time limits exceed 10 seconds since set piece initiation. Standard set pieces may terminate when ball carries exceed 5 meters, pass completions exceed 5 meters, the ball leaves the opposition box after having been inside, or time limits exceed 3 seconds since set piece initiation.

For example, when a corner kick is awarded with the ball positioned 8 meters from the goal line, the system may classify this as an attacking set piece based on the ball distance to goal being less than 30 meters. The system may monitor subsequent ball movement and maintain the set pieces 1750 classification until the ball is carried 6 meters away from the corner position outside the penalty area, triggering termination based on the carry distance threshold for attacking set pieces. The system may then transition to appropriate subsequent phase classification based on the resulting game situation and ball positioning.

The phase switching criteria for the phases of play 1700 may implement temporal consistency requirements to avoid rapid transitions between phases that could result from brief positional changes or momentary tactical adjustments. The system may apply minimum phase duration requirements of 2 seconds for most phases, ensuring that detected phases represent sustained tactical situations rather than momentary game states. When a phase duration falls below the 2-second threshold, the system may remove the brief phase and extend the previous phase to fill the temporal gap, maintaining tactical continuity in the phase classification sequence.

The backfilling methodology may address phases that require temporal persistence to engage by extending the phase classification backward in time once the engagement criteria are satisfied. For example, when the progressive play 1730 requires the ball to remain behind the defending team centroid for 2 seconds before phase initiation, the system may backfill the progressive play classification across the preceding 2 seconds once the criteria are met, ensuring that the entire period of ball advancement is appropriately classified within the progressive play phase.

The machine learning algorithms for the phases of play 1700 may process multiple data streams simultaneously to generate comprehensive phase classifications that account for both positional measurements and semantic game events. The system may analyze ball possession indicators from the event data 208 to determine possession status and timing, while processing spatial distribution patterns from the broadcast tracking data 206 to evaluate team formations and positioning characteristics. The integration of these data streams may enable the system to generate phase classifications that reflect both the tactical context derived from positional analysis and the game state information derived from event detection.

The automated phase categorization may enable real-time tactical analysis during live sporting occasions by providing immediate classification of game periods into tactically meaningful segments. The computer implemented method may utilize the phase of play categorization to identify one or more portions of a sporting occasion into at least one of the recovery 1710, the build-up 1720, the progressive play 1730, the counter-attack 1740, and the set pieces 1750, enabling comprehensive analysis of tactical patterns and team performance across different game situations. The system may determine an output based on the one or more metrics including phase of play classifications, generating tactical insights that combine positional data with contextual phase information to provide enhanced understanding of sporting occasion dynamics and strategic decision-making processes.

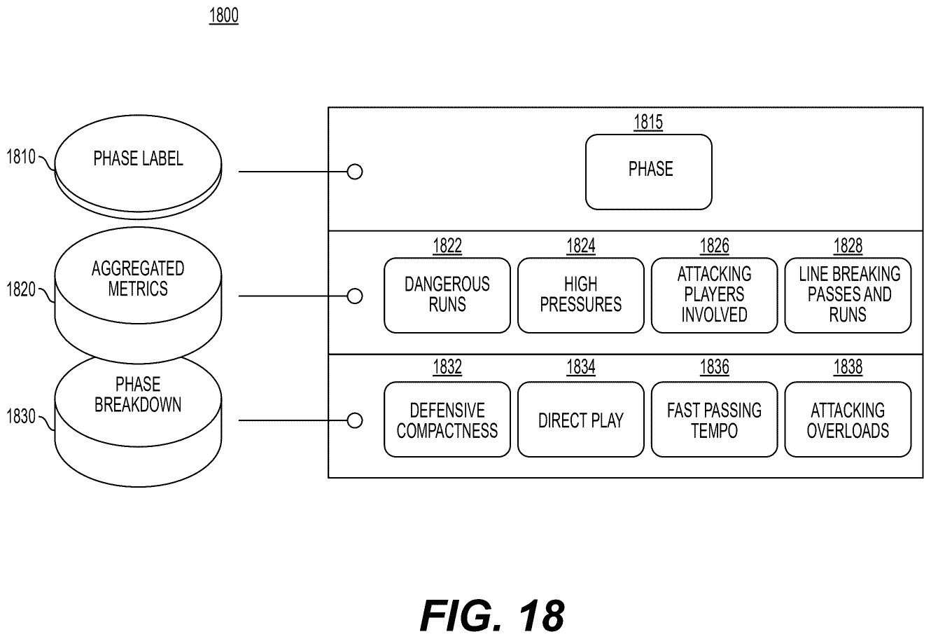

Referring to FIG. 18, a flow 1800 may implement a comprehensive phase determination system that processes tracking data and event data through computational analysis to generate contextual phase classifications for sporting occasions. The flow 1800 may demonstrate the technical methodology for transforming frame-by-frame metrics into aggregated tactical insights through systematic analysis of agent positioning, movement patterns, and game dynamics. The flow 1800 may include four primary components that work in coordination to process raw tracking data through sequential computational operations, ultimately generating phase classifications that provide tactical understanding of sporting occasion segments.

The flow 1800 may establish relationships between a phase label 1810, a phase 1815, aggregated metrics 1820, and a phase breakdown 1830 through interconnected computational processes that combine positional analysis with contextual game information. The phase label 1810 may serve as the primary classification output that categorizes specific temporal segments of the sporting occasion into tactical phases based on the computational analysis performed by the other components. A phase 1815 may represent the specific temporal segment being analyzed, providing the contextual framework within which the aggregated metrics 1820 and the phase breakdown 1830 operate to generate the appropriate phase label 1810.

The technical implementation for the flow 1800 may involve parallel processing pipelines that simultaneously calculate the aggregated metrics 1820 and the phase breakdown 1830 for each phase 1815, enabling real-time phase classification during live sporting occasions. The system may integrate outputs from the frame-by-frame metrics 500 including the pass options 510, the pressure 520, the line detection 530, and the marking 540 to generate comprehensive tactical analysis that informs the phase determination process. The flow 1800 may apply machine learning algorithms combined with rules-based definitions to process the aggregated metrics 1820 and the phase breakdown 1830, generating the phase label 1810 through systematic evaluation of tactical criteria and game state characteristics.

The aggregated metrics 1820 may process tracking data through computational operations that combine individual agent metrics into collective team-level measurements, providing quantitative assessment of tactical behaviors and performance characteristics during each phase 1815. The aggregated metrics 1820 may include dangerous runs 1822, high pressure 1824, attacking players involved 1826, and line breaking passes and runs 1828, each calculated through specific technical methodologies that transform frame-by-frame measurements into meaningful tactical indicators.

The dangerous runs 1822 may implement computational analysis that identifies and quantifies movement patterns exhibiting significant threat potential based on expected threat (xThreat) value increases and maximum threat thresholds. The system may calculate the dangerous runs 1822 by analyzing player run data generated through the pattern recognition algorithms described for the in-possession player runs 1100 and the out-of-possession player runs 1200, applying specific criteria that require at least 0.05 increase in xThreat values during the run with maximum xThreat values reaching at least 0.2. The technical implementation may involve monitoring xThreat calculations throughout each detected run episode, identifying runs where the difference between maximum and starting xThreat values exceeds the 0.05 threshold while ensuring that peak threat levels reach the 0.2 minimum threshold.

The high pressure 1824 may implement computational analysis that quantifies defensive intensity applied to ball carriers through aggregation of pressure classifications generated by the pressure 520 component of the frame-by-frame metrics 500. The system may calculate the high pressure 1824 by analyzing pressure level distributions across all defensive agents within the phase 1815, applying weighted aggregation methods that account for the number of defensive players applying pressure and the intensity levels maintained throughout the pressure episodes. The technical implementation may involve processing pressure classifications of none, low, medium, and high pressure generated through the multi-class classifier, calculating aggregate pressure scores that reflect collective defensive intensity during each phase 1815.

The attacking players involved 1826 may implement computational analysis that quantifies the number of offensive agents actively participating in attacking actions during each phase 1815 through analysis of movement patterns, positional changes, and tactical engagement indicators. The system may calculate the attacking players involved 1826 by monitoring agent participation in offensive runs, pass reception opportunities, and positional advancement toward threatening field areas. The technical implementation may involve analyzing player run classifications from the in-possession player runs 1100, pass option calculations from the pass options 510, and positional progression measurements to determine which offensive agents demonstrate active engagement in attacking play during each phase 1815.

The line breaking passes and runs 1828 may implement computational analysis that quantifies successful penetration of defensive formations through both ball movement and agent movement that crosses defensive line boundaries identified by the line detection 530. The system may calculate the line breaking passes and runs 1828 by aggregating successful line penetration events detected through the clustering algorithm, combining pass events that cross defensive line boundaries with agent movement patterns that successfully breach defensive formations. The technical implementation may involve monitoring ball trajectories and agent trajectories that cross cluster boundaries representing defensive lines, midfield lines, and attacking lines, generating aggregate counts of successful penetration events during each phase 1815.

The phase breakdown 1830 may process tracking data through specialized computational operations that analyze specific tactical characteristics and game dynamics to provide detailed contextual information about team positioning, movement patterns, and strategic behaviors during each phase 1815. The phase breakdown 1830 may include defensive compactness 1832, direct play 1834, fast passing tempo 1836, and attacking overloads 1838, each calculated through distinct technical methodologies that capture different aspects of tactical performance and strategic implementation.

The defensive compactness 1832 may implement computational analysis using Convex Hull volume calculations applied to defensive player positions to determine the spatial area covered by the defensive formation. The system may calculate the defensive compactness 1832 by processing positional coordinates of all defensive outfield players and applying geometric algorithms to determine the smallest area that encompasses all defensive positions. The technical implementation may require sustained positioning for at least 1 second to ensure stable formation analysis, classifying compactness levels as high compactness when Convex Hull volume measures less than 600 square meters, medium compactness when volume measures between 650 and 900 square meters, and low compactness when volume exceeds 950 square meters.

The direct play 1834 may implement computational analysis that identifies rapid ball advancement through passing sequences that achieve significant territorial gain within specified time constraints. The system may calculate the direct play 1834 by monitoring cumulative ball movement in the x-direction through passing actions, applying technical requirements that mandate at least 32 meters gain in x-direction within 4 seconds of current possession time. The technical implementation may involve tracking ball position changes resulting from completed passes, calculating cumulative x-coordinate advancement, and applying temporal constraints that ensure the territorial gain occurs within the specified time window. When a team completes three passes that advance the ball from x-coordinate 25 to x-coordinate 58 within 3.5 seconds, the system may identify this sequence as meeting the direct play 1834 criteria based on the 33-meter x-direction gain achieved within the 4-second time limit.

The fast-passing tempo 1836 may implement computational analysis that identifies rapid passing sequences characterized by high pass frequency within specified time constraints. The system may calculate the fast-passing tempo 1836 by monitoring pass completion events within temporal windows, applying technical requirements that mandate at least 4 passes within 6 seconds of current possession time. The technical implementation may involve tracking pass event timestamps from the event data 208, calculating pass frequency within rolling time windows, and identifying sequences where pass completion rates exceed the specified threshold. When a team completes 5 passes within a 5.2-second period during a possession sequence, the system may identify this sequence as meeting the fast-passing tempo 1836 criteria based on exceeding the minimum pass frequency requirements.

The attacking overloads 1838 may implement computational analysis using elliptical zone methodology to identify situations where attacking teams achieve numerical superiority in dangerous field areas near the ball location. The system may calculate the attacking overloads 1838 by defining elliptical zones centered around the ball position and oriented toward the opposition goal, applying different dimensional parameters for in-possession and out-of-possession team player counting. The technical implementation may utilize elliptical zones with width 20 meters and length 25 meters for counting in-possession team players, while applying elliptical zones with width 21 meters and length 26.25 meters for counting out-of-possession team players.

The elliptical zone positioning may center the zones such that the ball location represents 20% of the distance along the length diameter from the rear of the ellipse, ensuring that the majority of the elliptical area extends toward the opposition goal direction. For example, when the ball is positioned at coordinates [50, 30], the system may generate an elliptical zone for the in-possession team with the ball positioned 5 meters from the rear edge of the 25-meter length dimension, creating an elliptical area that extends 20 meters toward the opposition goal. The system may simultaneously generate a slightly larger elliptical zone for counting out-of-possession team players, with the ball positioned 5.25 meters from the rear edge of the 26.25-meter length dimension.

The overload detection methodology may require the overload condition to persist for at least 0.7 seconds within the past 1 second of play to ensure sustained numerical advantage rather than momentary positional imbalances. The system may apply different overload thresholds based on the number of defending players within the elliptical zone, requiring at least 1 additional attacking player when 2 or fewer defenders are present, and requiring at least 2 additional attacking players when 3 or more defenders are present within the zone. The attacking overloads 1838 may further classify overload types as wide overloads when at least 50% of frames show ball y-coordinate positions exceeding 19 meters or falling below-19 meters, and central overloads for other positioning scenarios.

The phase determination process implemented through the flow 1800 may combine the aggregated metrics 1820 and the phase breakdown 1830 through weighted analysis algorithms that evaluate multiple tactical factors simultaneously to generate appropriate phase label 1810 classifications. The computer implemented method may determine the phase of play by determining the aggregated metrics 1820 corresponding to the one or more metrics associated with the one or more agents 112, determining the phase breakdown 1830 based on the aggregated metrics 1820, and categorizing each of the one or more portions of the sporting occasion based on the aggregated metrics 1820 and the phase breakdown 1830. The system may apply machine learning classification techniques that process the quantitative outputs from both the aggregated metrics 1820 and the phase breakdown 1830 to generate phase label 1810 assignments that reflect the tactical characteristics and strategic context of each phase 1815 within the sporting occasion.

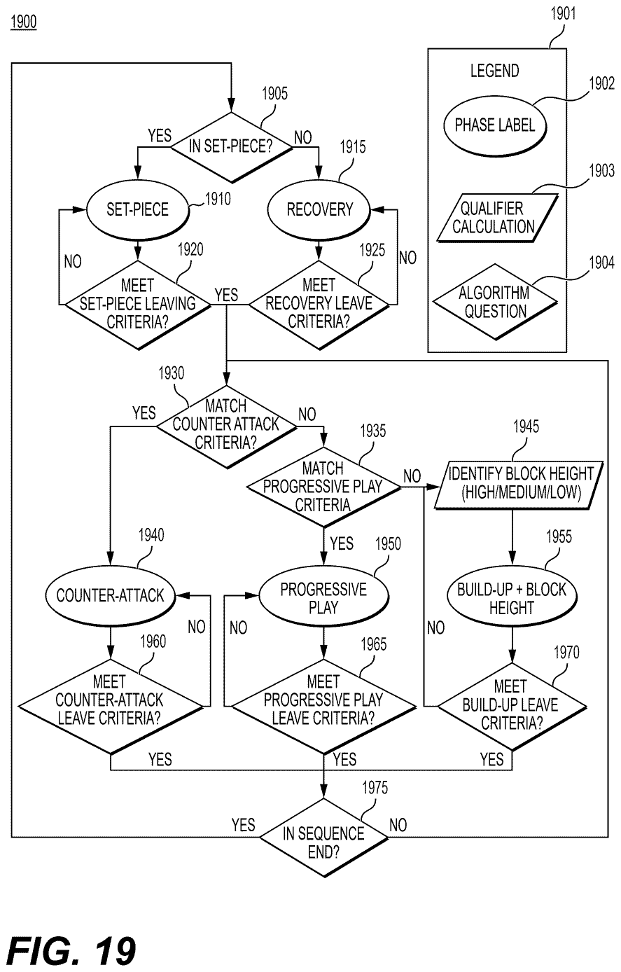

Referring to FIG. 19, a flow 1900 may implement a comprehensive algorithmic decision tree that processes tracking data through systematic computational operations to determine phases of play classifications for sporting occasions. The flow 1900 may demonstrate the technical methodology for automated phase determination through sequential decision points that evaluate specific criteria including set-piece detection, recovery phase analysis, counter-attack identification, progressive play assessment, and defensive block height classification. The flow 1900 may include a legend 1901 that identifies different types of elements within the algorithmic framework, providing visual distinction between phase classifications, computational operations, and decision criteria.

The legend 1901 may establish visual coding conventions that distinguish between a phase label 1902, a qualifier calculation 1903, and an algorithm question 1904 throughout the flow 1900. The phase label 1902 may represent terminal classification outputs that assign specific phase categories to temporal segments of the sporting occasion based on the computational analysis performed through the algorithmic decision tree. The qualifier calculation 1903 may represent computational operations that process tracking data and event data to generate quantitative measurements used for phase determination criteria evaluation. An algorithm question 1904 may represent decision points within the flow 1900 where specific criteria are evaluated to determine the appropriate path through the algorithmic decision tree toward phase classification.

The flow 1900 may begin with an operation 1905 that determines whether the current play sequence constitutes a set-piece through analysis of game event classifications in the event data 208. The operation 1905 may implement computational analysis that examines event type indicators to distinguish between open play sequences and non-open play sequences including corner kicks, free kicks, throw-ins, and other dead-ball situations. The technical implementation may involve processing event data timestamps and event type classifications to identify when play sequences initiate with set-piece events rather than continuous gameplay transitions. When the operation 1905 determines that the play sequence begins with a set-piece event, the flow 1900 may proceed to an operation 1910 for set-piece phase processing.

The operation 1910 may implement set-piece phase classification that applies the set pieces 1750 framework described previously, monitoring ball position relative to goal location and applying appropriate termination criteria based on attacking or standard set-piece classifications. The technical implementation may involve analyzing ball distance to goal within 3 seconds of set-piece initiation to determine whether the set-piece qualifies as attacking (ball distance ≤30 meters) or standard (ball distance >30 meters) classification. The operation 1910 may maintain set-piece phase classification while monitoring for termination criteria including distance limits, time limits, and ball position changes that indicate transition to open play.

Following the operation 1910, the flow 1900 may proceed to an operation 1920 that evaluates whether set-piece leaving criteria are satisfied through computational analysis of ball movement, time elapsed, and positional changes since set-piece initiation. The operation 1920 may implement different termination criteria based on the attacking or standard set-piece classification determined in the operation 1910. For attacking set-pieces, the operation 1920 may monitor for ball carries exceeding 5 meters outside the opposition box, controlled completions exceeding 5 meters outside the opposition box, ball departure from the opposition box after having been inside, or time limits exceeding 10 seconds since set-piece initiation. For standard set-pieces, the operation 1920 may apply more restrictive criteria including ball carries exceeding 5 meters, pass completions exceeding 5 meters, ball departure from the opposition box after having been inside, or time limits exceeding 3 seconds since set-piece initiation.

When the operation 1920 determines that set-piece leaving criteria are not satisfied, the flow 1900 may return to the operation 1910 to maintain set-piece phase classification. When the operation 1920 determines that leaving criteria are satisfied, the flow 1900 may proceed to an operation 1930 for subsequent phase evaluation. The technical implementation may involve continuous monitoring of ball position, movement characteristics, and temporal progression to ensure accurate detection of set-piece termination conditions.

When the operation 1905 determines that the play sequence does not constitute a set-piece, the flow 1900 may proceed to an operation 1915 for recovery phase processing. The operation 1915 may implement the recovery 1710 framework that applies computational criteria including distance limits, carry thresholds, pass completion requirements, and time limits to determine recovery phase classification. The technical implementation may involve monitoring ball possession status through integration with the event data 208 to identify possession transitions, then applying distance threshold analysis by calculating cumulative ball movement from the initial possession point.

Following the operation 1915, the flow 1900 may proceed to an operation 1925 that evaluates whether recovery leave criteria are satisfied through computational analysis of ball movement distance, individual ball carries, pass completion counts, and individual possession duration. The operation 1925 may implement technical criteria requiring ball movement exceeding 10 meters through any combination of passes, carries, or ball movement, individual ball carries exceeding 10 meters, completion of 3 successful passes, or individual ball possession exceeding 2 seconds duration. The technical implementation may involve cumulative distance calculations, pass event counting, and temporal monitoring to determine when recovery phase termination conditions are satisfied.

When the operation 1925 determines that recovery leave criteria are not satisfied, the flow 1900 may return to the operation 1915 to maintain recovery phase classification. When the operation 1925 determines that leaving criteria are satisfied, the flow 1900 may proceed to the operation 1930 for subsequent phase evaluation. The computational operations may ensure accurate detection of recovery phase completion based on ball movement characteristics and possession development indicators.

The operation 1930 may implement counter-attack criteria evaluation through systematic analysis of three specific computational requirements: quick turnover timing, quick transition characteristics, and quickly behind opposition positioning. The operation 1930 may evaluate quick turnover requirements by calculating the time interval between the current possession start and the previous possession end, applying technical criteria that require the current possession to initiate within 5 seconds of the previous possession termination. The technical implementation may involve processing possession timing data from the event data 208 of FIGS. 2A and 2B to determine possession transition intervals and identify rapid possession changes characteristic of counter-attacking situations.

The operation 1930 may evaluate quick transition characteristics through analysis of ball advancement speed and goal proximity achievement within specified time constraints. The technical implementation may require the current possession's ball distance to goal to reach less than 30 meters within 15 seconds of possession starting, combined with ball speed toward the opposition goal center exceeding 5 meters per second for at least 3 seconds duration. The system may calculate ball distance to goal by measuring the Euclidean distance between ball position and goal center coordinates, monitoring this distance throughout the possession sequence to identify when the 30-meter threshold is achieved. The ball speed calculation may involve analyzing ball movement vectors directed toward the opposition goal, applying differential analysis to consecutive ball positions to determine speed measurements and ensuring sustained speed above the 5 meters per second threshold for the required 3-second duration.

The operation 1930 may evaluate quickly behind opposition positioning through analysis of ball position relative to the defending team centroid and defensive team positioning relative to field boundaries. The technical implementation may require the attacking team to achieve ball possession behind the defending team centroid within 6 seconds of possession starting while the defensive team's centroid remains outside its own half of the field. The system may calculate the defending team centroid by averaging x-coordinate positions of all defensive outfield players, then monitoring ball position relative to this centroid to determine when the ball crosses behind the defensive formation. The defensive team positioning analysis may ensure that the defensive centroid remains in the attacking half of the field during the counter-attack initiation, indicating that the defensive team has not retreated to deep defensive positions.

When the operation 1930 determines that counter-attack criteria are satisfied through successful evaluation of all three computational requirements, the flow 1900 may proceed to an operation 1940 for counter-attack phase processing. When the operation 1930 determines that counter-attack criteria are not satisfied, the flow 1900 may proceed to an operation 1935 for progressive play criteria evaluation. The technical implementation may ensure that counter-attack detection occurs only when all three criteria are simultaneously satisfied, preventing false positive classifications that could result from partial satisfaction of counter-attack requirements.

The operation 1935 may implement progressive play criteria evaluation through analysis of ball position relative to the defending team centroid and sustained positioning requirements. The operation 1935 may apply computational criteria that require the ball to remain behind the defending team centroid for at least 2 seconds while the attacking team maintains control, indicating successful advancement into threatening field positions. The technical implementation may involve continuous monitoring of ball x-coordinate position relative to the calculated defending team centroid position, applying temporal persistence requirements to ensure sustained ball advancement rather than momentary positional changes.

When the operation 1935 determines that progressive play criteria are satisfied, the flow 1900 may proceed to an operation 1950 for progressive play phase processing. When the operation 1935 determines that progressive play criteria are not satisfied, the flow 1900 may proceed to an operation 1945 for defensive block height identification. The computational analysis may distinguish between progressive play situations where the attacking team has achieved significant field advancement and build-up situations where the attacking team faces organized defensive formations.

The operation 1945 may implement defensive block height identification through analysis of defensive team positioning patterns and field zone classifications. The operation 1945 may calculate defensive team centroid by averaging x-coordinate positions of all defensive outfield players, then apply field zone analysis to determine defensive block classification as high, medium, or low based on centroid positioning and defensive line locations. The technical implementation may classify defensive formations as low block when the defensive team centroid is positioned in quarter 1 of the pitch, corresponding to less than 26.25 meters from the defensive team's own goal in standard field coordinate systems.

The operation 1945 may classify defensive formations as medium block when the defensive team centroid is positioned in quarter 2 or quarter 3 of the pitch with the defensive line positioned within the defensive team's own 5/12ths of the pitch, corresponding to defensive centroid positioning between 26.25 and 52.50 meters from the defensive goal with defensive line positioning less than 43.75 meters from the defensive goal. The operation 1945 may classify defensive formations as high block when the defensive team centroid is positioned in quarter 3 or quarter 4 of the pitch with the defensive line positioned outside the defensive team's own 5/12ths of the pitch, corresponding to defensive centroid positioning at least 52.5 meters from the defensive goal with defensive line positioning at least 43.75 meters from the defensive goal.

The technical implementation for defensive block height identification may utilize the line detection 530 to determine defensive line positioning through clustering techniques applied to defensive player x-coordinate positions. The operation 1945 may require sustained defensive positioning for at least 2 seconds to ensure stable formation analysis, preventing brief positional changes from triggering incorrect block height classifications. The system may combine defensive team centroid calculations with defensive line positioning analysis to generate comprehensive block height determinations that account for both overall team positioning and specific defensive line characteristics.

Following the operation 1945, the flow 1900 may proceed to an operation 1955 that combines build-up phase classification with the specific block height designation determined through the defensive positioning analysis. The operation 1955 may implement the build-up 1720 framework that generates comprehensive phase labels including “build-up against low block,” “build-up against medium block,” or “build-up against high block” based on the block height identification results from the operation 1945. The technical implementation may ensure that build-up phase classifications include specific defensive context information that enables tactical analysis of attacking team performance against different types of defensive formations.

The operation 1940 may implement counter-attack phase processing that applies the counter-attack 1740 framework, monitoring for termination criteria that indicate transition to subsequent phases. The technical implementation may involve continuous analysis of ball position relative to the defending team centroid, ball movement characteristics, and tactical development to determine when counter-attack phase conditions are no longer satisfied. The operation 1940 may maintain counter-attack phase classification while the attacking team continues to exploit the rapid transition opportunity created by the initial possession change.

Following the operation 1940, the flow 1900 may proceed to an operation 1960 that evaluates whether counter-attack leave criteria are satisfied through computational analysis of ball positioning and movement characteristics. The operation 1960 may implement termination criteria that end the counter-attack phase when the ball moves back in front of the defending team centroid for at least 1 second, or when ball movement characteristics indicate reduced attacking intensity through speed measurements falling below specified thresholds. The technical implementation may apply the same reduced intensity detection criteria used for the progressive play 1730, analyzing x-axis ball speed below 3 meters per second and ball distance to goal speed below 1.5 meters per second for the past 2 seconds.

When the operation 1960 determines that counter-attack leave criteria are not satisfied, the flow 1900 may return to the operation 1940 to maintain counter-attack phase classification. When the operation 1960 determines that leaving criteria are satisfied, the flow 1900 may proceed to an operation 1975 for sequence termination evaluation. The computational operations may ensure accurate detection of counter-attack phase completion based on tactical development and ball movement characteristics.

The operation 1950 may implement progressive play phase processing that applies the progressive play 1730 framework, monitoring for termination criteria including ball position changes and movement intensity reductions. The technical implementation may involve continuous monitoring of ball x-coordinate position relative to the defending team centroid, applying termination criteria when the ball moves back in front of the defending team centroid for at least 1 second or when reduced intensity conditions are detected through speed analysis.

Following the operation 1950, the flow 1900 may proceed to an operation 1965 that evaluates whether progressive play leave criteria are satisfied through computational analysis similar to the counter-attack termination evaluation. The operation 1965 may implement the same technical criteria used in the operation 1960, analyzing ball position relative to the defending team centroid and ball movement intensity characteristics to determine when progressive play phase conditions are no longer satisfied.

When the operation 1965 determines that progressive play leave criteria are not satisfied, the flow 1900 may return to the operation 1950 to maintain progressive play phase classification. When the operation 1965 determines that leaving criteria are satisfied, the flow 1900 may proceed to the operation 1975 for sequence termination evaluation. The computational operations may ensure accurate detection of progressive play phase completion based on tactical development and positioning changes.

Following the operation 1955, the flow 1900 may proceed to an operation 1970 that evaluates whether build-up leave criteria are satisfied through computational analysis of defensive formation changes and attacking team advancement. The operation 1970 may implement termination criteria that end the build-up phase when the attacking team successfully advances beyond the organized defensive formation or when defensive positioning characteristics change sufficiently to alter the tactical context. The technical implementation may monitor defensive team centroid positioning and defensive line locations to determine when build-up phase conditions are no longer applicable.

When the operation 1970 determines that build-up leave criteria are not satisfied, the flow 1900 may return to the operation 1955 to maintain build-up phase classification with the appropriate block height designation. When the operation 1970 determines that leaving criteria are satisfied, the flow 1900 may proceed to the operation 1975 for sequence termination evaluation. The computational operations may ensure accurate detection of build-up phase completion based on tactical progression and defensive formation changes.

The operation 1975 may implement sequence termination evaluation that determines whether the current possession sequence has concluded through analysis of possession status and game state indicators. The operation 1975 may process possession termination events from the event data 208 including possession changes, game stoppages, and other sequence-ending occurrences to determine when phase classification should conclude. When the operation 1975 determines that the sequence has not ended, the flow 1900 may return to the operation 1945 for continued phase evaluation within the ongoing possession sequence.

When the operation 1975 determines that the sequence has ended, the flow 1900 may complete the phase determination process for the current sequence and prepare for analysis of subsequent possession sequences. The technical implementation may ensure that phase classifications are appropriately terminated when possession sequences conclude, enabling the system to begin fresh phase analysis for new possession sequences that may initiate with different tactical contexts and phase classification requirements.

The algorithmic decision tree implemented through the flow 1900 may enable real-time phase determination during live sporting occasions through systematic evaluation of computational criteria at each decision point. The technical methodology may ensure that phase classifications accurately reflect the tactical context and strategic development of sporting occasion segments through comprehensive analysis of tracking data, event data, and positional relationships. The flow 1900 may demonstrate the automated transformation of raw sports data into contextual phase classifications that provide tactical insights for coaches, analysts, and broadcasters who require understanding of game dynamics and strategic decision-making processes throughout sporting occasions.

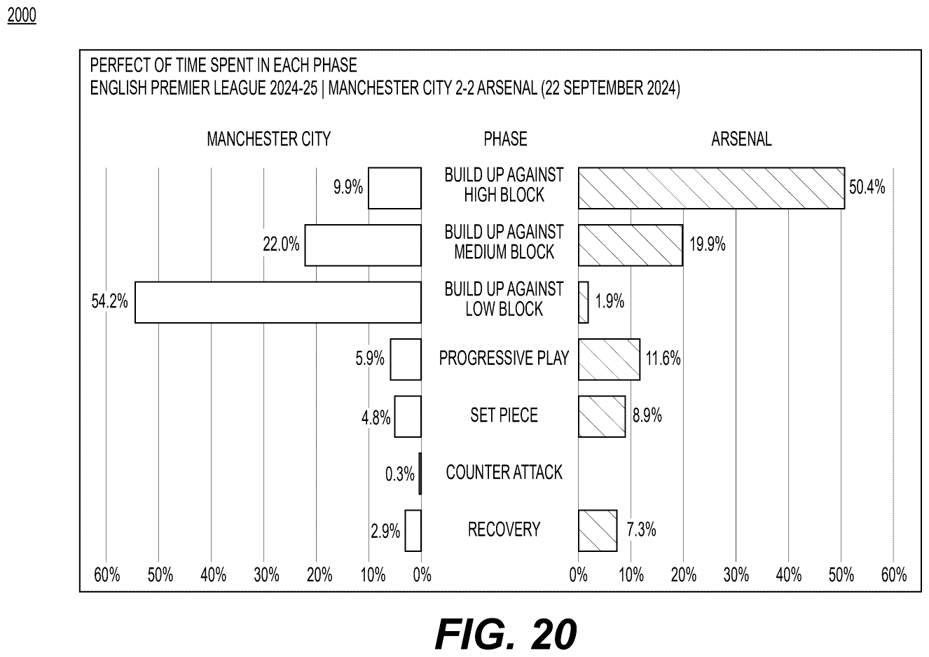

Referring to FIG. 20, an interface 2000 may demonstrate the technical outputs of the automated phase determination system through visual representation of quantitative phase distribution data collected during a match between Manchester City and Arsenal on Sep. 22, 2024. The phase of play interface 2000 may display statistical data in bar chart format that illustrates the percentage of time each team spent in different tactical phases throughout the sporting occasion, providing the ability to transform raw tracking data into meaningful tactical insights. The interface 2000 may organize phase distribution data using horizontal bar charts that extend in opposite directions from a central axis, enabling direct comparison of tactical behaviors between the two teams during the same match period.

The interface 2000 may implement technical visualization methodology that processes the phase classifications generated through the flow 1900 and converts temporal phase data into percentage distributions that quantify tactical performance characteristics. The system may calculate phase percentages by analyzing the total duration spent in each phase classification relative to the overall match time, applying temporal aggregation algorithms that account for phase switching criteria and minimum duration requirements described in the phases of play 1700 framework. The bar chart visualization may utilize proportional scaling where bar length corresponds directly to the calculated percentage values, enabling immediate visual assessment of tactical emphasis and strategic priorities for each team.

The Manchester City section of the interface 2000 may display phase distribution data using downward-extending bars that quantify the team's tactical behavior patterns throughout the match. The progressive play phase may represent 54.2% of Manchester City's possession time, indicating that the team successfully advanced the ball beyond the defending team's central average location for the majority of their attacking sequences. This substantial progressive play percentage may demonstrate the team's ability to penetrate defensive formations and achieve threatening field positions through sustained ball advancement and tactical progression.

The build-up phases for Manchester City may be distributed across different defensive block classifications, with build-up against high block representing 9.9% of possession time, build-up against medium block representing 22.0% of possession time, and build-up against low block representing 1.9% of possession time. The technical implementation may distinguish between these build-up classifications through the defensive block height identification process described in the operation 1945, where defensive team centroid positioning and defensive line locations determine the appropriate block classification. The relatively low percentage of build-up against low block may indicate that Arsenal maintained advanced defensive positioning throughout most of the match, requiring Manchester City to organize offensive movement against higher defensive formations.

The set piece phase may represent 4.8% of Manchester City's match time, reflecting the proportion of possession sequences that initiated with non-open play events including corner kicks, free kicks, and throw-ins. The counter-attack phase may represent 0.3% of possession time, indicating limited opportunities for rapid transition situations that satisfied the quick turnover, quick transition, and quickly behind opposition criteria described in the operation 1930. The recovery phase may represent 2.9% of possession time, reflecting periods where the team regained possession and applied the distance limits, carry thresholds, and pass completion requirements described in the recovery 1710 framework.

The Arsenal section of the interface 2000 may display phase distribution data using upward-extending bars that quantify the team's tactical behavior patterns in comparison to Manchester City's approach. The build-up against high block phase may represent 50.1% of Arsenal's possession time, indicating that the team frequently organized offensive movement against Manchester City's advanced defensive positioning. This substantial build-up percentage may demonstrate Arsenal's tactical approach of patient possession development against organized defensive formations, contrasting with Manchester City's emphasis on progressive play advancement.

The build-up against medium block may represent 19.8% of Arsenal's possession time, while build-up against low block may represent 1.9% of possession time, matching Manchester City's low block percentage and suggesting that both teams maintained relatively advanced defensive positioning throughout the match. The progressive play phase may represent 11.6% of Arsenal's possession time, significantly lower than Manchester City's 54.2% progressive play percentage, indicating different tactical approaches to ball advancement and field progression between the two teams.

The set piece phase may represent 8.9% of Arsenal's match time, nearly double Manchester City's 4.8% set piece percentage, potentially reflecting different tactical situations or game flow characteristics that resulted in more dead-ball situations for Arsenal. The counter-attack phase may represent 7.3% of possession time, substantially higher than Manchester City's 0.3% counter-attack percentage, indicating that Arsenal generated more opportunities for rapid transition situations that satisfied the computational criteria for counter-attack classification. The recovery phase may represent 7.3% of possession time, matching the counter-attack percentage and exceeding Manchester City's 2.9% recovery percentage.

The comparative analysis enabled by the interface 2000 may reveal significant tactical differences between the two teams' approaches to possession development and field advancement. Manchester City's dominant progressive play percentage of 54.2% compared to Arsenal's 11.6% may indicate that Manchester City more frequently achieved ball positioning behind Arsenal's defensive centroid, satisfying the progressive play criteria described in the operation 1935. Conversely, Arsenal's dominant build-up against high block percentage of 50.1% compared to Manchester City's 9.9% may indicate that Arsenal more frequently faced organized defensive formations positioned in advanced field areas.

The technical accuracy of the phase distribution calculations may be demonstrated through the comprehensive coverage of match time across all phase classifications, with the combined percentages for each team accounting for the complete temporal duration of their respective possession sequences. The interface 2000 may process phase classification data generated through the systematic evaluation described in the flow 1900, ensuring that each temporal segment of the match receives appropriate phase assignment based on the computational criteria and algorithmic decision tree methodology.

The visualization methodology implemented in the interface 2000 may enable immediate tactical assessment by coaches, analysts, and broadcasters who require quantitative understanding of team performance characteristics and strategic implementation effectiveness. The bar chart format may facilitate rapid comparison of tactical emphasis between opposing teams, highlighting strategic differences in-possession development, defensive organization, and transition play execution. The percentage-based representation may enable objective evaluation of tactical performance that transcends subjective assessment, providing concrete measurements of strategic decision-making and tactical discipline throughout the sporting occasion.

The interface 2000 may demonstrate the practical application of the automated transformation system described throughout this disclosure, illustrating how raw tracking data and event data may be processed through the frame-by-frame metrics 500, aggregated through the flow 1800, and classified through the flow 1900 to generate actionable tactical insights. The interface may serve as evidence of the system's capability to transform complex multi-agent positional data into accessible tactical information that supports real-time decision-making and post-match analysis in professional sports environments.

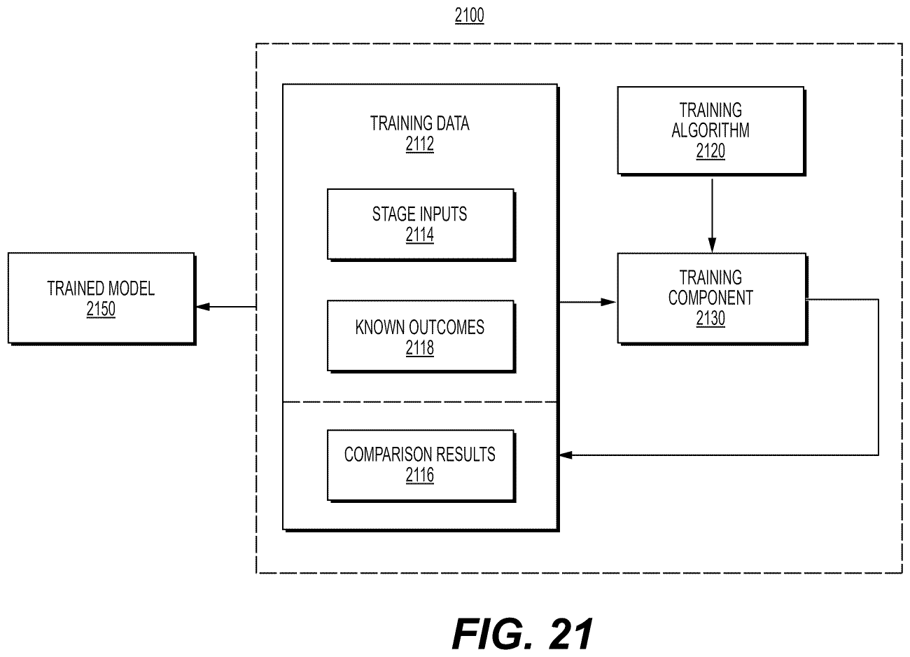

Referring to FIG. 21 illustrating a flow diagram for training a machine learning model, in accordance with an aspect of the disclosed subject matter. As shown in a flow diagram 2100 of FIG. 21, a training data 2112 may include one or more of stage inputs 2114 and known outcomes 2118 related to a machine learning model to be trained. The stage inputs 2114 may be from any applicable source including a component or set shown in the figures provided herein. The known outcomes 2118 may be included for machine learning models generated based on supervised or semi-supervised training. An unsupervised machine learning model might not be trained using the known outcomes 2118. The known outcomes 2118 may include known or desired outputs for future inputs similar to or in the same category as the stage inputs 2114 that do not have corresponding known outputs.

The training data 2112 and a training algorithm 2120 may be provided to a training component 2130 that may apply the training data 2112 to the training algorithm 2120 to generate a trained machine learning model 2150. According to an implementation, the training component 2130 may be provided comparison results 2116 that compares a previous output of the corresponding machine learning model to apply the previous result to re-train the machine learning model. The comparison results 2116 may be used by the training component 2130 to update the corresponding machine learning model. The training algorithm 2120 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 2100 may be a trained machine learning model 2150.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

### Machine Learning for Team/Player Predictions

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (e.g., attend to) the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

### Sports Machine Learning

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting occasions with corresponding time boundaries, teams, players, coaches, officials, and environmental data associated with a location of corresponding sporting occasions.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer-based sports machine learning model may be trained to correlate or otherwise associate player position information in reference to a soccer pitch. The soccer-based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

### Machine Learning Models.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

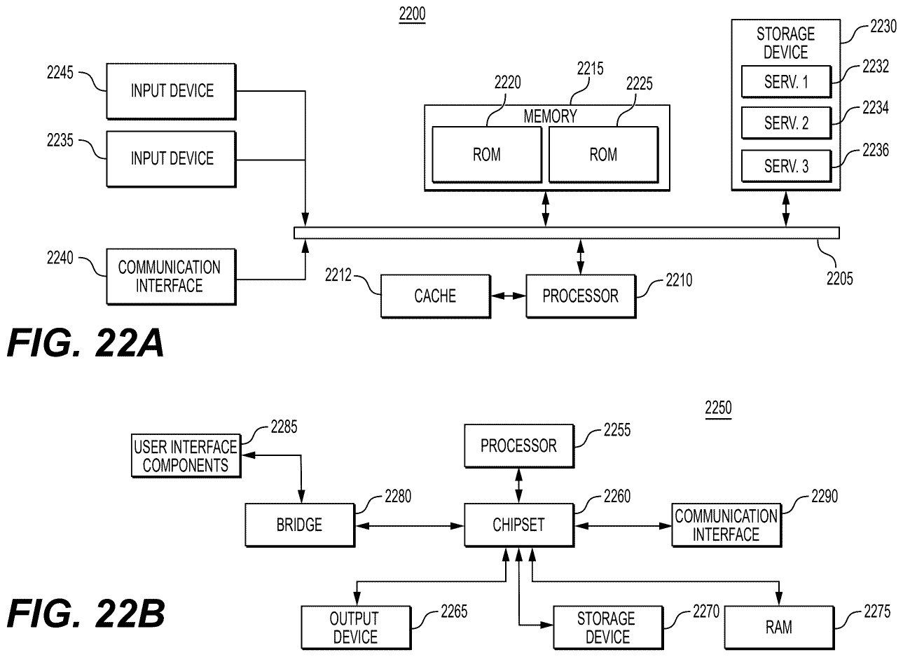

Referring to FIG. 22A, illustrating an architecture of a computing system 2200, according to example embodiments. The computing system 2200 may be representative of at least a portion of the organization computing system 104. One or more components of the computing system 2200 may be in electrical communication with each other using a system bus 2205. The computing system 2200 may include a processing unit (CPU or processor) 2210 and the system bus 2205 that couples various system components including a system memory 2215, such as a read only memory (ROM) 2220 and a random access memory (RAM) 2225, to the processor 2210. The computing system 2200 may include a cache of high-speed memory connected directly with, in close proximity to, or integrated as part of the processor 2210. The computing system 2200 may copy data from the system memory 2215 and/or a storage device 2230 to a cache 2212 for quick access by the processor 2210. In this way, the cache 2212 may provide a performance boost that avoids the processor 2210 delays while waiting for data. These and other modules may control or be configured to control the processor 2210 to perform various actions. Another system memory may be available for use as well. The system memory 2215 may include multiple different types of memory with different performance characteristics. The processor 2210 may include any general purpose processor and a hardware module or software module, such as service 1 2232, service 2 2234, and service 3 2236 stored in the storage device 2230, configured to control the processor 2210 as well as a special-purpose processor where software instructions are incorporated into the actual processor design. The processor 2210 may essentially be a completely self-contained computing system, containing multiple cores or processors, a bus, memory controller, cache, etc. A multi-core processor may be symmetric or asymmetric.

To enable user interaction with the computing system 2200, an input device 2245 may represent any number of input mechanisms, such as a microphone for speech, a touch-sensitive screen for gesture or graphical input, keyboard, mouse, motion input, speech and so forth. An output device 2235 (e.g., display) may also be one or more of a number of output mechanisms known to those of skill in the art. In some instances, multimodal systems may enable a user to provide multiple types of input to communicate with the computing system 2200. A communications interface 2240 may generally govern and manage the user input and system output. There is no restriction on operating on any particular hardware arrangement and therefore the basic features here may easily be substituted for improved hardware or firmware arrangements as they are developed.

The storage device 2230 may be a non-volatile memory and may be a hard disk or other types of computer readable media which may store data that are accessible by a computer, such as magnetic cassettes, flash memory cards, solid state memory devices, digital versatile disks, cartridges, a random access memories (RAMs) 2225, a read only memory (ROM) 2220, and hybrids thereof.

The storage device 2230 may include services 2232, 2234, and 2236 for controlling the processor 2210. Other hardware or software modules are contemplated. The storage device 2230 may be connected to the system bus 2205. In one aspect, a hardware module that performs a particular function may include the software component stored in a computer-readable medium in connection with the necessary hardware components, such as the processor 2210, the system bus 2205, the output device 2235, and so forth, to carry out the function.

Referring to FIG. 22B, illustrating a computing system 2250 having a chipset architecture that may represent at least a portion of the organization computing system 104. The computing system 2250 may be an example of computer hardware, software, and firmware that may be used to implement the disclosed technology. The computing system 2250 may include a processor 2255, representative of any number of physically and/or logically distinct resources capable of executing software, firmware, and hardware configured to perform identified computations. The processor 2255 may communicate with a chipset 2260 that may control input to and output from the processor 2255. In this example, the chipset 2260 outputs information to an output 2265, such as a display, and may read and write information to a storage device 2270, which may include magnetic media, and solid-state media, for example. The chipset 2260 may also read data from and write data to a RAM 2275. A bridge 2280 for interfacing with a variety of user interface components 2285 may be provided for interfacing with the chipset 2260. Such the user interface components 2285 may include a keyboard, a microphone, touch detection and processing circuitry, a pointing device, such as a mouse, and so on. In general, inputs to the computing system 2250 may come from any of a variety of sources, machine generated and/or human generated.

The chipset 2260 may also interface with one or more communication interfaces 2290 that may have different physical interfaces. The one or more communication interfaces 2290 may include interfaces for wired and wireless local area networks, for broadband wireless networks, as well as personal area networks. Some applications of the methods for generating, displaying, and using the GUI disclosed herein may include receiving ordered data sets over the physical interface or be generated by the machine itself by the processor 2255 analyzing data stored in the storage device 2270 or the RAM 2275. Further, the machine may receive inputs from a user through user interface components 2285 and execute appropriate functions, such as browsing functions by interpreting these inputs using the processor 2255.

It may be appreciated that example the computing system 2200 and the computing system 2250 may have more than one processor 2210 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A computer implemented method for automated transformation of sports data for metric based output determination, comprising:
receiving video data including a plurality of video frames captured during a sporting occasion, wherein each frame of the plurality of video frames includes data corresponding to one or more agents;
receiving event data associated with the video data;
processing the plurality of video frames and the event data to generate imputed tracking data, wherein the imputed tracking data includes positional data and movement data for each of the one or more agents;
determining one or more metrics based on the imputed tracking data, wherein the one or more metrics includes at least one of a pass option, a pressure, a line detection, and a marking; and
determining an output based on the one or more metrics for the one or more agents.

2. The computer implemented method of claim 1, wherein the pass option identifies available passing opportunities for an object carrier based on the positional data and the movement data for each of the one or more agents.

3. The computer implemented method of claim 1, wherein the pressure quantifies a defensive pressure applied to an object carrier based on a proximity of the one or more agents determined by the positional data and the movement data for each of the one or more agents.

4. The computer implemented method of claim 1, wherein the line detection identifies one or more line-breaking actions when movement of at least one of an object or one or more agents penetrates through a detected defensive line.

5. The computer implemented method of claim 1, wherein the marking identifies one or more defensive matchups by determining one or more defensive agents are within a threshold distance from an offensive agent.

6. The computer implemented method of claim 1, wherein the one or more metrics includes a player run to identify one or more movement patterns for each of the one or more agents.

7. The computer implemented method of claim 6, wherein the player run is categorized into at least one of an in-possession or an out-of-possession based on the positional data and the movement data for each of the one or more agents.

8. The computer implemented method of claim 7, wherein the in-possession category includes one or more of an in to out, an out to in, a coming short, a dropping off, a supporting runs, an overlapping and underlapping runs, a runs ahead of an object, a runs in behind, and a cross option.

9. The computer implemented method of claim 1, wherein the one or more metrics includes a phase of play that categorizes one or more portions of a sporting occasion into at least one of a recovery, a build-up, a progressive play, a counter-attack, and a set piece phase.

10. The computer implemented method of claim 9, wherein the phase of play is determined by:
determining one or more aggregated metrics corresponding to the one or more metrics associated with the one or more agents;
determining one or more phase breakdowns based on the one or more aggregated metrics; and
categorizing each of the one or more portions of the sporting occasion based on the one or more aggregated metrics and the one or more phase breakdowns.

11. A system for automated transformation of sports data for metric based output determination, the system comprising:
a non-transitory computer readable medium configured to store processor-readable instructions; and
a processor operatively connected to the non-transitory computer readable medium, and configured to execute the instructions to perform operations comprising:
receiving video data including a plurality of video frames captured during a sporting occasion, wherein each frame of the plurality of video frames includes data corresponding to one or more agents;
receiving event data associated with the video data;
processing the plurality of video frames and the event data to generate imputed tracking data, wherein the imputed tracking data includes positional data and movement data for each of the one or more agents;
determining one or more metrics based on the imputed tracking data, wherein the one or more metrics includes at least one of a pass option, a pressure, a line detection, and a marking; and
determining an output based on the one or more metrics for the one or more agents.

12. The system of claim 11, wherein the pass option identifies available passing opportunities for an object carrier based on the positional data and the movement data for each of the one or more agents, and
wherein the pressure quantifies a defensive pressure applied to an object carrier based on a proximity of the one or more agents determined by the positional data and the movement data for each of the one or more agents.

13. The system of claim 11, wherein the line detection identifies one or more line-breaking actions when movement of at least one of an object or one or more agents penetrates through a detected defensive line, and
wherein the marking identifies one or more defensive matchups by determining one or more defensive agents are within a threshold distance from an offensive agent.

14. The system of claim 11, wherein the one or more metrics includes a player run to identify one or more movement patterns for each of the one or more agents.

15. The system of claim 14, wherein the player run is categorized into at least one of an in-possession or an out-of-possession based on the positional data and the movement data for each of the one or more agents.

16. The system of claim 11, wherein the one or more metrics includes a phase of play that categorizes one or more portions of a sporting occasion into at least one of a recovery, a build-up, a progressive play, a counter-attack, and a set piece phase.

17. A non-transitory computer readable medium configured to store processor-readable instructions, wherein when executed by a processor, the instructions perform operations comprising:
receiving video data including a plurality of video frames captured during a sporting occasion, wherein each frame of the plurality of video frames includes data corresponding to one or more agents;
receiving event data associated with the video data;
processing the plurality of video frames and the event data to generate imputed tracking data, wherein the imputed tracking data includes positional data and movement data for each of the one or more agents;
determining one or more metrics based on the imputed tracking data, wherein the one or more metrics includes at least one of a pass option, a pressure, a line detection, and a marking; and
determining an output based on the one or more metrics for the one or more agents.

18. The non-transitory computer readable medium of claim 17, wherein the pass option identifies available passing opportunities for an object carrier based on the positional data and the movement data for each of the one or more agents,
wherein the pressure quantifies a defensive pressure applied to an object carrier based on a proximity of the one or more agents determined by the positional data and the movement data for each of the one or more agents,
wherein the line detection identifies one or more line-breaking actions when movement of at least one of an object or one or more agents penetrates through a detected defensive line, and
wherein the marking identifies one or more defensive matchups by determining one or more defensive agents are within a threshold distance from an offensive agent.

19. The non-transitory computer readable medium of claim 17, wherein the one or more metrics includes a player run to identify one or more movement patterns for each of the one or more agents,
wherein the player run is categorized into at least one of an in-possession or an out-of-possession based on the positional data and the movement data for each of the one or more agents, and
wherein the in-possession category includes one or more of an in to out, an out to in, a coming short, a dropping off, a supporting runs, an overlapping and underlapping runs, a runs ahead of an object, a runs in behind, and a cross option.

20. The non-transitory computer readable medium of claim 17, wherein the one or more metrics includes a phase of play that categorizes one or more portions of a sporting occasion into at least one of a recovery, a build-up, a progressive play, a counter-attack, and a set piece phase.
